(19) United States
(12) Patent Application Publication
(10) Pub. No.: US 2014/0163980 A1
(43) Pub. Date: Jun. 12, 2014

(54) MULTIMEDIA MESSAGE HAVING PORTIONS OF MEDIA CONTENT WITH AUDIO OVERLAY

(71) Applicant: RAWLLIN INTERNATIONAL INC., Tortola (VG)

(72) Inventors: Måns Anders Tesch, Gard (FR); Johan Magnus Tesch, London (GB); Vsevolod Kuznetsov, Sankt-Petersburg (RU)

(73) Assignee: Rawllin International Inc., Tortola (VG)

(21) Appl. No.: 13/710,363

(22) Filed: Dec. 10, 2012

(51) Int. Cl. G10L 21/10

(52) U.S. Cl. CPC G10L 21/10
USPC 704/235

(57) ABSTRACT

A multimedia message is generated according to media content portions identified by a message input. The media content portions are identified from among media content that can include videos, images, and audio content that is associated or not associated with the media content portions respectively. The media content portions correspond to words or phrases of the message inputs. A multimedia message is generated having one or more of the media content portions corresponding to words or phrases received. Audio content of the media content portions can be separated and reassembled with different media content portions than originally associated with. The multimedia message comprises the media content portions having different audio content portions than initially.

### TECHNICAL FIELD

The subject application relates to media content and messages related to media content, and, in particular, to the composition of messages in association with media content portions having an audio overlay.

### BACKGROUND

Media content can includes various different forms of media and the contents that make up the different forms of media. For example, a film or video, also called a movie or motion picture, is a series of still or moving images that are rapidly put together and projected onto/from a display, such as by a reel on a projector device, or some other device, depending upon what generation a person is from. The video or film is produced by recording photographic images with cameras, or by creating images using animation techniques or visual effects. The process of filmmaking has developed into an art form and a large industry, which continues to provide entertainment to masses of people, especially during times of war or calamity.

Videos are made up of a series of individual images called frames, or also referred to herein as clips. When these images are shown rapidly in succession, a viewer has the illusion that motion is occurring. Videos and portions of videos can be thought of as cultural artifacts created by specific cultures, which reflect those cultures, and, in turn, affect them. Film is considered to be an important art form, a source of popular entertainment and a powerful method for educating or indoctrinating citizens. The visual elements of cinema give motion pictures a universal power of communication. Some films have become popular worldwide attractions by using dubbing or subtitles that translate the dialogue into the language of the viewer.

To these ends, people continue to express themselves in novel and different ways by leaving behind classical films that not only mark generations, but provide the shoulders for new generations to stand upon, subject to copyright laws. The above trends or deficiencies are merely intended to provide an overview of some conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and communicating media content and media content portions corresponding to message inputs are described herein. An exemplary system comprises a memory that stores computer-executable components and a processor, communicatively coupled to the memory, which is configured to facilitate execution of the computer-executable components. The computer-executable components comprise an input component configured to receive a message input having a set of words or phrases for generating a multimedia message. A media component is configured to analyze media content to determine an audio content portion and a video content portion that corresponds to the set of words or phrases of the message input. An overlay component is configured to overlay the audio content portion with the video content portion. A message component is configured to generate the multimedia message with the video content portion and the audio content portion to correspond to the set of words or phrases of the message input.

In another non-limiting embodiment, an exemplary method comprises receiving, by a system including at least one processor receiving, by a system including at least one processor, a message input having a set of words or phrases for generating a multimedia message. A first media content portion is determined from media content that includes a first audio content portion of a first video content portion and a second media content portion is determined that includes a second audio content portion of a second video content portion, wherein the first media content portion and the second media content portion correspond to the set of words or phrases of the message input based on a set of predetermined criteria. The method includes combining the first audio content portion with the second video content portion to form a third media content portion. The multimedia message is generated that includes the third media content portion.

In yet another non-limiting embodiment, an example apparatus comprises a memory storing computer-executable instructions, and a processor, communicatively coupled to the memory, that facilitates execution of the computer-executable instructions to at least receive a set of words or phrases for generation of a multimedia message. A set of media content portions is determined that respectively include an audio content portion and a video content portion according to the set of words or phrases. The processor is further configured to facilitate execution of the computer-executable instructions to associate the audio content portion of a first media content portion with the video content portion of a second media content portion to form a third media content portion. The multimedia message is generated with the third media content portion.

In still another non-limiting embodiment, an exemplary computer readable storage medium comprising computer executable instructions that, in response to execution, cause a computing system including at least one processor to perform operations. The operations comprise receiving a set of words or phrases for generation of a multimedia message having a media content portion corresponding to the set of words or phrases. The media content portion is extracted having a video content portion and an audio content portion from a set of media content corresponding to the set of received words or phrases. The video content portion of the media content portion I associated with a different audio content portion of a different media content portion that corresponds to the set of received words or phrases. The operations further include generating the multimedia message with at least one media content portion that corresponds to the set of received words or phrases and includes the video content portion associated with the different audio content portion.

In another example embodiment, a system comprises means for receiving a set of words or phrases for a multimedia message; means for identifying a set of media content portions that include an audio content portion and a video content portion that corresponds to the audio content portion from a set of media content; means for correlating a different audio content portion with the video content portion; and means for generating the multimedia message with the video content portion and the different audio content portion.

The following description and the annexed drawings set forth in detail certain illustrative aspects of the disclosed subject matter. These aspects are indicative, however, of but a few of the various ways in which the principles of the various innovations may be employed. The disclosed subject matter is intended to include all such aspects and their equivalents. Other advantages and distinctive features of the disclosed subject matter will become apparent from the following detailed description of the various innovations when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example messaging system in accordance with various aspects described herein;

FIG. 2 illustrates another example messaging system in accordance with various aspects described herein;

FIG. 3 illustrates another example messaging system in accordance with various aspects described herein;

FIG. 4 illustrates another example messaging system in accordance with various aspects described herein;

FIG. 5 illustrates an example video content portion and audio content portion of a media content portion in accordance with various aspects described herein;

FIG. 6 illustrates an example of a flow diagram showing an exemplary non-limiting implementation for a system for generating a message in accordance with various aspects described herein;

FIG. 7 illustrates another example of a flow diagram showing an exemplary non-limiting implementation for a system for generating a message in accordance with various aspects described herein;

FIG. 8 illustrates an example messaging system in accordance with various aspects described herein;

FIG. 9 illustrates another example messaging system in accordance with various aspects described herein;

FIG. 10 illustrates another example messaging system in accordance with various aspects described herein;

FIG. 11 illustrates an example of a semantic component in accordance with various aspects described herein;

FIG. 12 illustrates an example of a flow diagram showing an exemplary non-limiting implementation for a system for generating a message in accordance with various aspects described herein;

FIG. 13 illustrates another example of a flow diagram showing an exemplary non-limiting implementation for a system for generating a message in accordance with various aspects described herein;

FIG. 14 illustrates an example messaging system in accordance with various aspects described herein;

FIG. 15 illustrates another example messaging system in accordance with various aspects described herein;

FIG. 16 illustrates another example messaging system in accordance with various aspects described herein;

FIG. 17 illustrates an example set of acronyms and corresponding meanings in accordance with various aspects described herein;

FIG. 18 illustrates an example set of emoticons and corresponding meanings in accordance with various aspects described herein;

FIG. 19 illustrates an example of a flow diagram showing an exemplary non-limiting implementation for a messaging system for evaluating media content in accordance with various aspects described herein;

FIG. 20 illustrates another example of a flow diagram showing an exemplary non-limiting implementation for a messaging system for evaluating media content in accordance with various aspects described herein;

FIG. 21 illustrates an example system in accordance with various aspects described herein;

FIG. 22 illustrates another example system in accordance with various aspects described herein;

FIG. 23 illustrates another example system in accordance with various aspects described herein;

FIG. 24-26 illustrate an example view pane in accordance with various aspects described herein;

FIG. 27 illustrates an example of a flow diagram showing an exemplary non-limiting implementation for a recommendation system for evaluating media content in accordance with various aspects described herein;

FIG. 28 illustrates another example of a flow diagram showing an exemplary non-limiting implementation for a recommendation system for evaluating media content in accordance with various aspects described herein;

FIG. 29 illustrates an example system in accordance with various aspects described herein;

FIG. 30 illustrates another example system in accordance with various aspects described herein;

FIG. 31 illustrates another example view pane of a slide reel in accordance with various aspects described herein;

FIG. 32 illustrates another example message component in accordance with various aspects described herein;

FIG. 33 illustrates an example media component in accordance with various aspects described herein;

FIG. 34 illustrates an example view pane in accordance with various aspects described herein;

FIG. 35 illustrates an example of a flow diagram showing an exemplary non-limiting implementation for a recommendation system for evaluating media content in accordance with various aspects described herein;

FIG. 36 illustrates another example of a flow diagram showing an exemplary non-limiting implementation for a recommendation system for evaluating media content in accordance with various aspects described herein;

FIG. 37 illustrates an example system in accordance with various aspects described herein;

FIG. 38 illustrates another example system in accordance with various aspects described herein;

FIG. 39 illustrates another example system in accordance with various aspects described herein;

FIG. 40 illustrates another example system in accordance with various aspects described herein;

FIG. 41 illustrates an example system flow diagram in accordance with various aspects described herein;

FIG. 42 illustrates another example of a flow diagram showing an exemplary non-limiting implementation for a system for generating a multimedia message in accordance with various aspects described herein;

FIG. 43 illustrates another example of a flow diagram showing an exemplary non-limiting implementation for a system for generating multimedia message in accordance with various aspects described herein;

FIG. 44 is a block diagram representing exemplary non-limiting networked environments in which various non-limiting embodiments described herein can be implemented; and

FIG. 45 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements. The word “set” is also intended to mean “one or more.”

### Overview

In consideration of the above-described trends or deficiencies among other things, various embodiments are provided that generate a media message for a user that includes a sequence of media clips or media content portions. The media content portions can include, for example, portions of videos from movies having audio content and/or imagery. A message component of a system having a processor and a memory generates the message that comprises a multi-media message, or a message having multiple different media contents with a sequence of media clips or media content portions. The message is generated in response to a set of message inputs being received, such as a text based message from a mobile device, a voice input, a predefined selection, a query term or the like. The message inputs received can include words or phrases intended for media content portions in a multimedia message to correspond with.

An overlay component is configured to replace, exchange, overlay, or, in other words, combine audio content portions of a media content portion or media content with a different media content portion or media content. For example, media content portions of various types of media content can be generated that correspond to a word or phrase received as input for a message. A media content portion can have video content portions, image content portions and/or audio content portions from a set of media content (e.g., films, movies, videos, music, etc.). The overlay component is operable to overlay a selected audio content portion with a video content portion. The selected audio content portion can be associated with a first video content portion, for example and overlaid or combined with a different second video content. For example, a media content portion can have one actor, object or person within it speaking the same words, but with another voice.

The words “portion,” “segment,” “scene,” “clip”, and “track” are used interchangeably herein to indicate a section of video and/or audio content that is generally meant to indicate less than the entirety of the video or audio recording, but can also include the entirety of a video or audio recording, and/or image, for example. Additionally, these words, as used herein can have the same meaning, such as to indicate a piece of media content. A scene generally indicates a portion of a video or a segment of a video, for example, however, this can also apply to a song or audio content for purposes herein to indicate a portion or a piece of an audio bite or sound recording, which may or may not be integral to or accompany a video.

Multimedia Message Having Portions of Media Content with Audio Overlay

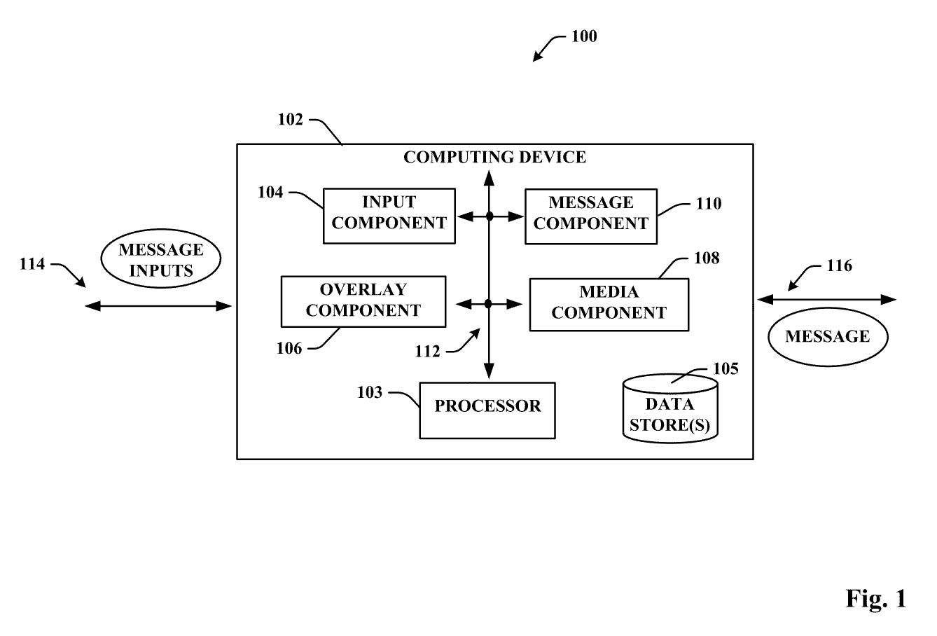

Initially referring to FIG. 1, illustrated is an example system 100 that generates a multimedia message in accordance with various embodiments disclosed. System 100 can include a memory or data store(s) 105 that stores computer executable components and a processor 103 that executes computer executable components stored in the data store(s), examples of which can be found with reference to other figures disclosed herein and throughout. The system 100 includes a computing device 102 that can include a mobile device, a smart phone, a laptop, personal digital assistant, personal computer, mobile phone, a hand held device, digital assistant and/or other similar devices, for example.

The computing device 102 receives a set of message inputs 114 via a text based communication (e.g., short messaging service), a voice input, a predefined selection input, a query term and/or other input. The message inputs 114 can include words, phrases, and/or images for a media message 116 to be generated from the inputs. The media message 116 (multimedia message) can include one or more portions of images including video images or sequences, photos, associated audio content, and the like, which respectively correspond to the content of the message inputs (e.g., words or phrases). For example, the multimedia message can be a sequence of media content portions that are extracted from different video, image, and/or audio content, in which each of the extracted portions conveys at least a part of the message comprised within the message inputs 114, such as a word, a phrase, and/or image received in the message inputs 114. The multimedia message 116 can included different formats of media content within the same message, such as partially audio content portions, image content, and/or video content, which can be associated with one another in the media segments or separate from one another. The multimedia message, for example, can have different formats from the message inputs 114, which enables the message 116 to convey a dynamic, personalized message that is communicated electronically as a multimedia text message, such as a video message, or, in other words, a sequence of one or more media content portions that convey the original message received in the message inputs 114, for example. The computer device 102 includes an input component 104, an overlay component 106, a media component 108 and a message component 110.

The input component 104 is configured to receive the message input 114 having a first set of words or phrases for generation of the message 116. The input component 104, for example, can receive a text message or other type message from a device or system, such as from a mobile device, smart phone, or any other networked device having a network connection or other type connection. Alternatively or additionally, the input component 104 can receive a selection input having the first set of words or phrases. For example, a touch input at a touch screen (not shown) and/or other input can be received to select from among a number of predetermined words or phrases. The input component 104 can also receive a query terms such as at a search engine field for as a first set of words or phrases. Other inputs can also be envisioned as being received and having the first set of words or phrases, such as a voice input, a thought invoked input, or any other input that can provide a word and/or phrase and be received by the input component 104.

The media component 108 is configured to generate, determine or identify portions or segments of media content that can include movies or films presented in a public theater, home videos, photos, pictures, images, audio content including songs, speeches, books, associated with or not associated with any of the other media content, for example. Each of the portions of media content or media content portions can include a timed segment of video or imagery with audio or without audio corresponding to it. The media component 108 is configured to determine a set of media content portions that respectively correspond to words or phrases according to a set of predetermined criteria.

The overlay component 106 is configured to overlay an audio content portion with a video content portion for a multimedia message 116. A media content portion determined by the media component 108 can have audio content in associated with it, or not have audio content associated with it. The overlay component 106 operates to examine the audio content portions generated from media content and remove, extract, identify, replace and/or combine the audio content portion with a video content portion that the audio content portion is not originally associated with.

For example, media component 108 can determine a first audio content portion that could be associated with a first video content portion, such as a cartoon clip of Porky Pig saying, “That's all Folks!” The video content portion includes Porky Pig moving his mouth, and the audio content portion includes the audio “That's all Folks!” In addition, the media component 108 can determine another second audio content portion and/or another second different video content portion that is associated or not associated with one another in a video clip, and that is based on the message inputs received as well as predetermined criteria, set of classification criteria, and/or user preferences. For example, the second different video content could be a scene with a movie having Marlyn Brando, or any preferential performer as asserted by a set of user preferences based on an actor or performer of choice, for example. The second video portion having Marlyn Brando could be overlaid with the first audio content portion so that Marlyn Brando appears to convey the message of the message inputs with a different or a first audio content portion generated. As such, the voice of Marlyn Brando could say “That's all Folks!” in the voice of Porky the Pig. Any number of variations and examples are envisioned in this disclosure, and the overlay component 106 can be considered an audio overlay component, as well as a textual overlay, or other such overlay component for overlaying media content portion (e.g., audio content) over video content portions and/or image content portions.

In one embodiment, the set of inputs 114 could be a set of voice inputs such that the voice inputs themselves are entered into the media component 104 for analysis and classified as at least part of the set of media content stored in one or more data stores for the generation of media content portions and for incorporated into the multimedia message. The voice inputs can be identified as being associated with the criteria for media content portions and identified, for example, according to a match of the words or phrases ascertained from the inputs, as candidates for media content portions to be integrated into a multimedia message. The overlay component 106 is configured to operate by overlaying the audio content portion having the sender or message deliverer's voice. The audio content portions can be broken into words or phrases as optional candidates for incorporation. At least one of the optional candidates can then be overlaid with a video content portion that is also determined to correspond or be associated with the message inputs received.

In one example, a sender's voice could provide the message “I'll be back.” At least one audio content portion generated by the media component 104 could be the sender's voice “I'll be back,” and one other video content portion having an associated audio content portion could be Arnold Schwarzenegger's voice saying, “I'll be back” and the video content portion of him saying the words in the 1984 movie “The Terminator.” A third media content portion, for example, can thus be generated via the overlay component 106 with the sender's voice saying “I'll be back” in association with Arnold mouthing the phrases in the video content portion from the movie, “The Terminator.”

In another embodiment, the overlay component 106 can operate to discern multiple voices or sounds from within a media content portion. For example, a video clip could be generated as having multiple different sounds within it such as a rock falling on top of a coyote while a roadrunner is beeping, which is common in the cartoon “Road Runner.” The sounds within the media content portion can be distinguished and either removed or shifted to overlay another media content portion even though they possibly do not relate to the original set of message inputs except that other indicators within the same portion do relate. This enables the further advantage of a user being able to classify sounds and video portions on the fly, for future use, and/or within the immediate multimedia message being generated or not.

In one example, a segment from the movie “Gone with the Wind” could be generated by the media content component 104, in which Clark Gable's role says, “Frankly my dear, I don't give a damn” to Vivien Leigh's role. The music playing in the background could then be removed as one of the audio content portions identified within the media content portion. The overlay component could then overlay another music audio portion instead, which could be stored, generated or communicated thereto.

The message component 110 is configured to generate the multimedia message with the set of media content portions. For example, the components of the computing device 102 are communicatively coupled with one another via a communication connection 112 (e.g., a wired and/or wireless connection). The message component 110 is communicatively coupled to and/or includes the input component 104, the overlay component 106 and the media component 108 that operate to convert a set of message inputs that represent, include or generate a set of words or phrases to be communicated by a client device and/or a third party server in a multimedia message.

The message component 110 is configured to generate media content portions that include video portions of a video mixed with audio portions that individually, or both correspond to words or phrases of the message inputs 114. For example, the media component 108 is configured to generate video scenes that correspond to a word or phrase of a text message, in which the audio of the movie can correspond thereto, or generate some other media content corresponding to the textual word or phrase generated within the message inputs and/or received by the input component 104.

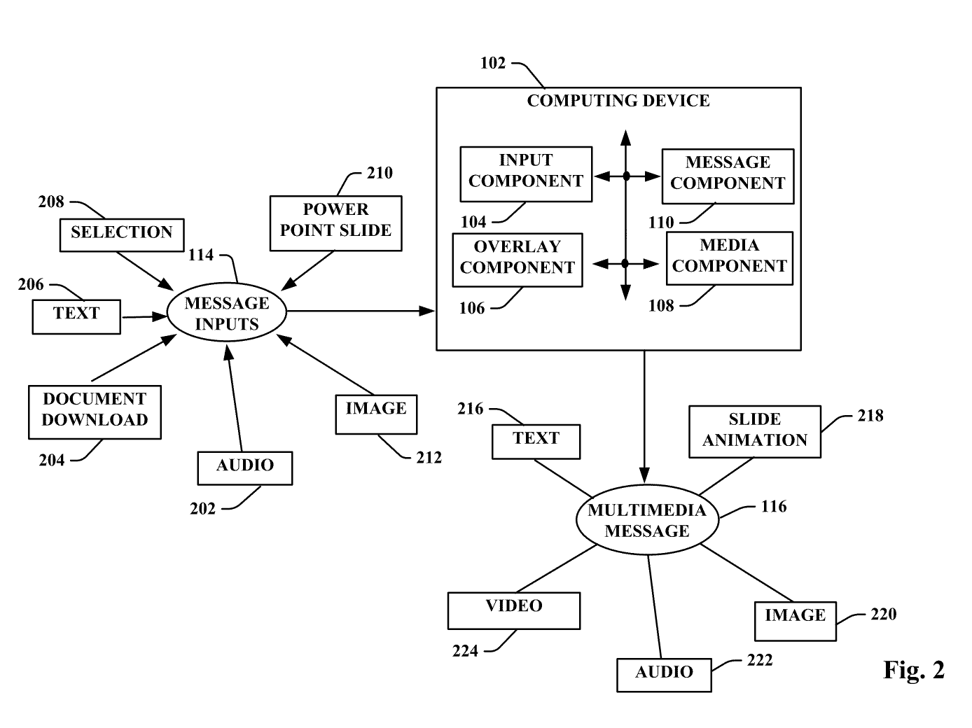

Referring now to FIG. 2, illustrated is an example of various kinds of message inputs that can be entered into the system 100 and any of the example system architectures described herein. For example, the message inputs 114 can be various types of inputs including one or more different formats that convey the message to be made in a multimedia message.

In one embodiment, one or more message inputs 114 can include words, phrases or actions in a video that convey a message, such as an audio input 202, a document input or document download 204, a text input 206, a selection 208, a power point slide or other slide 210 with or without animation, image 212 and/or other input data of a format. The inputs 114 can include one type of input having one or more words, phrases and/or actions therein, or can include various types of inputs such as from the examples of the audio input 202, the document input or document download 204, the text input 206, the selection 208, the power point slide or other slide 210 with or without animation, the image 212 and/or other input data of another format.

Further, the set of inputs can be used to generate media content portions via the computing device 102 that are overlaid with or have the different formats in the message inputs and/or additional or different formats for the multimedia message 116. The multimedia message 116 can include various media content portions including a text content portion 216, a slide portion or slide animation portion 218, an image content portion 220, an audio content portion 222, a video content portion 224, and/or any other media content portion that is overlaid or sequentially concatenated in the multimedia message.

In one example, the multimedia message can include audio content portions that are outputted as podcasts corresponding to the message inputs with images and/or video. In another example, the message input 114 can include a document or a set of text that is processed by the computing device 102 and media content portions transcript the text according to video and/or audio from various types of media content. In another example, screenshots are provided as images with voices that are overlaid by the overlay component 106 in order to provide commentary to the screenshots (e.g., video screenshots, or any other captured/created image) as audio content portions overlaid to video content portions.

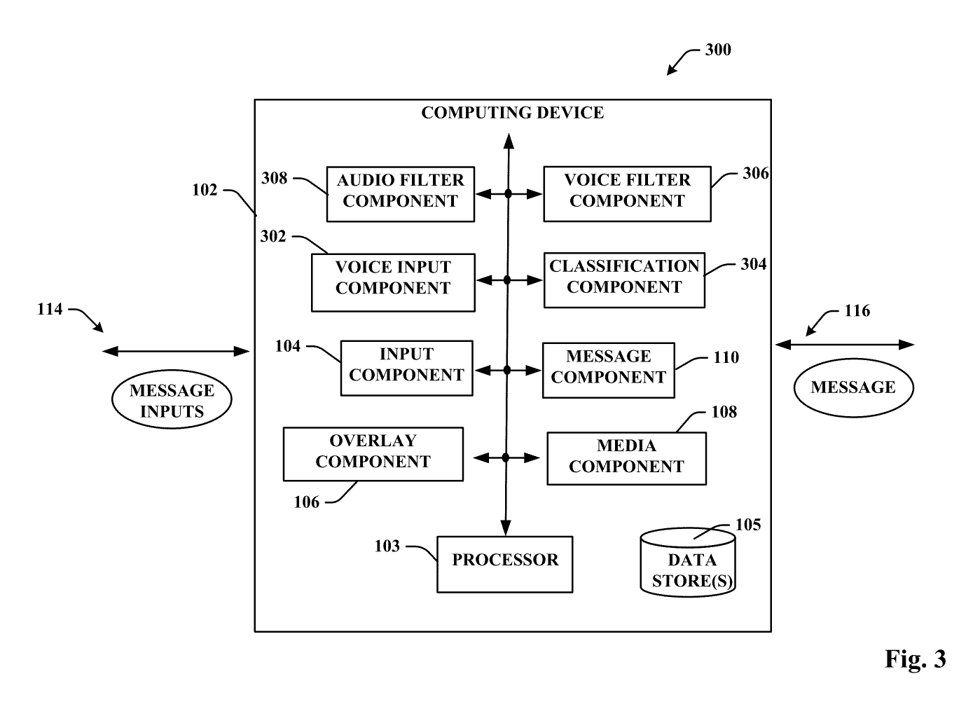

Referring to FIG. 3, illustrated is an example system 300 for generating messages in accordance with various embodiments disclosed. System 300 includes the computing device 102 that operates with various components disclosed in this disclosure. Similar components as discussed above comprise the example architecture of the computer device 102, and other architectural configurations are also envisions. For example, in addition to the components discussed above, the computing device 102 includes a voice input component 302, a voice filter component 304, a classification component 306 and an audio filter component 308.

The voice input component 302 is configured to receive a voice input as the message input having a set of words or phrases for generation of the multimedia message. For example, a user could desire to generate a multimedia message 116 stating that “red hot peppers burn you.” The message inputs could be a voice input having a command such as “computer, find: red hot peppers burn you.” The voice input component 302 of the computer device 102 analyzes the voice message to provide textual data with the words or phrases “red hot peppers burn you.” In response, the words or phrases determined are processed by the media component for determining various media content portions of media content (e.g., video segments, audio segments, image portions, etc.).

The voice input component 302 is further configured to associate the set of words or phrases of the voice input to the video content portion as audio content that corresponds to the video content portion. For example, the media component 108 determines different media content portions that include audio content and video content portions that either have audio associated therewith or do not have audio associated therewith. In response to a user preference, and/or classification criteria, the voice input “red hot peppers burn you” generates various media content portions in which the video portions have the voice of the user providing “red hot peppers burn you” as the audio content portion of the video content portions generated. The user can then select the best or desired video content portions with his or her own voice stating the message, but from a different actor or actress, and/or in different contexts of video content portions generated prior to the voice input “red hot peppers burn you” being received. The voice input component 302 is further configured to remove any audio content originally associated with the video content portion and via the overlay component 106 associate the set of words or phrases of the voice input with the video content portion.

In another example, the classification component 304 operates in conjunction with other components, such as with the voice input component 302. The classification component 216 is configured to receive a set of classification options for the set of classifications in order to set criteria by which components of the computer device 102 generate multimedia messages. The set of classifications include at least one of a set of themes selected to correspond with the set of media content, a set of song artists selected to correspond with the set of media content, a set of actors selected to correspond with the set of media content, a set of titles (albums titles, movie titles, book titles, song titles, etc.) selected to correspond with the set of media content, a set of media ratings of the set of media content, a voice tone selected to correspond with the set of media content, a time period selected to correspond with the set of media content and/or a personal media content preference selected to correspond with the set of media content from a personal video or audio stored in a data store, such as a characteristic pertaining to the media content portions.

In one embodiment, the phrase “red hot chili peppers burn you” can be entered by voice command and analyzed by the voice input component 302 for words or phrases. The words and phrases can be used to determine/generate media content portions. A voice input can further be used to enter classification criteria and/or user preferences to the classifications component 304 for determining the media content portions. For example, a classification and/or user preference can be set to generate video content portions having Marlyn Brando's voice. The media component 108 can then generate media content portions with Marlyn Brando and any other predetermined criteria/classification criteria/user preference such as a match of audio content in the video content portions with words or phrases of the message inputs (e.g., voice inputted words or phrases). A query can be specified with the voice inputs and further focusing the search to details within the video content portions, such as “red hot chili peppers burn you” with Marlyn Brando and red sun burned women, with the additional specification that the women are overweight or heavy. Multiple examples can be generated to narrow or further define the determination of media content portions with voice and/or text input for generation of a multimedia message according to inputs received.

The voice filter component 306 is configured to separate the video content portion from the audio content portion so that the different portions are presented as options to a user for selection, and/or insertion into the multimedia message and/or to be correlated with a word or phrase later use. The audio filter component 308 is configured to identify different audio signals within the audio content portion of the media content. In other words, the audio filter component 308 identifies the different audio signals with an originating source.

For example, the audio filter component 308 can operate to discern multiple voices or sounds from within a media content portion. For example, sounds within media content portions can be distinguished and either removed or shifted to overlay another media content portion even though they possibly do not relate to the original set of message inputs. This enables the further advantage of a user being able to classify sounds and video portions on the fly, for future use, and/or within the immediate multimedia message being generated or not.

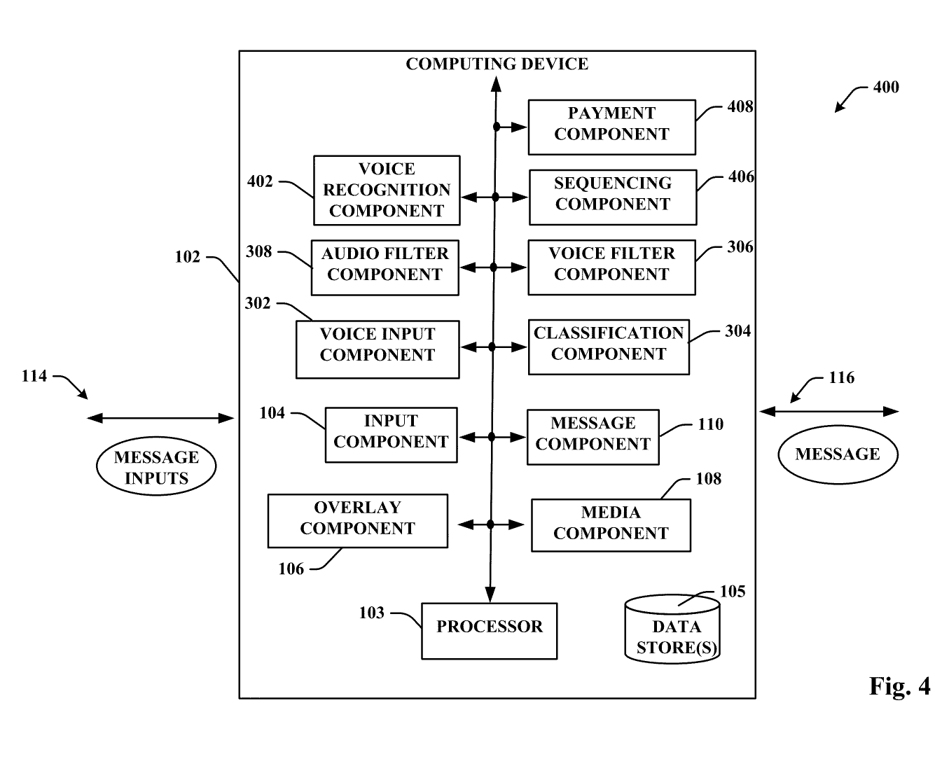

Referring to FIG. 4, illustrated is an example of system 400 in accordance with various embodiments described herein. The computing device 102 further includes a voice recognition component 402, a voice filter component 406 and a payment component 408.

The voice recognition component 402 is configured to analyze the audio content portion to identify different voices originating from different persons respectively. For example, voices from Marlyn Brando can be identified or matched with voices of other media content portions also having Marlyn Brando's voice. In addition, media content portion generates in response to a match of words or phrases in the segment matching words or phrases of the message inputs can have other voices within the portion, which can also be identified from the originating person or as words or phrases being spoken within the same portion. The voice recognition component 402 identifies different voices within one or more audio content portions of the media content based on a set of classification criteria including, a theme, a song, a speech, an originating person that vocalizes the audio content, and/or according to a characterization of the video content that the audio content is originally associated with. For example, the audio content can recognize a voice in response to a seasonal theme, as a famous speech (e.g., the “I have a dream” speech by Martin Luther King). Characteristics of each voice are able to be ascertained to voices within the media content portions to further classify, organize and identify the media content portions having audio content portions identified.

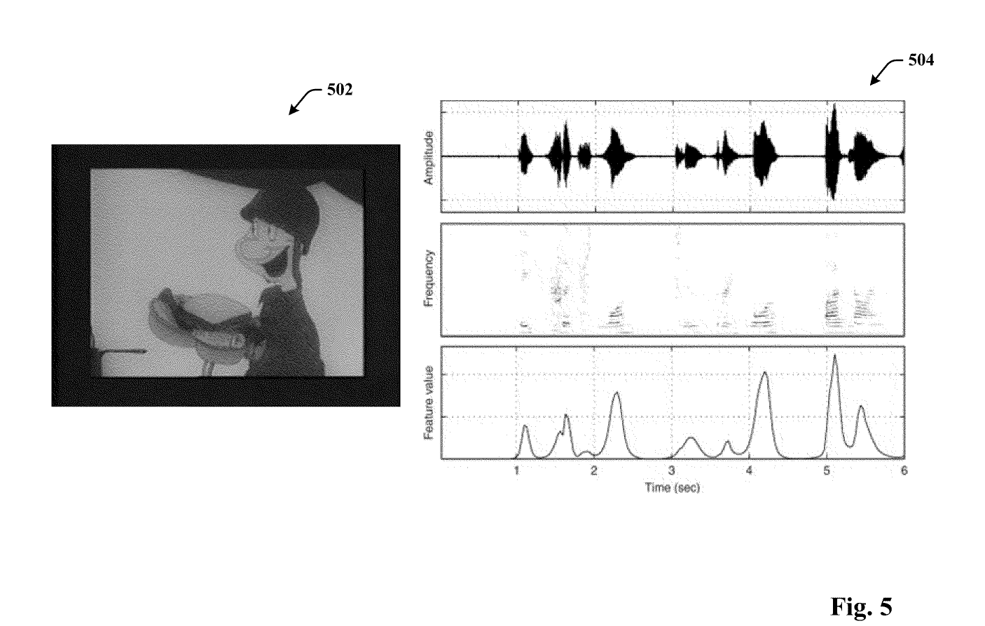

The sequencing component 404 is configured to align the video content portion with the audio content portion in a matching time sequence, and associate the audio content portion and the video content portion to convey the word or the phrase received by the message input in the multimedia message. The result being shown in FIG. 5, where a video content portion 502 and an audio content portion 504 that is not originally associated with the video content portion 502 is sequenced together in a timed sequence so that the cartoon character stating “how about a sandwich” is played or generated with another audio content portion stating something different or the same words with a different voice.

The payment component 408 is configured to assign a cost or a charge to at least one of the audio content portion or the video content portion generated within the multimedia message. For example, a charge or a cost can be billed to each portion of media content that is incorporated into a multimedia message. The payment component 408 for example can identify a copyrighted portion having Marlyn Brando's voice, for example, and bill a cost or charge based on the copyright or some other criteria for billing a user of the media content portion for multimedia message generation.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases. Reference may be made to the figures described above for ease of description. However, the methods are not limited to any particular embodiment or example provided within this disclosure and can be applied to any of the systems disclosed herein.

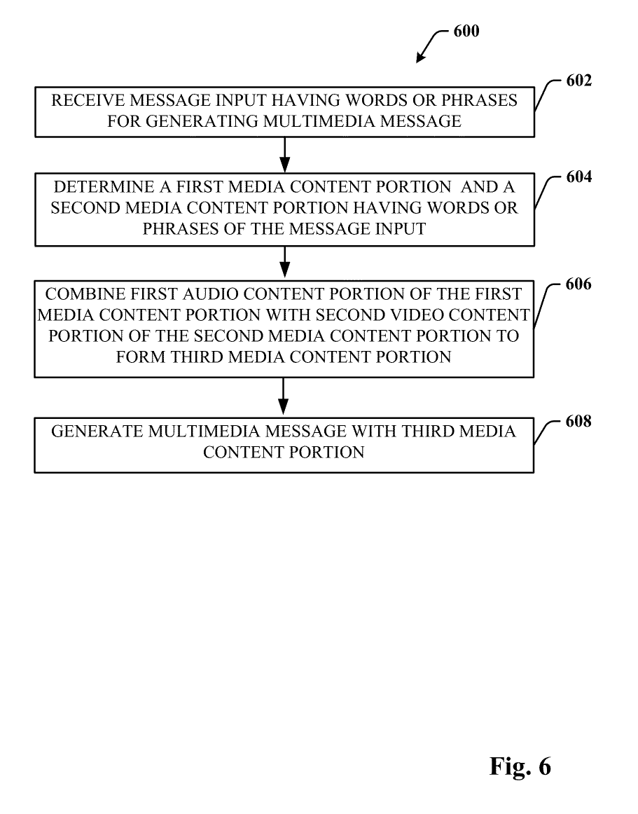

Referring to FIG. 6, illustrates a method 600 for a messaging system in accordance with various embodiments disclosed herein. The method 600 initiates at 602 and includes receiving, by a system including at least one processor, a message input having a set of words or phrases for generating a multimedia message. At 604, the method includes determining, from media content, a first media content portion that includes a first audio content portion of a first video content portion and a second media content portion that includes a second audio content portion of a second video content portion, wherein the first media content portion and the second media content portion correspond to the set of words or phrases of the message input based on a set of predetermined criteria, for example. The set of predetermined criteria can include at least one of an action, a facial expression, an audio word or phrase spoken or a characteristic about an event or person including at least one of a facial expression, an action, words or phrases spoken, in a portion media content that corresponds to the set of words or phrases received as inputs.

At 606, the first audio content portion is combined with the second video content portion to form a third media content portion, and at 608 a multimedia message is generated that includes the third media content portion.

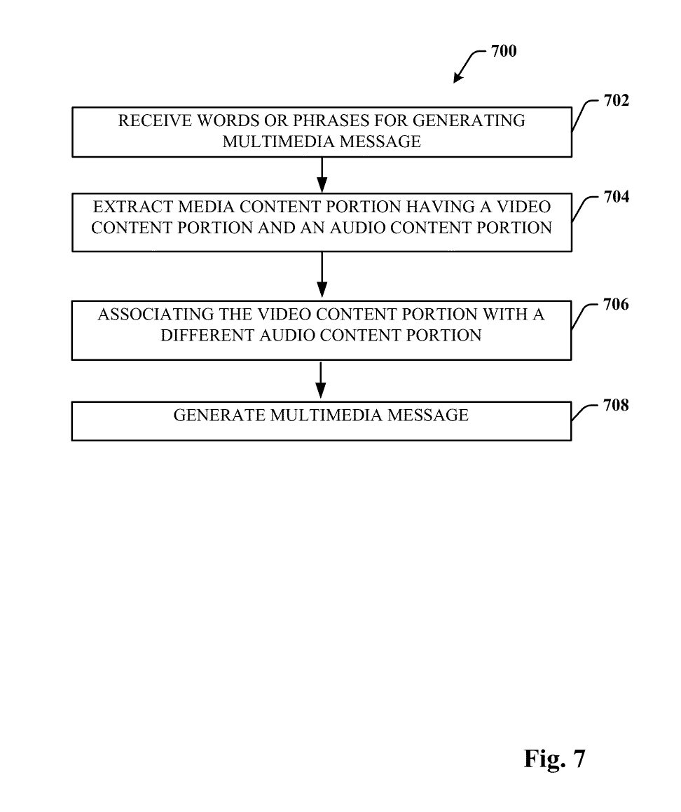

An example methodology 700 for implementing a method for a system for media content is illustrated in FIG. 7. The method 700, for example, provides for a system to evaluate various media content inputs and generate a sequence of media content portions that correspond to words, phrases or images of the inputs. At 702, the method initiates with receiving a set of words or phrases for generation of a multimedia message having a media content portion corresponding to the set of words or phrases. At 704, the method includes extracting the media content portion having a video content portion and an audio content portion from a set of media content corresponding to the set of received words or phrases. At 706, the method includes associating the video content portion of the media content portion with a different audio content portion of a different media content portion that corresponds to the set of received words or phrases. At 708, the multimedia message is generated with at least one media content portion that corresponds to the set of received words or phrases and includes the video content portion associated with the different audio content portion.

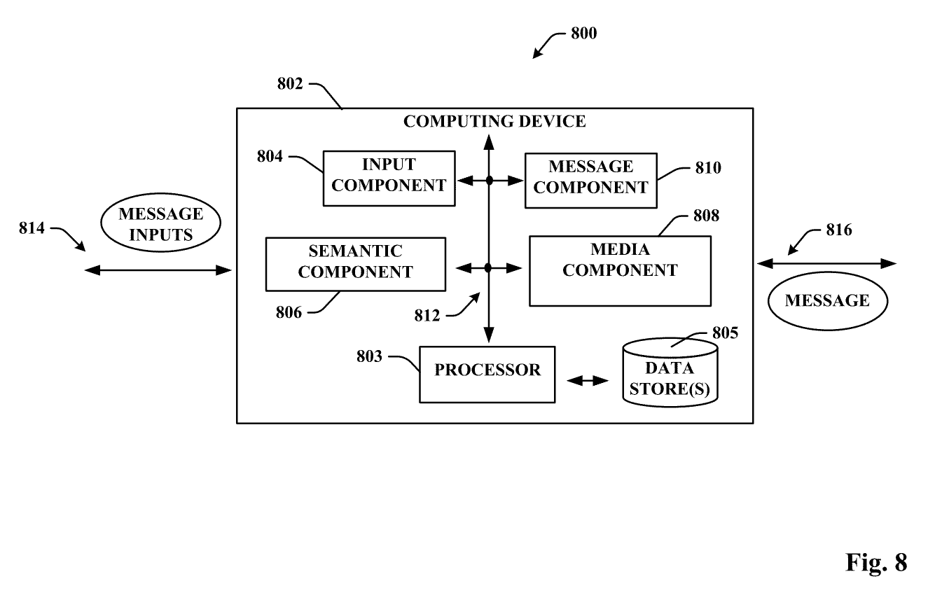

Referring to FIG. 8, illustrated is an example messaging system for generating multimedia messages in accordance with various embodiments disclosed. System 800 can include a memory or data store(s) 805 that stores computer executable components and a processor 803 that executes computer executable components stored in the data store(s), examples of which can be found with reference to other figures disclosed herein and throughout. The system 800 includes a computing device 802 that can include a mobile device, a smart phone, a laptop, personal digital assistant, personal computer, mobile phone, a hand held device, digital assistant and/or other similar devices, for example.

The computing device 802 receives a set of message inputs 814 via a text based communication (e.g., short messaging service), a voice input, a predefined selection input, a query term and/or other input. The message inputs 814 can include words, phrases, and/or images for a media message 816 to be generated from the inputs. The media message 816 (multimedia message) can include one or more portions of images including video images or sequences, photos, associated audio content, and the like, which respectively correspond to the content of the message inputs (e.g., words or phrases). The multimedia message can be a stream of media content portions that are extracted or segmented from different video, image, and/or audio content, in which each portion conveys a part of the content comprised within the message inputs 814, such as a word, a phrase, and/or image therein. The multimedia message 816 can included different formats of media content within the same message, such as partially audio content portions, image content, and/or video content. Alternatively, the message 816 can include entirely audio, entirely video, or entirely image content. The multimedia message, for example, can have different formats from the message inputs 814, which enables the message 816 to convey a dynamic, personalized message that is communicated electronically as a multimedia text message, for example, or via any other communicated means (e.g., electronic mail, etc.). The computer device 802 includes an input component 104, a semantic component 806, a media component 808 and a message component 810.

The input component 814 is configured to receive the message input 814 having a first set of words or phrases for generation of the message 816. The input component 804, for example, can receive a text message such as from a mobile device, for example. Alternatively or additionally, the input component 804 can receive a selection input having the first set of words or phrases. For example, a touch input at a touch screen (not shown) and/or other input can be received to select from among a number of predetermined words or phrases. The input component 804 can also receive a query terms such as at a search engine field for as a first set of words or phrases. Other inputs can also be envisioned as being received and having the first set of words or phrases, such as a voice input, a thought invoked input, or any other input that can provide a word and/or phrase and be received by the input component 804.

The semantic component 806 is configured to determine a second set of words or phrases that are different from the first set of words and phrases received by the input component 804 and that further have the same or a similar definition as the first set of words or phrases. The semantic component 806 operates to ascertain a semantic meaning of words or phrases inputted into the system 800. A semantic meaning, for example, can include a meaning or relation between words, phrases and/or symbols (images) and the perspective, interpretation and/or ideas in which the words, phrases and/or signs convey or relate to. The semantic component 806 can define a second set of words or phrases based on the semantic meaning of the first set of words or phrases, as well as include various meanings to the first set of words or phrases that differ from the second set of words or phrases, and in which have different second sets of words or phrases associated with those corresponding meanings. The second set of words or phrases, for example, can be a set of synonyms or words that have the same meaning or a similar meaning. In addition, the second set of words or phrase can have different meanings, in which one or more definitions are similar or synonymic to the first set of words or phrases.

In one example, the phrase “You are hot!” can be received by the input component via a voice command input, and/or a text message received. The semantic component 806 interprets the meaning of “You are hot!” and generates a semantic meaning and/or a set of semantic meanings, which can include examples such as “You are beautiful,” “You are sexy,” “You are of a high temperature”, “You are ill,” “You feel warm,” as phrases that could have any one of a possible meanings similar to the phrase received “You are hot!.” In addition, the words received can individually have meanings determined by the semantic component 806 such as “You” “are” and “hot.” While the words “You” and “are” are limited in scope to the number of definitions associated to them (e.g., one or two definitions), the word “hot” has a multiplicity of definitions, in which synonyms can include the following: heated, fiery, burning, scalding, boiling, torrid, sultry, biting, piquant, sharp, spicy, fervid, fiery, passionate, intense, excitable, impetuous, angry, furious, irate, and/or violent, for example, as taken from standard English definition. The semantic component 806 is thus operable to define any number of definitions or meanings to a phrase as well as to individual words incorporated within the phrase. In one embodiment, the second set of words or phrases can include word or phrases of a different language and/or a different alphabet, syllabaries, ideograms, (e.g., Pinyin, Hindi, Cyrillic, Latin, etc.) than from the first set of words or phrases, which can be in addition or alternatively to the various meanings, interpretations, semantic meanings ascertained to individual words and/or phrases of the message inputs received by the input component 804.

The media component 808 is configured to generate, determine or identify portions or segments of media content that can include movies or films presented in a public theater, home videos, photos, pictures, images, audio content including songs, speeches, books, associated with or not associated with any of the other media content, for example. Each of the portions of media content or media content portions can include a timed segment of video or imagery with audio or without audio corresponding to it. The media component 808, in response to the first set of words or phrases and the second set of words or phrases ascertained by the semantic component 806, generates a set of media content portions that correspond to the ascertained meanings, the words, and/or phrases from the first set of words or phrases, and/or the second set of words or phrases. For example, words or phrases of the text input can be associated with words and phrases of a video sequence. In addition or alternatively, the media component 808 is configured to dynamically, in real time generate corresponding video scenes, video/audio clips, portions and/or segments from an indexed set of videos stored in a data store, a third party server, on a network (e.g., a cloud network or the like), an additional device, and/or other like.

The media component 808 is configured to determine a set of media content portions that respectively correspond to words or phrases and/or an interpretive meaning of words or phrases according to a set of predetermined criteria, such as by storing and grouping the media content portions or segments, for example, according to words, action scenes, voice tone, a rating of the video or movie, a targeted age, a movie theme, genre, gestures, participating actors and/or other classifications, in which the portion and/or segment is corresponded, associated and/or compared with the phrases or words of received inputs (e.g., text input). In one example, a user, such as a user that is hearing impaired, can generate a sequence of video clips (e.g., scenes, segments, portions, etc.) from famous movies or a set of stored movies of a data store without the user hearing or having knowledge of the audio content. Based on the set of text inputs the user provides or selects, portions of video movies/audio can be provided by the media component 808 for the user to combine into a concatenated message according to semantic meanings or definitions of words or phrases. The message can then be communicated by being played with the sequence of words or phrases of the textual input by being transmitted to another device, and/or stored for future communication. The media component 808 therefore enables more creative expressions of messaging and communication among devices.

The message component 810 is configured to generate the multimedia message with the set of media content portions. For example, the components of the computing device 802 are communicatively coupled with one another via a communication connection 812 (e.g., a wired and/or wireless connection). The message component 810 is communicatively coupled to and/or includes the input component 804, the semantic component 806 and the media component 808 that operate to convert a set of inputs that represent, include or generate a set of words or phrases to be communicated by a client device and/or a third party server.

The message component 810 is configured to generate media content portions that include video portions of a video mixed with audio portions that individually, or both correspond to words or phrases of the message inputs 814. For example, the media component 808 is configured to generate video scenes that correspond to a word or phrase of a text message, in which the audio of the movie can correspond or some other content correspond to the textual word or phrase generated by the semantic component 806 and/or received by the input component 804.

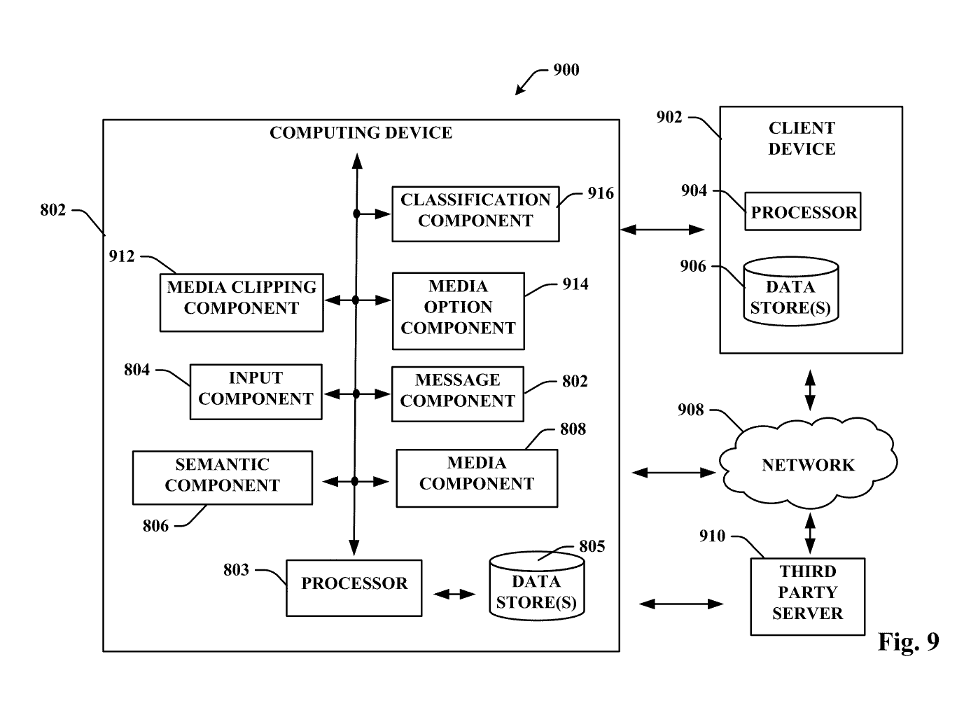

Referring now to FIG. 9, illustrated is an example messaging system 900 for generating multimedia messages in accordance with various embodiments disclosed. The computing device 802 includes components similar in function as discussed above and throughout this disclosure. The computing device 802 further includes a media clipping component 912, a media option component 914 and a classification component 916.

The system 900 with the computing device 802 further illustrates one example architecture like the system discussed herein for generating a multimedia message from a set of inputs, in which the inputs are message inputs such as text inputs based on one format and the multimedia message conveys an equivalent or similar message in a different or second format (e.g., video, etc.) with different portions of different media comprised in the message. The computing device 802, for example, is in communication with a client device 902 having a processor 904 and one or more data stores 906 for storing and/or receive multimedia messages. The computing device 802 is further operable to communication with a network 908, which can include a Local Area Network, a Wide Area Network, a cloud based network, and the like. The computing device 802 can also communicate multimedia messages to a third party server 910 and/or any other system or device operable to receive multimedia communication. The multimedia message generated by the computing device 802 is able to be shared among various systems and/or device, such as from the network 908 (e.g., a cloud network, etc.), the client device 910 and the third party server 910 via the network 908 or in a direct communication therebetween.

The media clipping component 912 of the system 900 operates as an extraction or splicing component in order to extract, splice and/or clip various portions of media that are identified or determined by the semantic component 906 and the media component 908. In one embodiment, the media clipping component 912 is configured to splice the set of image content and extract the set of media content portions according to the portions identified by the media component 808 and from a set of predetermined criteria. For example, images within the set of images can be spliced, or extracted based on a matching of audio content, an action, an expression, an emotion and/or any intended meaning as ascertained by the semantic component 806 with one or more words or phrases. In addition or alternatively, the media clipping component 912 can extract media content portions according to a set of classification criteria as discussed above (e.g., a theme, actor, holiday, event, time period, rating, audience, age category, performer, object within a media content portion and/or the like). The portions identified by the media component, for example, can be marked based one parameters of an image, video audio portion that are defined based on the classification criteria, user preferences and/or the predetermined criteria discussed herein. The media content portions determined are then further spliced in order to be placed, integrated, combined and/or concatenated together with other media content portions in a multimedia message. In another embodiment, the extracted portions or media content portions can be sorted in the data store 805, the client device 902, the network 908, and/or the third party server 910 in order to be further classified and/or tagged with a word or phrase by a user and then shared.

The media option component 914 is configured to generate the set of media content portions generated from the media clipping component 912 as a set of options that can be selected as corresponding with the first set of words or phrases. The options can be classified, defined by user preferences, and/or extracted from a personal data store and/or a public data store having images from other personal data stores or content viewed in a public exhibition, theater, sound bite, etc. The selection received at the media option component 914 can provide for a correlation with the set of words or phrases based on a selected option provided by user. A user, for example, could prefer a media content portion generated in response to any number of meanings that the semantic component 806 attached to the first set of words or phrases. In this way, a user is provided multiple options and personalization to a multimedia message. For example, rather than the word “hot” meaning a temperature level, a user could use media content portions portraying and/or sounding in audio the word “spicy.” In one example, an option presented to a user therefore could be an image of an Indian Ghost Pepper, which is the hottest pepper currently known to mankind and used in warfare. The media option component 914 presents the media content portions to a user for incorporation into the multimedia message 816, for storing, sharing and/or communicating alone.

In another example, the photo or images of the Indian Ghost Pepper can be stored, and a further set of words or phrases could be entered by a user as the first set of words or phrases. Thereafter, the stored image of the Indian Ghost Pepper could be used as a segment of the multimedia message in conjunction with other words or phrases in which a meaning has been ascertained by the semantic component and an array of media content portions have been identified the media component 808. For example, a user could desire to convey the message discussed above “You are hot!” In the case where the Indian Ghost Pepper media content portion is stored as corresponding to the word “Hot” or the phrase itself (“You are hot!”), another set of words could be entered as “You make me feel.” After the system, generated media content portions corresponding to the words or phrase, the user could select the image or video sequence with the Indian Ghost Pepper to be incorporated at the end of the message to convey the message “You make me feel hot” or whatever meaning would be implied to “You make me feel (*image of Indian Ghost Pepper*). In order to focus the message, as discussed herein with other embodiments throughout, the textual word or phrase associated with the message could also be communicated in conjunction with the multimedia message comprising various media content portions. As also discussed in detail herein infra, audio content is one criterion in which the media content portions are generated for the multimedia message. As such, a combination of audio content within video content portions could convey the message “You make me feel” and the image of the Indian Ghost Pepper could be the last portion of the multimedia message then generated without any audio content. Alternatively, of course, the word “hot” could be associated with a variety of different media content portions as discussed herein. This example, however, provides one illustration among many possibilities of the diversity of the systems disclosed herein for generation of multimedia messaging.

The classification component 916 is configured to receive a set of classification options for the set of classifications in order to set criteria by which components of the system 900 generate multimedia messages. The set of classifications include at least one of a set of themes selected to correspond with the set of media content, a set of song artists selected to correspond with the set of media content, a set of actors selected to correspond with the set of media content, a set of titles (albums titles, movie titles, book titles, song titles, etc.) selected to correspond with the set of media content, a set of media ratings of the set of media content, a voice tone selected to correspond with the set of media content, a time period selected to correspond with the set of media content and/or a personal media content preference selected to correspond with the set of media content from a personal video or audio stored in a data store.

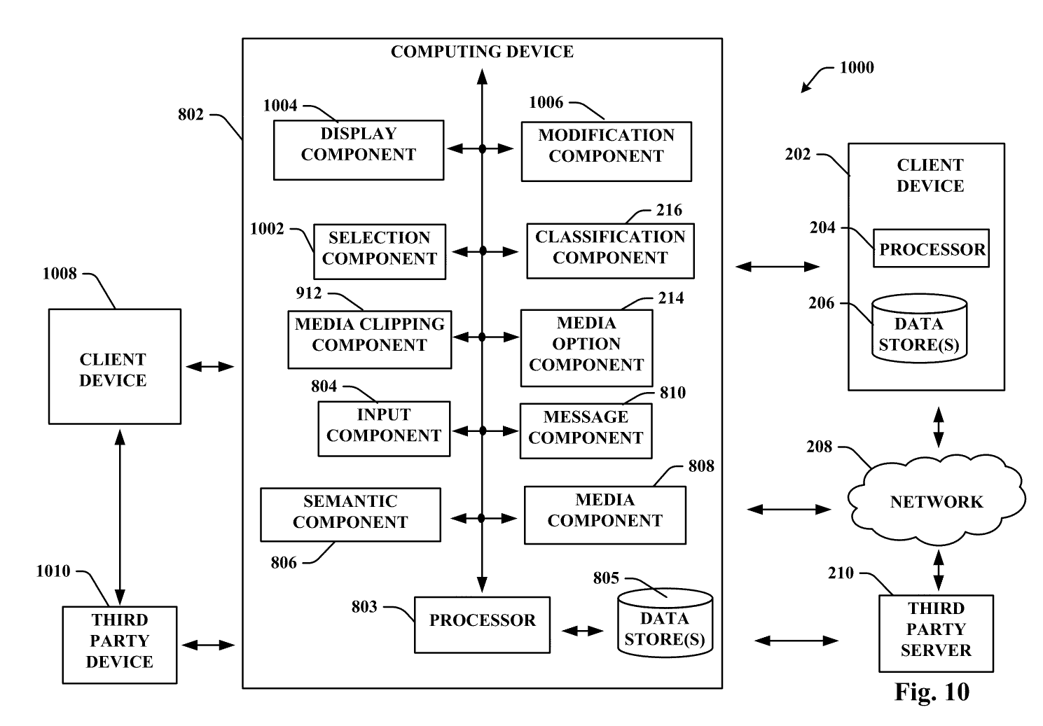

Referring to FIG. 10 illustrates a system 1000 for generating multimedia messages in accordance with various embodiments described herein. The system 1000 includes similar components discussed herein as well as a client device 1008 and a third party device 1010 that can store various forms of media content (video, image, audio, etc.) for use by the computing device 802. The computing device further includes a selection component 1002, a display component and a modification component 1006.

The system 1000 with the computing device 802 further illustrates example architecture like the systems discussed herein for generating a multimedia message from a set of inputs, such as from the client device 1008, the third party device 1010, and/or any other server, cloud network, data store, and the like. The computing device 802 can receive inputs from any client device of one format and then communicate a multimedia message in different formats, such as video, image, audio content that was not included in the inputs received. The inputs are message inputs such as text inputs based on one format and the multimedia message conveys an equivalent or similar message in a differing format (e.g., video, etc.) or additional formats with different portions of different media comprised in the message. The computing device 802, for example, is in communication with the client device 902 and/or any other device or server for transmitting the message (e.g., via a transceiver—not shown).

The selection component 1002 is configured to receive a selection that identifies a media content portion with a semantic meaning. For example, the media content portions that are correlated with according to a set of different words or phrases than the ones received can be modified by a user to have a different word or phrase associated with a media content portion. For example, a video segment or portion having a chili pepper associated with it can be edited to have a different word associated with it, such as “hot,” “spicy,” both and/or some other word. Any text accompany the media content portion within the multimedia message can have the corresponding text designated or selected to accompany it as well. The correlation with a word/phrase with the media content portion can then further edited to replace as well as add to additional words associated with the particular media content portions. Therefore, different meanings or sets of words can be connected and edited based on various intentions of the user providing the message inputs via the client device 1008 and/or some other device 1010, in which the multimedia message includes textual labels (words/phrases) connected to a media content portion, which can be then included in the multimedia message to convey a new and different message format for text messaging or other electronic messages.

The computing device includes a display component 1004 that can be a touch screen display on the computing device 1004, and/or any other type of display that renders text messages, multimedia messages as discussed herein, and/or any other graphic to the user as well as media content portion options according to various meanings respectively associated thereto. The modification component 1006 is configured to modify media content portions of the multimedia message. The modification component 1006, for example, is operable to modify one or more media content portions such as a video clip and/or an audio clip of a set of media content portions that corresponds to a word or phrase of the set of words or phrases that are communicated or ascertained by the semantic component 806 as having a similar meaning. In one embodiment, the modification component 1006 can modify by replacement of the media content portions with a different media content portion to correspond with the word or phrase identified or the meaning identified in the inputted message. For example, the message generated from the semantic meaning of the received inputs can include media content portions, such as text phrases or words (e.g., overlaying or proximately located to each corresponding media content portion), video clips, images and/or audio content portions. In one embodiment, the modification component 1006 can modify the message with a new word or phrase to replace an existing word or phrase in the message, and, in turn, replace a corresponding video clip. In addition, the modification component 1006 is configured to modify media content portions to be edited within the individual media content portions, so that segments or portions of the media content portions can be modified. For example, a media content portion can be modified by coloring an object a different color, as well as from cutting, splicing, segmenting, and/or pasting objects within the media content portions. For example, objects within one media content portion can be pasted into another media content portion. For example, the Indian Ghost Pepper could be pasted as lying on a bed and cut from a fruit bowl or a pepper tree. Additionally or alternatively, a video portion, audio portion, image portion and/or text portion can be replaced with a different or new video portion, audio portion image portion and/or text portion for the message to be changed, kept the same, or better expressed according to a user's defined preference or classification criteria. In addition or alternatively, the message component can be provided a set of media content portions that correspond to a word, phrase and/or image of an input for generating the message and/or to be part of a group of media content portions corresponding with a particular word, phrase and/or image.

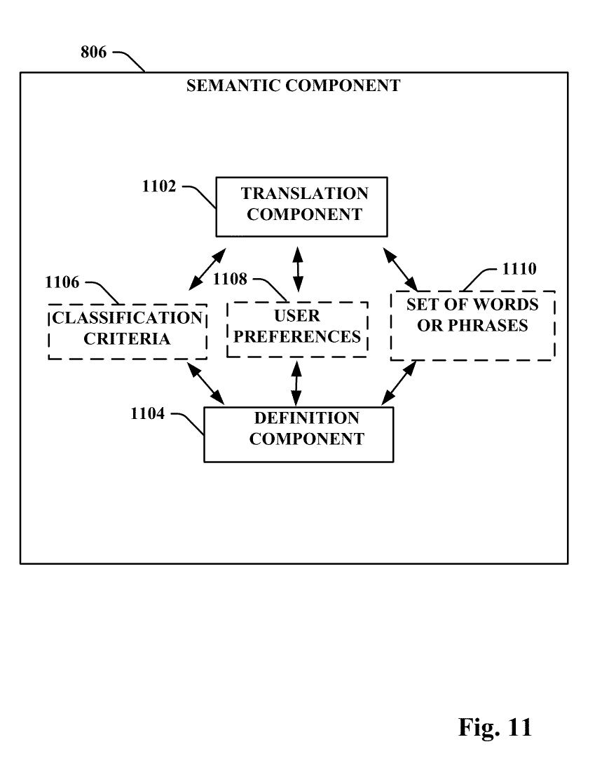

Referring to FIG. 11, illustrated is an example of the semantic component 806 in accordance with various embodiments disclosed herein. The semantic component 806 includes a translation component 1102 and a definition component 1104. The translation component 1102 operates to provide a second set of words or phrases from the first set of words or phrases received as message inputs for generation of a multimedia message that can have various media content portions from various types of media content. The definition component 1104 is configured to ascertain a definition of the received set of first words or phrases.

The definition component 1104 is operable to ascertain meanings of words or phrases based on their context as well as from a set of classification criteria 1106, user preferences 1108 and/or a first set of words or phrases 1110. For example, the definition component 1104 can process artificial intelligence such as fuzzy logic or expert system design logic with various filters (e.g., Bayesian filter, etc.). In a first example, the word “cool” can have multiple definitions. Here, “cool” can mean any number of definitions listed in a standard dictionary. In a second example, a phrase “You are cool” is ascertained and multiple definitions or interpretations of the phrases in accord with the definitions can be determined. These definitions likely do not vary much from the word “cool” in the first example. However, in a third example, the phrase “elephants are cool because they visit ancient elephant burial sites” the interpretive meanings can vary more based on the context. The word “cool” can further mean such things as “interesting,” “fascinating,” and the like, in which the context of “You are” with the word “cool” would not convey much difference from the standard dictionary definitions. The definition component 1104 is operable to generate one or more second set of words or phrases in order to enable media content portions to be identified among media content.

In addition, the translation component 1102 operates to provide one or more different languages to the first set of words or phrases and translates the first set of words or phrases 1110 according to the user preferences 1108 and classification criteria 1106 for the definition component 1104, which then further ascertains a set of meanings according to user preferences and/or classification criteria. For example, a set of words or phrases can be received and then based on the user preferences translated to English, the classification criteria can provide age ranges for definitions, and general interest, according to theme, a rating, time period for media content and the like discussed herein. A general category of slang, dialect, language, dictionary preferences, etc. can be used based on the user's set of classification criteria and the set of user preferences for a certain language and/or for a set of media content (movies, books, audio, etc.). Metadata can be obtained from media content to obtain a general profile of the user and to ascertain various meanings or interpretations of words or phrases. The interpretations or meanings can then be used by the media component or any of the splicing/extracting/portioning components discussed herein to extract media content portions that correspond to the meaning of the message inputs with classification criteria, user preferences and/or a second set of words or phrases.

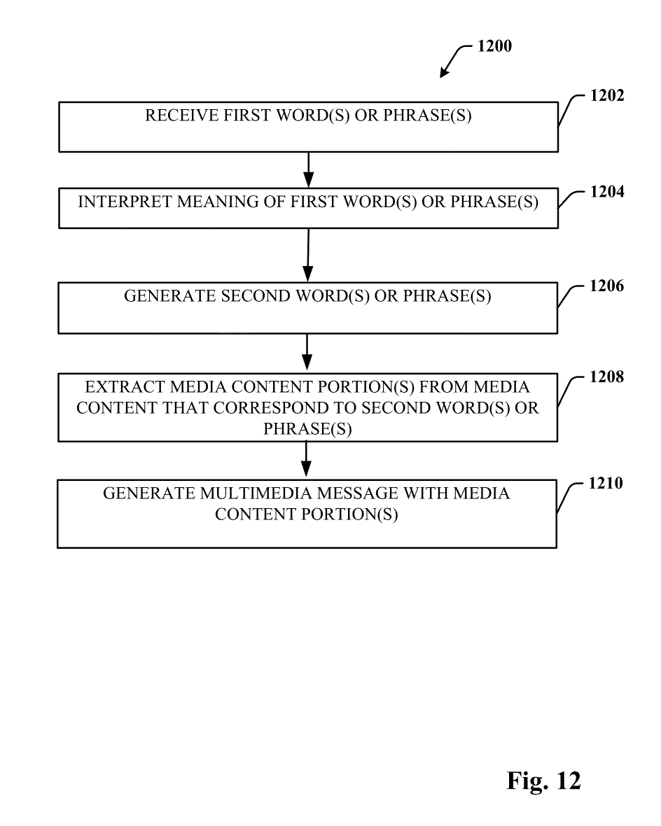

Referring to FIG. 12, illustrates a method 1200 for a messaging system in accordance with various embodiments disclosed herein. The method 1200 initiates at 1202, and includes receiving, by a system including at least one processor, a first set of words or phrases for generation of a multimedia message.

At 1204, a semantic meaning of the first set of words or phrases is interpreted for a semantic meaning or similar definition. At 1206, a second set of words or phrases that is different from the first set of words or phrases is generated, wherein the second set of words or phrases have the semantic meaning. At 1206, a set of media content portions is extracted from media content that correspond to the second set of words or phrases. The multimedia message is then generated with the set of media content portions.

In one embodiment, the set of media content portions are extracted from the media content based on a set of predetermined criteria including at least one of a match of the second set of words or phrases with audio content associated with the set of media content portions. The set of media content portions that correspond to the second set of words or phrases can be modified to a different set of media content portions to correspond to the second set of words or phrases. A set of classification criteria can be received that include at least one of a theme, an event, a title, a rating, a voice tone, a time period, a date, a language, a person or performer, a country, a demographic or a characteristic related to the media content, which can be used to generated a meaning of words or phrases, identify media content portions and extract them accordingly.

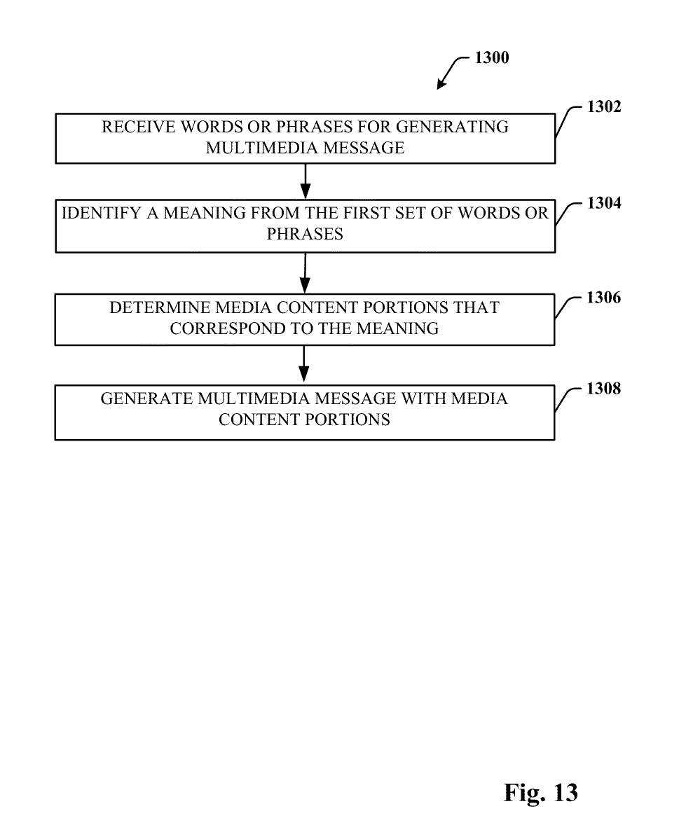

An example methodology 1300 for implementing a method for a system for media content is illustrated in FIG. 13. The method 1300, for example, provides for a system to evaluate various media content inputs and generate a sequence of media content portions that correspond to words, phrases or images of the inputs.

At 1302, the method initiates with receiving a first set of words or phrases for generating a multimedia message. At 1304, the method includes interpreting a meaning of the first set of words or phrases. At 13013, media content portions are determined that correspond to the meaning. At 1308 a multimedia message is generated with the media content portions. Various criteria can also be used to determine media content portions from media content that correspond to the emoticon and/or acronym received. For example, a matching action, expression, event, etc. can be used to determine portions of media content that correspond with the intended message based on the meaning ascertained.

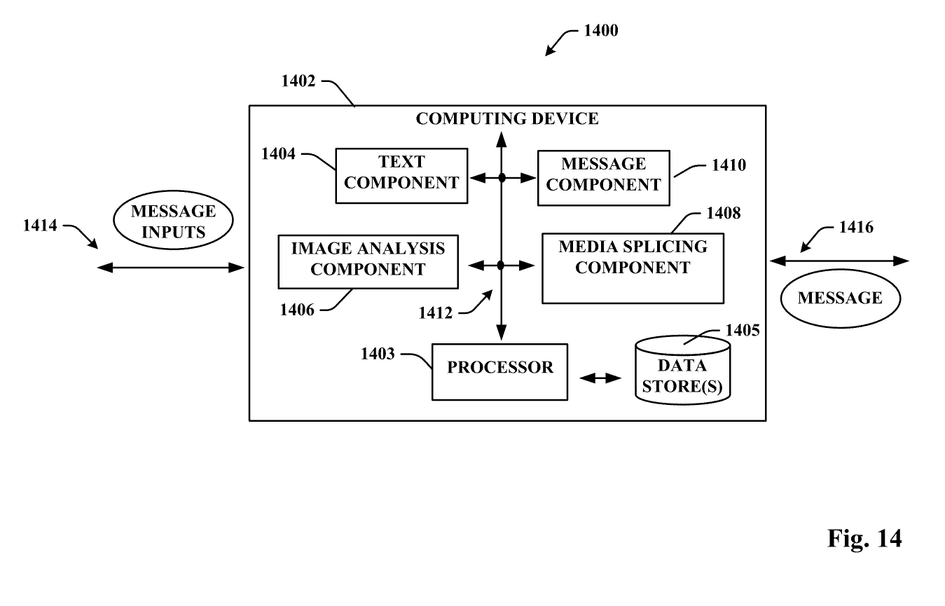

Referring to FIG. 14, illustrated is an example system for generating multimedia messages in accordance with various embodiments disclosed. The system 1400 operates to receive a set of message inputs including an emoticon and/or an acronym and process the emoticon and/or acronym into a multimedia message as a personalized message comprising media content portions (e.g., video/image/audio content segments) to then communicate to a recipient device. The system 1400 includes a computing device 1402, which can include a mobile device, a smart phone, a laptop, personal digital assistant, personal computer, mobile phone and a hand held device, digital assistant and like devices, for example. The computing device includes at least on processor 1403 for processing computer executable instructions, which is communicatively coupled to one or more data stores 1405 that store the computer executable instructions for executing one or more components. The computing device 1402 includes a text component 1404, an image analysis component 1404, a media splicing component 1408 and a message component 1410 that operate to generate multimedia messages comprising one format and content from message inputs that can have a different format and content.

For example, the text component 1404 is configured to receive a set of message inputs 1414 that can include a text message having an emoticon or an acronym for generation of a multimedia message. The text component 1404 is operable to communicate the emoticon or acronym to the image analysis component 1406 via a communication bus, line or connection 1412, which can include any communication pathway. For example, message inputs 1414 can include various text based messages having numerical, alphabetic, alphanumeric, and the like typed characters or symbols to convey a message within. The text component 1404 operates to identify emoticons or acronyms within the text based message of the message inputs for further processing. The message inputs can also include other types of content and is not limited to only text based content as detailed infra.

In one embodiment, the text component 1404 is configured to identify an emoticon and an acronym within a set of message inputs 1414. An emoticon includes a pictorial representation of a facial expression using punctuation marks and letters, which can be written or typed to express a person's mood or to convey an image. Emoticons are often used to alert a responder to the tenor or temper of a statement, and can change and improve interpretation of plain text; emoticons for a smiley face :-) and sad face :-( appear in the first documented use in digital form. The word is a portmanteau word of the English words emotion and icon. In web forums, instant messengers and online games, text emoticons are often automatically replaced with small corresponding images, which came to be called emoticons as well.

In addition or alternatively, the text component 1404 operates to receive and identify an acronym of the message inputs 1414. For example, an acronym includes a text message shorthand and/or a chat acronym that is used to convey a message. For example, a text message can include the acronym “LOL,” which can be received as a text message shorthand for “Laughing Out Loud” and is intended to convey that something is funny or funny enough to cause someone the sender to laugh out loud. Many other examples exist, some of which are detailed further below. In another example, acronyms intend to provide an abbreviation for names or words that in the traditional sense are formed to shorten words that are long according to the first letter of one or more words. For example, a shorthand designation of the acronym United States of America is USA.

The text component 1404 operates to receive any kind of acronym, whether a chat acronym and/or an acronym intended for abbreviating a person, place or thing and an emoticon that is replaced with a corresponding image or one that is purely text based. The text component 1404 is coupled to the image analysis component 1406 that is configured to perform an analysis on the message input 1414 and to identify emoticons and acronyms within a text based message. In one embodiment, a table or index of different emoticons and acronyms with their corresponding meaning or image can be stored in the data store 1414 for reference. The image analysis component 1406 operates to look up the index or table and based on the features of the text message identify acronyms and/or emoticons in a message inputted to the system. In one embodiment, the index/tables can be updated manually by a user to designate acronyms and/or emoticons to a specific meaning, image, emotion and the like. In addition or alternatively, the image analysis component 1406 is operable to dynamically discern an emoticon or acronym's meaning with a network connection and/or via expert system or fuzzy logic processes.

For example, the image analysis component 1406 can communicate a search query over a network connection that generates various meanings, definitions, and/or interpretations of an acronym and/or an emoticon received by the text component 1404. Each of the results can be stored in the data store 1405 in an index or table entry that associates the emoticon or acronym with a result. In addition or alternatively, a user can enter the meaning (e.g., an image, emotion, words or phrases, etc.) manually so that as future acronyms or emoticons are received in a message for or by the particular user, the image analysis component 1406 associates the meaning to the emoticon or acronym. In another embodiment, a set of classifications can be associated with the emoticon or acronym in order for the image analysis component to discern what images, emotions, words or phrases could be associated with the particular emoticons or acronym.

In yet another embodiment, the system 1400 includes the media splicing component 1408, or otherwise a media clipping component in communication with the other components via the communication bus 1412. The media splicing component 1408 is configured to extract a set of media content portions from media content that correspond to the emoticon and/or the acronym received in the message input 1414. In one embodiment, the media splicing component is further configured to extract the set of media content portions from the media content according to a set of predetermined criteria and/or from the set of classifications discussed above. The set of predetermined criteria, for example, can include at least one of a matching of audio content of the media content with words that are represented by the acronym or the matching of an action, an expression, or audio content with an image or an emotion represented by the emoticon. A set of classification criteria can include, for example, least one of a set of themes selected to correspond with the set of media content, a set of song artists selected to correspond with the set of media content, a set of actors selected to correspond with the set of media content, a set of album titles selected to correspond with the set of media content, a set of media ratings of the set of media content, a voice tone selected to correspond with the set of media content, a time period selected to correspond with the set of media content or a personal media content preference selected to correspond with the set of media content from a personal video or audio stored in the data store 1405, in addition to other classifying characteristics set of by a user or defined further by user preferences.

The media content that is spliced by the media splicing component 1408 includes at least one of video content having audio content, video content, audio content, or an image, from cinematic movie content that includes a film featured in a public theatre, in which the image can be a drawn, or digitally created image or photo. The media splicing component 1408 receives the identified emoticons and/or acronyms from the image analysis component 1406, and according to the predetermined criteria and/or the set of classifications, as well as user preferences operates to portions, splice or extract portions of media from the set of media content.

For example, the media splicing component 1408 can received identification of a smiley face in the set of message inputs 1414 from the image analysis component 1406. The message input 1414, for example, could be a colon with a closed parenthesis (e.g., :)), as an acronym could be LOL as an example. In response to identification of the emoticon and/or acronym, the media splicing component 1408 operates to generate portions of media from media content stored in the data store 1405 or another data store for video/image/audio content, and/or a network connection having a data store such as a cloud network. The portions of media content or media content portions include segments of video clips and/or images that express the emoticon and/or acronym. For example, a smiley face identified in a text message as the message input could initiate the media splicing component 1408 to generate any number of portions of a movie, film or other video, audio content, photos or the like as candidate to place within the multimedia message for the portion of the multimedia message that corresponds to or is expressed by the emoticon received. The same is true for acronyms, such as LOL. As such, inputs are received/entered into the system 1400 as text based inputs (e.g., from a text message) and a multimedia message is generate with video portions, image portions, audio portions, etc. from different types of movies, films, videos, audio, photos, etc. that are linked to and analyzed by the image analyzing component 1406 and extracted according to the media splicing component 1408.

The media splicing component 1408 can operate to splice media content according to the set of predetermined criteria and/or the set of classifications as discussed above. For example, a user or client of the system 1400 can set the classifications according to a set of selections for a rating, a date, an event, a genre or theme, an actor, a person, etc. for the media content or media content portions from the media content to be analyzed and spliced. In response to a Halloween setting for the theme or date selection and the smiley face emoticon (:)) and/or LOL acronym, for example, the media splicing component 1408 returns media content portions having a smiley face made by a vampire, werewolf, jack-o-lantern, ghost, or any other hallowed like theme with images, videos segments, or sounds having the Halloween theme and that also correspond to the emoticon a smiley face. For example, a smiley face or LOL received as message input and a Halloween theme entered for the classification criteria, the media splicing component 1408 could return a vampire smiling or laughing out loud from scenes of the movie “Salem's Lot” based on the novel written by Stephen King. This is only one example of many different classifications that can be set and which are detailed throughout this disclosure for the generation of a multimedia message in response to message input (e.g., text based messages), for example. Other themes could be a Christmas theme, an Easter bunny theme, and the like.

In another embodiment, a plurality of classification criteria can also be set in conjunction with one another. For example, while a Christmas theme is selected or entered, a person or character can also be set to be Rudolph, so that an entered text message having LOL or a smiley face generates a portion of a video having Rudolph laughing. Other classifications can also be set as well as other emoticons and acronyms for analysis and the generation of one or more multimedia messages comprising media content portions associated with a text.

The message component 1410 is configured to generate the multimedia message with the set of media content portions that correspond to the emoticon or the acronym of the set of text messages. The message component 1410 can assemble the media content portions according to the emoticon or icon based on the sequence in which the emoticon or acronym is received in the text message and/or based on a different order defined in the set of classifications or a set of user preferences.

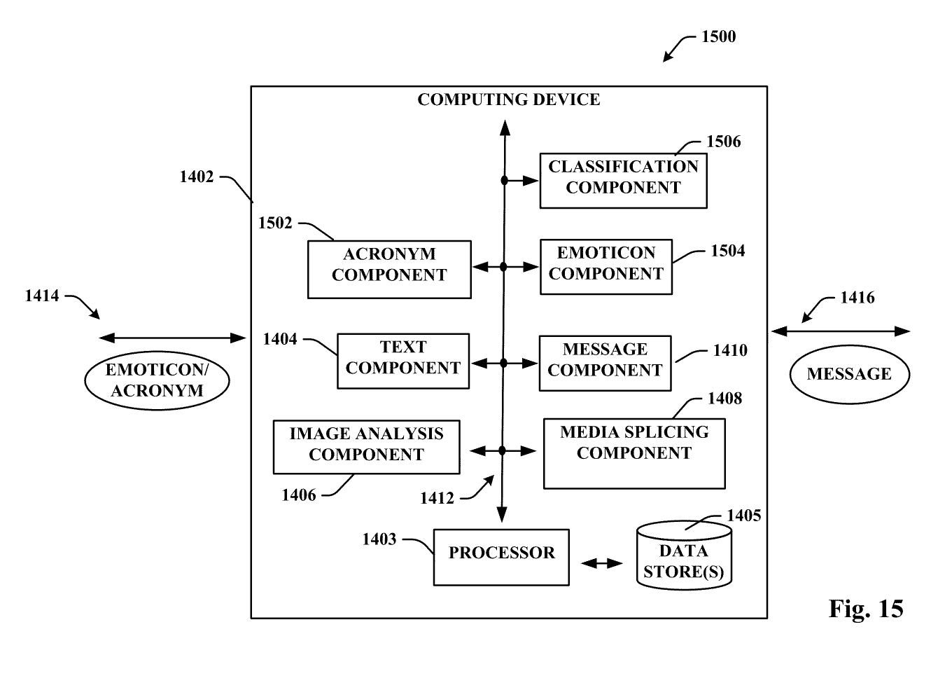

Referring now to FIG. 15, illustrated is an example system 1500 for generating multimedia messages in accordance with various embodiments disclosed. The system 1500, with similar components as discussed herein, includes an acronym component 1502, and emoticon component 1504 and a classification component 1506.

The acronym component 1502 is configured to identify words represented by the acronym of a text message that is received by the system 1500. The acronym component 1502 can identify and then correlated any number of acronyms with any number of words or phrases according to an interpretive assessment of the acronym. For example, an acronym can be determined to convey a message as well as an abbreviation of a person, place, thing, action, emotion, etc. As such, the acronym component 1502 associates (correlates) words or phrases that may not be literally translated in the acronym, but can interpret meaning, emotions, a message and the like with the acronym by associating one or more words (or phrases) with an acronym. This can be a dynamic association in which no predefined associations in an index or table are provided, and also in cases where predefined associations are stored or communicated to the acronym component 1502 multiple meanings or interpretations can be provided so that various different words or phrases are associated with the acronym received.

For example, a chat acronym could be received by the system such as “182,” in which multiple meanings could be determined from this number. The number can be just a number, in which according to a matching audio content, the image analysis component 1406 and the media splicing component 1408 of the system identify video content having audio (media content portions) with the words “one hundred eighty two.” In addition or alternatively, media content portions having the words “I hate you,” could also be generated. Therefore, a segment of the movie, “Sleepless in Seattle” could be generated with an actor or actress saying, “I hate you,” in order to comprise at least a portion of the multimedia message. Additionally, if the set of classifications has Meg Ryan selected or entered to be the actress in the media content portions, the portion of the video in which Meg Ryan's role informs Tom Hanks “I hate you,” can be generated as an option for expressing the acronym “182.” As such, the acronym component 1502 can associate various words to “182” of the text based message to words such as “one hundred and eighty two” as well as “I hate you” for corresponding different media content portions associated with the words or phrase.

The emoticon component 1504 is configured to identify an image and/or a sound represented by the emoticon expressed in a text message or other message input and correspond the image to a textual word or phrase for further processing or analysis. The emoticon component 1504 correlates (associates) an interpretive meaning to the image received in a text message for media content portions to be generated in a multimedia message. In one embodiment, words or phrases are associated with the image identified and then the media content is searched and spliced for video segments, audio segments, and/or image content portions that represent the words or phrases. Various interpretations can be ascertained from an emoticon, such as a sad feeling, disapproval, pouting, etc. from a single image. The emoticon component 1504 is operable to identify an interpretive meaning with words or phrases in order for the media splicing component to parse segments of media content.

For example, a sad face can be associated with the word sad. In response, to the correlation of the word “sad,” settings set for the classification criteria and any predetermined criteria being satisfied and/or user preferences for the associated words or phrases, the media splicing component 1408 can splice segments of media content expressing sadness, vocalizing the word sad, and/or acting in sad manner, for example.

In another embodiment, the acronym component 1502 and the emoticon component 1504 can enable manual modification or editing of the words or phrases correlated with a particular acronym or emotion, which can be set according to a set of user preferences for the acronym and emoticon components 1502, 1504. For example, a word associated with an image of a bunny rabbit illustrated via a text based image of a text message could be “soft,” “fluffy,” “bunny,” “rabbit” and/or another descriptor. A user could decide to modify the correlation of the image to something he or she and a friend would only understand the meaning to be, (e.g., the word “cute”) or something others would not necessarily realize immediately. In addition or alternative, a user could narrow the focus of the meaning to just fluffy, or broaden the focus to include fluffy with a color (e.g., grey), with a different animal, etc. Regardless of the word or phrase, the correlation is able to be modified via a user setting or preference via the emoticon component 1504. A modification alters the associations of the acronym component and the emoticon component to generate different associations among an acronym and/or an emoticon with an image of media content.

The classification component 1506 is configured to receive a set of classification options for the set of classifications in order to set criteria by which components of the system 1500 generate multimedia messages. The set of classifications include at least one of a set of themes selected to correspond with the set of media content, a set of song artists selected to correspond with the set of media content, a set of actors selected to correspond with the set of media content, a set of titles (albums titles, movie titles, book titles, song titles, etc.) selected to correspond with the set of media content, a set of media ratings of the set of media content, a voice tone selected to correspond with the set of media content, a time period selected to correspond with the set of media content and/or a personal media content preference selected to correspond with the set of media content from a personal video or audio stored in a data store.

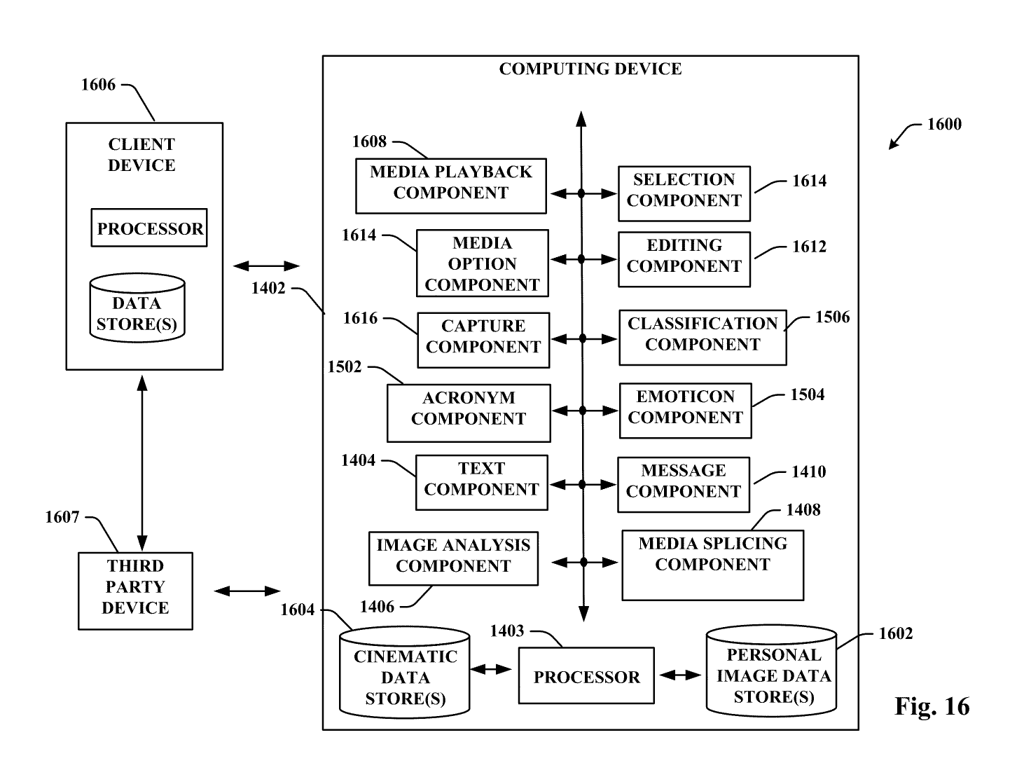

Referring now to FIG. 16, illustrated is a system 1600 in accordance with various embodiments disclosed. The computer device 1402 further includes similar components as discussed above and further includes a media playback component 1608, a selection component 1610, an editing component 1612, a media option component 1614, and a capture component 1616.

The system 1600 includes a personal image data store 1602 that can include a repository of acronyms and/or emoticons for storing personal home videos and images created on the computing device 1402 and/or a different client device 1606, and/or third party device 1607 (e.g., a server, or other device), for example. The system 1600 further includes a cinematic data store 1604 for storing cinematic videos or images that have been viewed or presented in a public theatre, for example, that may have been licensed or purchased. Either data store 1602 or 1604 can also include media content (video/audio/images) from a third party device 1607 for generating a repository of videos, which can be provided on a cloud network, at the computing device 1402, the third party device/server 1607, another client device 1606 and/or the like, in which the body of media content that has been processed by the various components described herein can be presented on a social network and/or other professional or family network.

The media playback component 1608 is configured to generate a preview of the multimedia message that includes generating a word or phrase and/or the at least one video or image sequentially according to a message inputs having an emoticon and/or acronym received. In addition, the media playback component 1612 can generate a preview of a selected media content portion or segment of media content that is stored in the data store 1602 and/or 1604, which enables viewing and/or editing of the multimedia message.

The selection component 1610 is configured to receive a selection that identifies a media content portion with an emoticon and/or acronym. For example, the media content portions that are correlated with an emoticon and/or acronym can be modified by a user to have a different emoticon and/or acronym associated with a media content portion. For example, a video segment or portion having a smiley or happy face associated with it, can be edited to have a different word associated with it, such as “happy” and “smile”, and then further edited to replace as well as add additional words associated with the particular media content portions, such as “laugh” or any acronym associated with the word. In one embodiment, the labeled emoticon or acronym associated with the media content portion can be presented with the media content portion generated within the multimedia message. In this way, the multimedia message includes textual labels (an emoticon and/or acronym) connected to a media content portion, which is included in the multimedia message conveying a new or different text message for the user to send.

The editing component 1612 is configured to edit emoticons and/or acronyms associated with the set of media content portions according to a set of user preferences, which can include a user preference for a number of words to connect with the portions (one or more images), a set of descriptors for each portions (e.g., colors, events, words spoken, sounds, music, date, etc.), a set of verbs, a set of nouns, a set of names, a set of places, a set of metadata, and the like) so that the words or phrases connected with each portion from the set of home videos or personal photos are indicative of the user's preferences for labeling with an emoticon and/or acronym. For example, a portion of video may be labeled according to the word or phrase “red ball,” “moving,” “rolling,” “on green grass,” and also the word “catch,” which could have been spoken or identified to be within the video, and also with emoticons and/or acronyms. A user preference can be set to label the portions within the video according to a person's name, an object identified (ball), a color illustrated, and from any other characteristic illustrated or spoken in the media content, along with a particular emotion, image, word or phrase associated with emoticons and/or acronyms. A set of user preferences for one set of video/audio/image content can be designated for nouns, colors, places, etc. while a different set of user preferences for correlating words or phrases can be designated to a different set of video/audio/image content. This enables a user to input various different types of videos or images and guide the analysis and correlation of various types of media content for configuring multimedia messages. As such, when the user generates a multimedia message by typing a phrase or text based message (message inputs) with emoticons and/or acronyms, the system can correspond certain words or phrases in the message inputs with particular words or phrases connected to different sets of media content stored based on the user preferences for each. Nouns, for example, can be connected to a video of a dog filmed, and verbs could be connected to a different film of a home video of a birthday party, for example. Upon assembling or generating the multimedia message, each set of videos could be analyzed for determined media content portions as options for the user to select. The user therefore, enters a text based message of a text based format and the system outputs a video/image/audio/multimedia message of a different format for viewing and conveying a dynamic text message.

The media option component 1614 is configured to generate the set of media content portions generated from emoticons and/or acronyms in a personal data store of home videos/images/audio and/or a set of cinematic media content portions generated from a set of cinematic movie content as options for a correlation with the emoticons and/or acronyms based on a selected option, whereby the set of cinematic movie content is stored in a data store and comprises content of a film that was featured in a public theatre. The media option component 1506 provides options for a user to select from, in which portions of media content from different sets of videos (e.g., home video and cinematic video) can be provided in the multimedia message. A user, for example, could prefer a scene from a movie (e.g., Rocky) to represent a an emoticon and/or acronym, rather than a segment of a home video. Both portions can be presented to the user in order for the user to correlate certain emoticons and/or acronyms with. The capture component 1616 are respectively configured to capture videos and/or photos in order to generate the image content, in which media content portions are generated from for a multimedia message. For example, rather than receiving the set of images from an external data store, or the data store 1405, the images and videos can be directly captured for the user to generate a video stream of video/audio/images automatically based on text or message inputs entered or received by the system 1600.

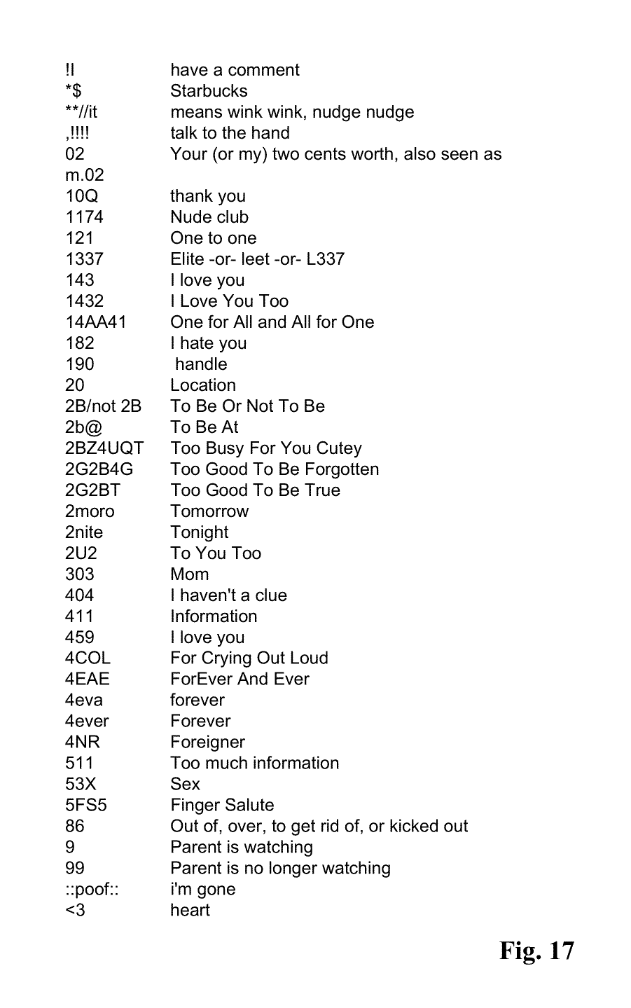

Referring now to FIG. 17, illustrated is a set of acronyms from a text based messages in accordance with embodiments disclosed herein. The acronyms and their meanings are not exhaustive and are an example of acronyms and meanings associated with them for identifying further media content portions of each as they are received. A text based message, a selection input, a modification input, a preselected input, and/or other type of inputs can be received having a text based message “4eva,” which has the same meaning as “forever.” Media content portions are then found that include the word or depict a meaning of “forever” in video/image/audio content of the media content portions. The image analysis component and the media splicing components described herein can implement definitions of acronyms and emoticon through an index table, and/or a network lookup or search, for example in order to then store the acronyms and meanings.

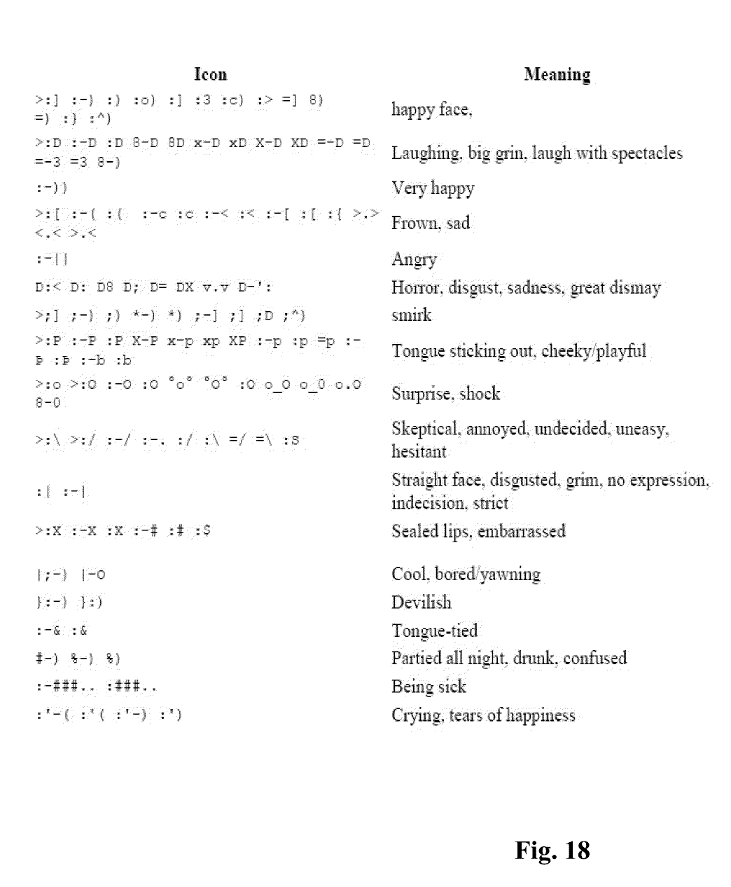

Referring now to FIG. 18, illustrates an example of emoticons listed as an icon and an associated meanings in accordance with aspects described in this disclosure. The example set of text based images, text based icons, or, in other words, set of emoticons is not exhaustive and many other emoticons and associated meanings are envisioned.

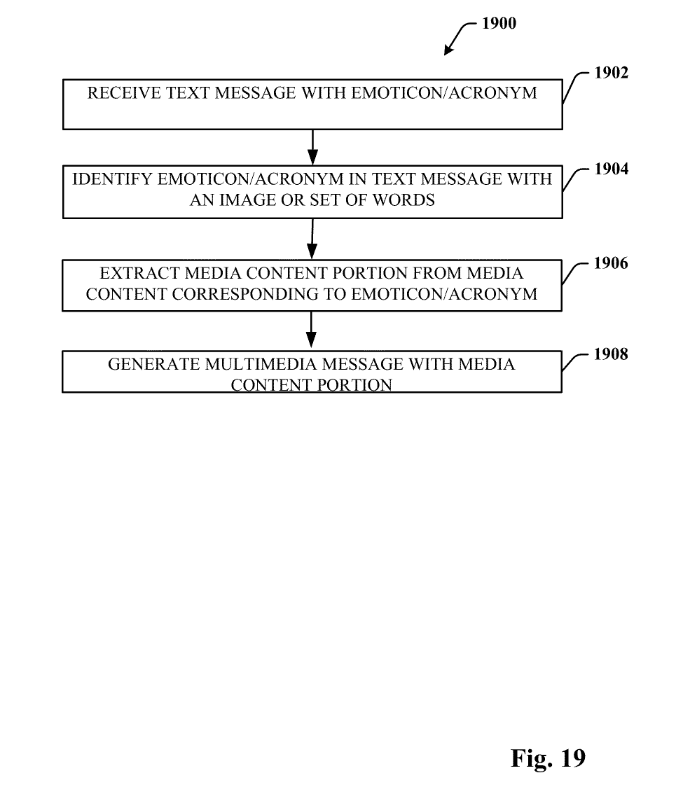

Referring to FIG. 19, illustrates a method 1900 for a messaging system in accordance with various embodiments disclosed herein. The method 1900 initiates and at 1902, the method includes receiving, by a system including at least one processor, an emoticon and/or an acronym via a text based message, a selection input for a predefined emoticon/acronym selection, and or other communicated input. At 1904, an emoticon and/or an acronym can be identified with an image or a set of words. For example, the emoticon and/or acronym in a text message can be associated with a particular image and/or words in order to connect a meaning for the portion of the text message having the emoticon/acronym. At 1906, one or more media content portions are extracted from media content corresponding to the emoticon and/or acronym. The media content portions can be video/image/audio content that are identified and/or extract according to a set of predetermined criteria. For example, a match of the image and/or audio content with the identified word/phrase/image of the emoticon and/or acronym can determine what portions are extracted from the media content stored in a data store. In one embodiment, the multimedia message can include at least one video or image from the set of media content portions generated from the set of image content and also corresponds to at least one word or phrase of the set of message inputs as part of the multimedia message, which is in addition to the emoticon and/or acronym of the message. For example, the multimedia message can partially comprise text, such as in a text message and then also include portions of video that convey the remainder of the message. The video portions can be from different videos (different movies, films, personal videos, personal photos, audio, etc.). The multimedia message can include at least one video or image from the set of media content portions generated from the set of image content (personal content), at least one textual word or phrase received in the set of message inputs and audio content that corresponds with at least one portion of the set of message inputs

At 1908, a multimedia message is generated with the media content portion(s) that correspond to the image and/or words identified with the emoticon/acronym. For example, a meaning of the emoticon/acronym can be identified and used based on words or images to identify the media content portions that are included in the message. Various user inputs and selection for classifications and other predetermined criteria, such as matching of an expression, an action, an event, along with other criteria discussed herein can focus the extracting of the media content portions and generation of the multimedia message.

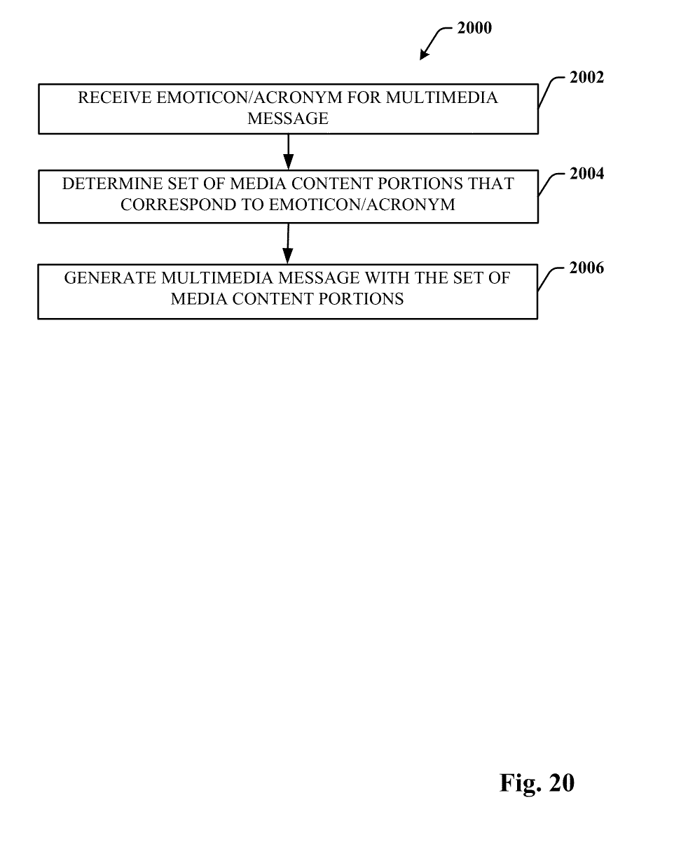

An example methodology 2000 for implementing a method for a system for media content is illustrated in FIG. 20. The method 2000, for example, provides for a system to evaluate various media content inputs and generate a sequence of media content portions that correspond to words, phrases or images of the inputs.

At 2002, the method initiates with receiving one or more emoticons and/or acronyms for generating a multimedia message. The emoticons and/or acronyms can be received from text message, a predefined selection, as a query term or the like, for example.

At 2004, the method includes determining a set of media content portions including content that corresponds to the emoticon and/or acronym. In one embodiment, the association or corresponding can be done with a word, a phrase or an image to interpret the meaning of the emoticon and/or acronym. The word, phrase or image can then be associated audio content, which can be associated with segments of video or not, in order to determined portions of video corresponding to the emoticon and/or acronym. Other criteria can also be used to determine media content portions from media content that correspond to the emoticon and/or acronym received. For example, a matching action, expression, event, etc. can be used to determine portions of media content that correspond with the intended message of an emoticon and/or acronym. The emoticon and/or acronym can then be conveyed via a multimedia message that is generated at 2006, such as via a mobile device, a mobile phone, and/or any other computer device.

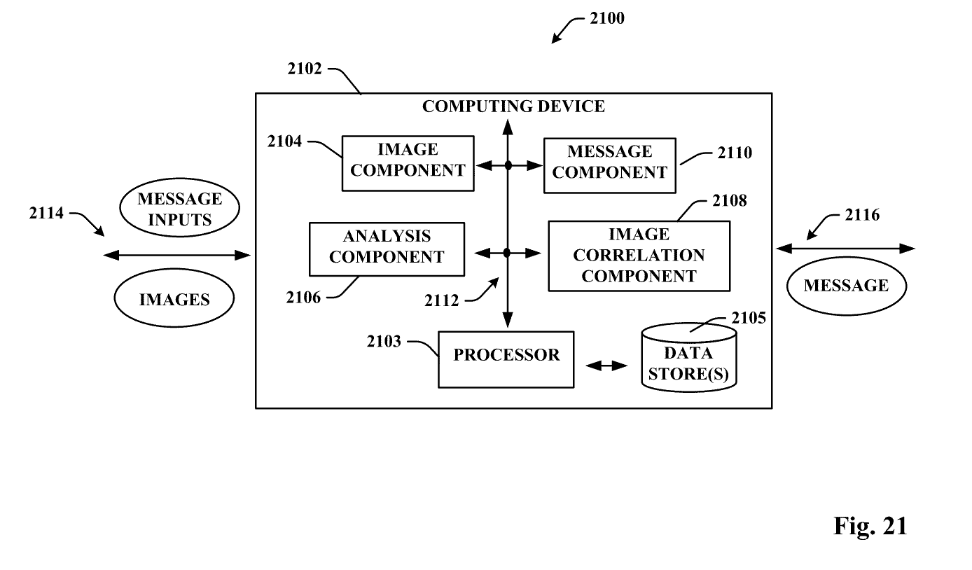

Referring to FIG. 21, illustrated is an example system for generating multimedia messages in accordance with various embodiments disclosed. The system 2100 operates to receive a set of images such as videos, pictures, created drawings, as well as audio accompanying the set of images for storage in one or more data stores. The set of images are analyzed to identify portions or segments of the images according to a set of predetermined criteria. The portions are then tagged, labeled, or, in other words, correlated to a word or phrase in order to be further identified. Based on a message or a set of message inputs received by the system 2100, a different message is generated with the identified portions to convey the same intended message.

The system 2100 comprises a computing device 2102 that receives inputs and generates a message that can be communicated. A user is able to utilize the system 2100 to input home videos captured or other images with or without audio content and further generate a multimedia message 2116 from the inputted home videos or other images. The computing device 2102 can be any computing device, such as a mobile device, laptop, personal digital assistant, personal computer, mobile phone and the like. The computing device 2102 operates to receive a set of inputs comprising a set of images 2114. The set of images 2114 can include videos, pictures, created/drawn images, and the like, which can also include audio content associated with or separate to the set of images 2114. Additionally or alternatively, the computing device 2102 can receive the set of inputs 2114 as message inputs for the computing device to generate a message 2116 that comprises portions of the set of images 2114.

The computing device 2102 comprises at least one processor 2103 that is communicatively coupled to one or more data store(s) 2105 having computer executable instructions for executing one or more components. The computing device 2102 further comprises an image component 2104, an analysis component 2106, an image correlation component 2108, and a message component 2110. The components of the computing device 2102, the processor 2103 and the data store(s) 2105 are communicatively coupled to on another via a communication link 2112. The communication link 2112 can include any communication link including a wired connection, wireless connection, optical connection, and other similar connections for communication, in which the system is not limited to any single type of communication architecture or mechanism.

The image component 2104 is configured to receive a set of images stored in a personal video or personal image data store for generating a multimedia message. The personal data store can be the data store 2105, an external data store of a client device or other computing device, and/or an additional data store of the system 2100 that stores personal data such as image content including videos, photos, and/or any digital media content that is designated by or inputted from a user. In other embodiments, as discussed infra, media content can also be stored from third party server or system, which is inputted to the system 2100 via a different communication channel or connection than just between the system and a client device user, for example.

An image analysis component 2106 is configured to determine a set of media content portions from the set of images. The image analysis component 2106, for example, analyzes video content, image content, and/or audio content to determine portions or segments that can be used in a message according to a set of predetermined criteria and/or a set of classification criteria. For example, the image analysis component 2106 can identify portions of the set of images stored in the data store 2105 and/or received via the set of inputs 2114 (e.g., personal home videos, photos, drawings, etc.). The set of predetermined criteria can include identification of one or more images with a particular facial expression, an action, an event occurring, audio content (spoken or not) characteristics about any occurrences in the video, a time frame of events, and/or a manual selection or splicing of the image content to include one or more scenes or images, for example. The set of classification criteria can include a theme or genre identified, a voice tone, a section of audio associated with the images (e.g., a time period), a time period corresponding to a historical time period or a range of dates, according to actors or actresses identified, a language spoken, a defined user preference matching a device in which the image(s) were captured, as well as any metadata associated with the set of images received by the system via a communication pathway or a data store. The image analysis component 2106 therefore operates to analyze the set of media content such as image content with video and/or audio content to determine portions of media content (one or more scenes or digital images) to be used for generating multimedia messages s they a correspond with a set of message inputs.

The image correlation component 2108 is configured to correlate a set of metadata such as words or phrases with the set of media content portions that have been determined from the set of images 2114. The image correlation component 2108, for example, tags the identified media content portions with data such as a word or phrase. The set of predetermined criteria described above can be used by the image correlation component 2108 to connect the portions identified in the set of image content 2114 with words or phrases. Each word or phrase, for example, can be any tag, label or metadata that identifies the media content portion to the system, the client device or for a user selection. For example, the word “RUN” can be connected to portion of a home video of a relative running for a specified or particular duration. This portion of video could have been identified by the image analysis component 2106 based on the person, the time, the action occurring, the duration of the action, etc. Therefore, when a user inputs a set of message inputs having the word “RUN” to be included in a multimedia message 2116, such as by the inputs 2114, the system 2100 operates to recognize the portion of image content identified with the relative running (e.g., a sibling chasing a dog) and corresponding to the word “RUN.” Media content portions of image content can also be recognized according to words spoken, for example, where if the relate spoke the word run, rather than actually running, in response to the user sending a message input with the word “RUN” as part of the message to be generated then the portion of video of the relative speaking the word run is generated.

The image correlation component 2108 operates to correlate a set of words or phrases (as tags or labels with metadata) based on the set of predetermined criteria including a matching action, a matching facial expression, a matching event(s) within one or more images, a matching voice tone or anything depicted or occurring within the set of images. The set of predetermined criteria, for example, can be distinguished somewhat from the set of classification criteria. The classification criteria, for example, provides criteria about the images (classification criteria—person, people, things in the image, time of events, place, date, time frames, etc.) that match segments or portions of the image content. The set of predetermined criteria can include the events, a type of action, expression, expression or circumstances occurring in one or more of the images (recognizable events—expression, emotion, action, speech, sounds occurring, etc.) matching a label or metadata that can include a word or phrase identifying the media content portion. Accordingly, the image analysis component 2106 can determine portions of media content provided in a set of inputs, such as from a user's personal data store, according to the set of classifications and/or the set of predetermined criteria, and the image correlation component 2108 correlates (associates) the portions with a word, phrase or other such identifier that enables creation of the multimedia message from additional or different inputs 2114 (message inputs) according to the set of predetermined criteria, for example.

In one embodiment, the image correlation component 2108 is further configured to correlate the set of words or phrases with the set of media content portions based on portions of audio content of the set of images connected with the set of media content portions. The portions of media content from the set of images received can then be identified with a word, phrase or other identifier according to the words or phrases spoken, or sounds identified within the images. As such, a richer and more personalized multimedia message is able to be generated from personal content.

The message component 2110 is configured to generate the multimedia message 2116 with the set of media content portions according to a set of message inputs (a text message received, selections inputted of predefined options, a query, and the like). For example, the multimedia message 2116 includes one or more media content portions (e.g., video portions, image portions, audio portions and the like) that are combined to form a continuous video stream. The message inputs received via the communication channel 2114 can include a text based message having words or phrases that are matched with the words or phrases correlated to or identified with the media content portions by the image correlation component 2108.

In one example, a user can provide to the system 2100 a set of inputs comprising a video or images. The system 2100 components operate to analyze, splice, identify and correlate portions of the video and images capture or provide by the user. In one embodiment, the system includes the device capturing the video or image, and/or enables an image to be drawn or created thereon, such as by a stylus, touch pad, digital ink, etc. The system receives the content from the user as a set of images, for example, and processes the image content received (e.g., via the image component 2104, the analysis component 2106, the image correlation component 2108, and the message component 2110) into media content portions. The system 2100 can then receive a set of messages or message inputs for generating a multimedia message according to the portions. For example, a message input can be a text based message stating, “I love puppies! Can we buy one?” In response to the message, the system 2100 generates a multimedia message with the media content portions so that when viewed the multimedia message includes one or more of the portions from the set of image content received that communicate in a sequence the intended message “I love puppies! Can we buy one?” The multimedia message can include multiple different media content portions corresponding to portions (words or phrases) of the message inputs, for example. As such, when the multimedia message is communicated a sequence (e.g., video stream) of images, including portions of video and/or audio, can be viewed as the communicated multimedia message. In one embodiment, the text message or message inputs can be voiced, overlaid, and/or otherwise generated with the video/audio images that are combined as the multimedia message. Alternatively, the final multimedia message does not have the initial message inputs incorporated in the multimedia message, which can be defined according to a user preference.

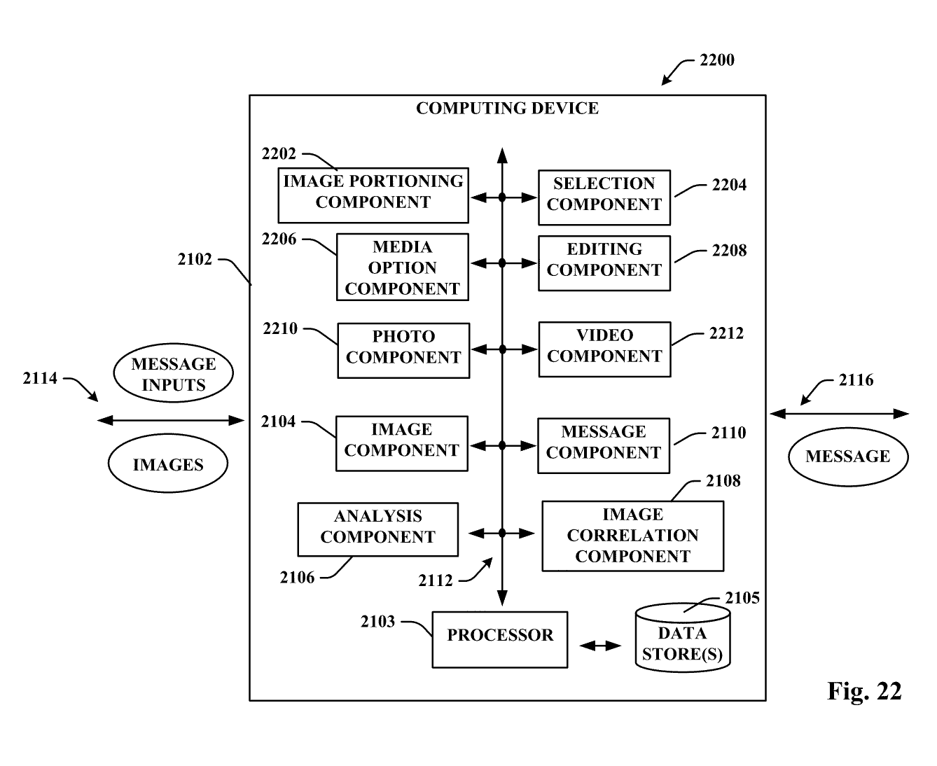

Referring now to FIG. 22, illustrated is the system 2200 for generating a multimedia message from a set of image content according to various embodiments disclosed herein. The system 2200 includes similar components as discussed above in FIG. 22, and further includes an image portioning component 2202, a selection component 2204, a media option component 2206, an editing component 2208, a photo component 2210 and a video component 22122.

The image portioning component 2202 is configured to splice the set of image content and extract the set of media content portions according to the set of predetermined criteria. For example, images within the set of images can be spliced, or extracted based on a matching of audio content, an action, an expression, an emotion with one or more words or phrases. In addition or alternatively, the image portioning component can extract media content portions according to a set of classification criteria as discussed above (e.g., a theme, actor, holiday, event, time period and the like). The image portioning component splices the media content according to portions identified by the analysis component 2106. The portions identified can be marked and then further spliced in order to be placed or concatenated together with other media content portions in a multimedia message. In addition, the extracted portions can be sorted in the data store 2105 in order to be further classified and/or tagged with a word or phrase by a user.

A selection component 2204 is configured to receive a selection that identifies a media content portion with a user inputted tag, word or phrase. For example, the media content portions correlated with a set of words or phrases can be modified by a user to have a different set of words or phrases associated with or correlated to the media content portion. For example, a video segment or portion having the word singing associated with it, can be edited to have a different word associated with it. In one embodiment, the labeled word or phrase associated with the media content portion can be presented with the media content portion generated within the multimedia message. In this way, the multimedia message includes textual labels connected to each portion and one or more portions comprising a video conveying a message for the user to send.

The editing component 2208 is configured to edit the set of words or phrases associated with the set of media content portions according to a set of user preferences, which can include a preference for a number of words to connect with the portions (one or more images), a set of descriptors for each portions (e.g., colors, events, words spoken, sounds, music, date, etc.), a set of verbs, a set of nouns, a set of names, a set of places, a set of metadata, and the like) so that the words or phrases connected with each portion from the set of home videos or personal photos are indicative of the user's preferences for labeling. For example, a set of images may be labeled as a red ball, moving, rolling, on green grass, and also the word “catch” because it happens to also be spoken within the video. A user preference can be set to only label the portions within the video according to a person's name, an object identified (ball), a color illustrated, and from other characteristics rather than having multiple different options for words connected with one set of image content. Additionally, a set of user preferences for one set of video/audio/image content can be designated for nouns, colors, places, etc. while a different set of user preferences for correlating words or phrases can be designated to a different set of video/audio/image content. This enables a user to input various different types of videos or images and guide the analysis and correlation of various types of media content for configuring multimedia messages. As such, when the user generates a multimedia message by typing a phrase or text based message (message inputs), the system can correspond certain words or phrases in the message inputs with particular words or phrases connected to different sets of media content stored based on the user preferences for each. Nouns, for example, can be connected to a video of a dog filmed, and verbs could be connected to a different film of a party.

The media option component 2206 is configured to generate the set of media content portions generated from the set image content and a set of cinematic media content portions generated from a set of cinematic movie content as options for a correlation with the set of words or phrases based on a selected option, wherein the set of cinematic movie content is stored in a data store and comprises content of a film that was featured in a public theatre. The media option component 2206 provides options for a user to select from, in which portions of media content from different sets of videos (e.g., home video and cinematic video) can be provided in the multimedia message. A user, for example, could prefer a scene from a movie (e.g., Rocky) to represent a word, rather than a segment of a home video. Both portions can be presented to the user in order for the user to correlate certain phrases or words with. Alternatively or additionally, portions from different sets of videos or images can correlate with a word or phrase so that user is presented with an option to choose among with the generation of each multimedia message. In one example, the multimedia message generated can include at least one of the set of media content portions from the set of image content (home videos or personal images) and/or at least one of the set of cinematic media content portions. A random selection could further be received to randomly select from among the options to place within the multimedia message as representative of a word or phrase received as the message inputs 2114.

The photo component 2210 and the video component 22122 are respectively configured to capture videos and/or photos in order to generate the image content, in which media content portions are generated from for a multimedia message. For example, rather than receiving the set of images from an external data store, or the data store 2105, the images and videos can be directly captured for the user to generate a video stream of video/audio/images automatically based on text or message inputs entered or received by the system 2200.

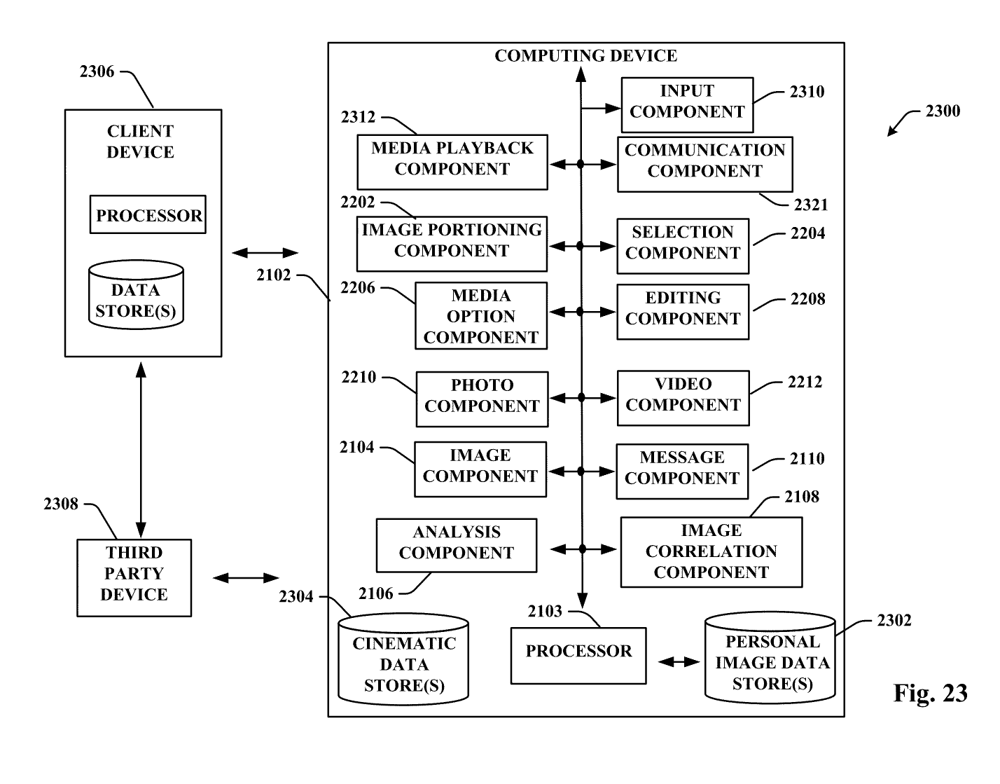

Referring now to FIG. 23, illustrated is a system 2300 in accordance with various embodiments disclosed. The computer system 2102 further includes similar components as discussed above and further includes a message input component 2310, a media playback component 2312 and a communication component 2321.

The system 2300 includes a personal image data store 2302 for storing personal home videos and images created on the computing device 2102 and/or a different client device 2306, and/or third party device (e.g., a server, or other device), for example. The system 2300 further includes a cinematic data store 2304 for storing cinematic videos or images that have been viewed or presented in a public theatre, such as Hollywood films or movies that have been licensed or purchased. Either data store 2302 or 2304 can also include media content (video/audio/images) from a third party device 2308 for generating a repository of videos, which can be provided on a cloud network, at the computing device 2102, the third party device/server 2308, another client device 2306 and/or the like, in which the body of media content that has been processed by the various components described herein can be presented on a social network and/or other professional or family network.

The message input component 2310 is configured to receive a set of message inputs from which the multimedia message is generated. As described above, portions of the set of message inputs correspond to portions of the multimedia message. For example, a set of phrases or words in the message inputted into the system 2300 can be matched with different media content portions by a match of the words or phrases correlating with each media content portion. For example, a text message can be received that states “I am laughing!” The words or phrase contained within the message are used to present the media content portions that are connected with the words or phrases to the user, such as in a display (not shown). In addition or alternatively, the message inputs can be received from a text message of a mobile phone, a typed input query, and/or a selection input to a predefined word or phrase.

The media playback component 2312 is configured to generate a preview of the multimedia message that includes generating the at least one textual word or phrase and the at least one video or image sequentially according to a sequence of the set of message inputs received. In addition, the media playback component 2312 can generate a preview of a selected media content portion or segment of media content that is stored in the data store 2302 and/or 2304. This enables a user to preview multimedia messages before sending them, as well as various media content portions that are generated or presented for the words or phrases of the message inputs. The communication component 2321 includes a transceiver, and/or other communication module for receiving wireless communications and sending communication packets incorporating the media content, and the multimedia message. For example, a mobile phone can communicate the multimedia message as a text message having text and video content.

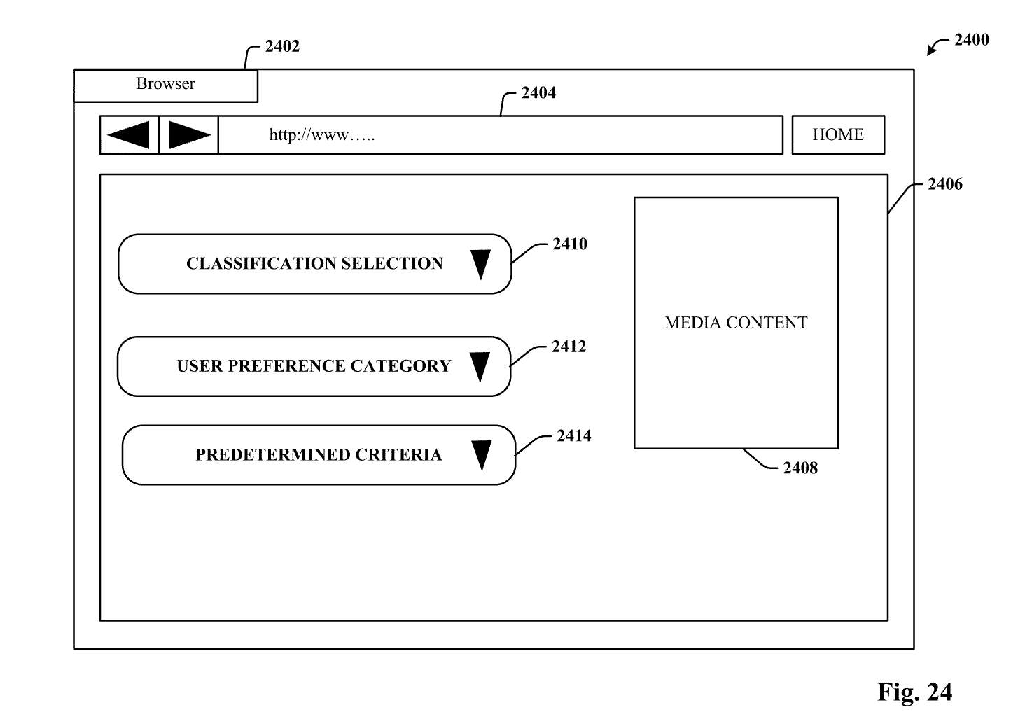

FIGS. 24-26 are described below as representative examples of aspects disclosed herein of one or more embodiments. These figures are illustrated for the purpose of providing examples of aspects discussed in this disclosure in viewing panes for ease of description. Different configurations of viewing panes are envisioned in this disclosure with various aspects disclosed. In addition, the viewing panes are illustrated as examples of embodiments and are not limited to any one particular configuration.

Referring now to FIG. 24, illustrated is an example input viewing pane 2400 in accordance with various aspects described herein. As discussed previously, the message component 2110 and/or the media playback component 2312 can generate the multimedia message to be communicated and/or previewed, which can be displayed in the viewing pane. The viewing pane 2400 can be associated via a web browser 2402 that includes an address bar 2404 (e.g., URL bar, location bar, etc.). The web browser 2402 can expose an evaluation screen 2406 that includes media content 2408 for viewing either directly over a network connection, a cloud network or some other connection.

The screen 2406 further includes various graphical user inputs for evaluating the media content 2408 by manual or direct selection online. The screen 2406 comprises a classification selection control 2410, a user preference category control 2412, and a predetermined criteria control 2414. Although the controls generated in the screen 2406 are depicted as drop down menus, as indicated by the arrows, other graphical user interface controls. For example, buttons, slot wheels, check boxes, icons or any other image enabling a user to input a selection at the screen. Theses controls enable a user to log on to an application on a device or enter a website via the address 2404 and further provide input to personalize the multimedia messages.

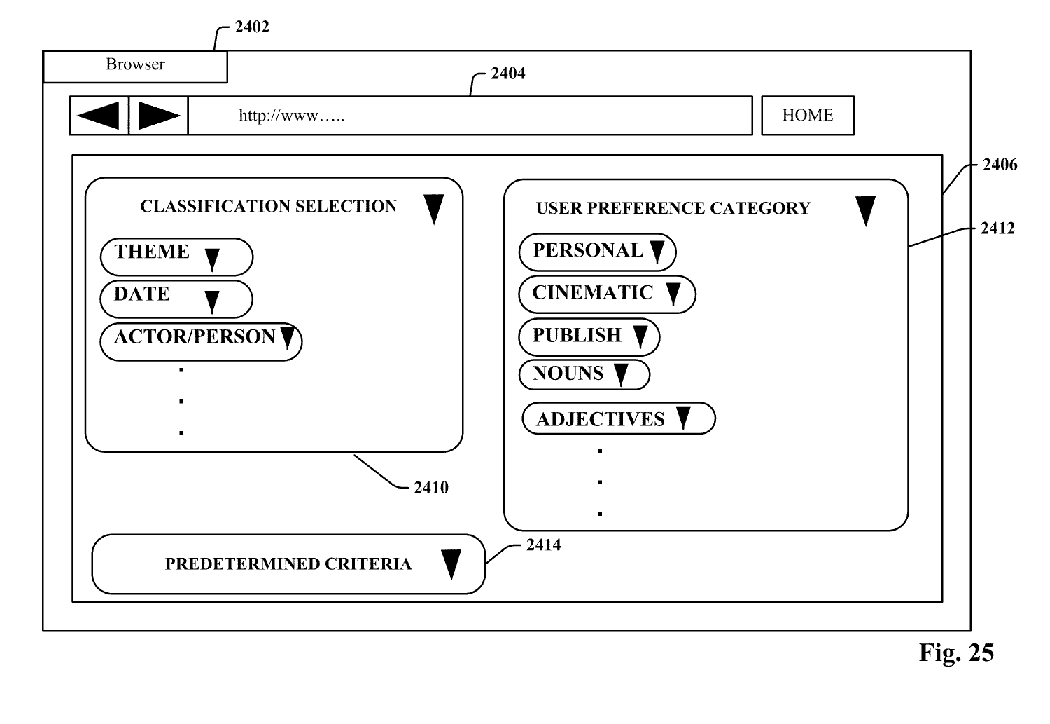

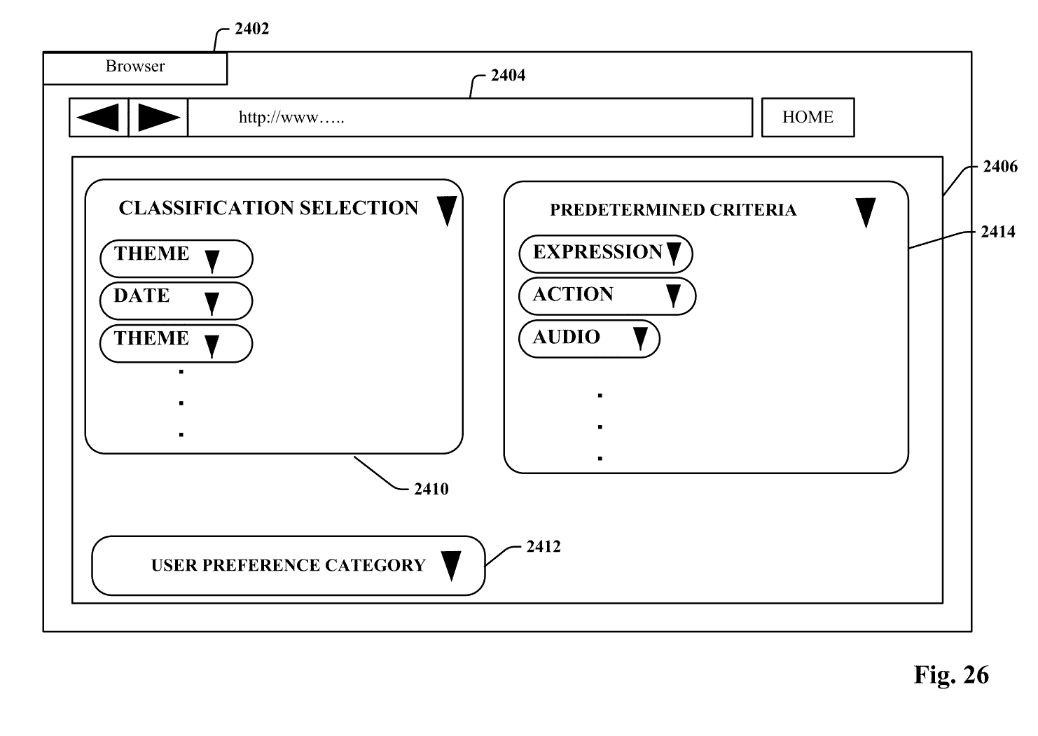

Referring now to FIG. 25 and FIG. 26, illustrated is an example of the different items displayed in the screen 2406 in accordance with various aspects described herein. Further, although these items are displayed for selection, these examples are also provided to illustrate the different classification selection controls 2410, user preference category controls 2412, and predetermined criteria control 2414 that are utilized in conjunction with the above discussed components or elements of the disclosed messaging systems. For example, a user can thus provide inputs expressing desired media content and personalized multimedia messages via a user interface selection, a text, a captured image, a voice command, a video, a free form image, a digital ink image, a handwritten digital image and/or the like.

In one embodiment, the measure selection control 2410 has different options (controls) for classifying media content and/or media content portions extracted from the set of images include video/image/audio content. The classifications can include can include a theme or genre identified, a voice tone, a section of audio associated with the images (e.g., a time period), a time period corresponding to a historical time period or a range of dates, according to actors or actresses identified, a language spoken, a rating, etc. as examples in which media content (video/images/audio) and/or the media content portions can be identified with. Other such classification criteria can also be viewed or generated as well based on a user's taste, metadata associated with the media content and/or characteristics or features of the videos/images/audio content being analyzed.

In another embodiment, the user preference control 2414 has different options (controls) for identifying various types of media content, such as a set of image content from a personal data store captured from a camera, home video recorder, mobile phone and the like, and/or from a cinematic media content that includes film or images with audio content that has been featured in a public theatre (such as Hollywood movies or the like). Various types of user preferences can be included such as a personal selection for obtaining media content portions from a person set of image content received and/or stored, a cinematic selection for movies obtained by a license or publicly release, a publish control to provide multimedia message online and/or to retrieve published image content, preference for media content portions to be labeled, tagged, or otherwise correlated with a word or phrase, such as for nouns, adjectives and/or other grammatical structures. Other preferences can also be implemented by the systems disclosed herein for portions and generated multimedia message from a set of text messages, query terms, selected text, and the like.

FIG. 26 further illustrates a set of predetermined criteria control 2414 that can be selected for generating media content portions and/or selecting sets of media content by which portions are extracted from. The predetermined criteria can include various options including identification of one or more images with a particular facial expression, an action, an event occurring, audio content (spoken or not), sounds and/or other characteristics related to occurrences or events within the video/image/audio content, a time frame of events by which the portions of content are extracted from, and/or a manual selection or splicing of the image content (including one or more scenes or images), for example. In addition, an audio control can be provided for determining portions of audio content associated with videos/images/audio content. For example, sound bites can be used as part of the multimedia message that can be of just song portions, speeches, interviews, audio books, videos and/or images having audio content.

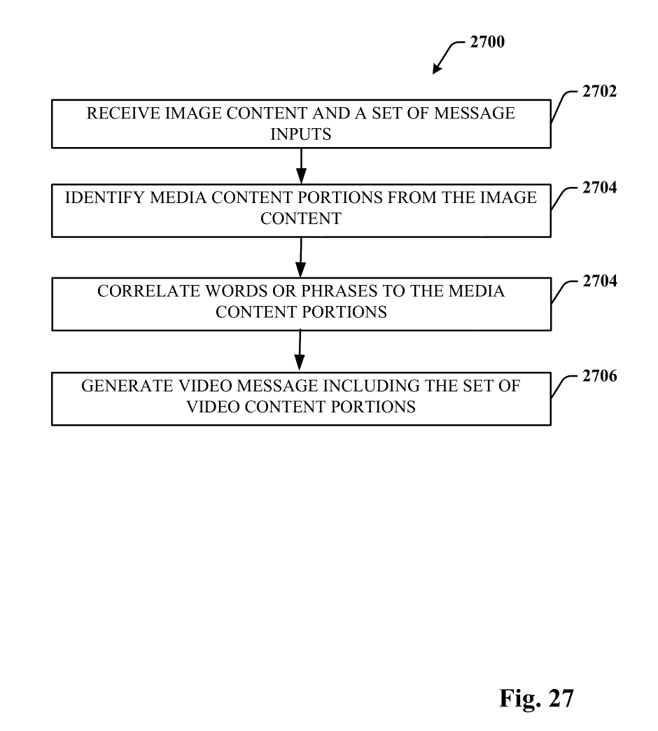

An example methodology 2700 for implementing a method for a system such as a system for generating a multimedia message with media content is illustrated in FIG. 27. The method 2700 initiates and at 2702, the method includes receiving, by a system including at least one processor, a set of image content stored in a personal video or personal image data store and a set of message inputs for generation of a multimedia message. In one embodiment, the multimedia message can include at least one video or image from the set of media content portions generated from the set of image content and also corresponds to at least one word or phrase of the set of message inputs as part of the multimedia message. For example, the multimedia message can partially comprise text, such as in a text message and then also include portions of video that convey the remained of the message. The video portions can be from different videos (different movies, films, personal videos, personal photos, audio, etc.). The multimedia message can include at least one video or image from the set of media content portions generated from the set of image content (personal content), at least one textual word or phrase received in the set of message inputs and audio content that corresponds with at least one portion of the set of message inputs. In another embodiment, the set of image content (personalized content from a personal device or home capturing device) comprise a set of video content having associated audio content, by which the set of image content and the set of message inputs are received via a same communication pathway, such as via a network from the same device, a same data store in communication with the processor, a set of text message, multimedia message such as in a Short Message Service (SMS) and/or a Multimedia Messaging Service (MMS).

At 2704, the method includes identifying a set of media content portions from the set of image content that include at least one digital image of the set of image content stored in the personal video or personal image data store for incorporation into the multimedia message. At 2706, a set of metadata including a first set of words or phrases are correlated with the set of media content portions. At 2706, the multimedia message is generated with the set of media content portions that correspond to the first set of message inputs. In one embodiment, generating the multimedia message with the set of media content portions that correspond to the set of message inputs can include matching the first set of words or phrases with a second set of words or phrases of the set of message inputs.

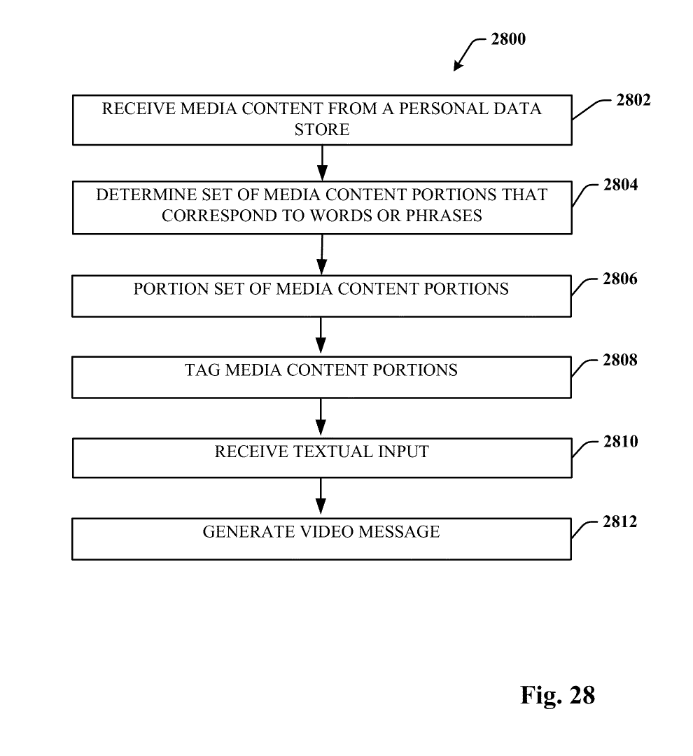

An example methodology 2800 for implementing a method for a system such as a system for generating a multimedia message with media content is illustrated in FIG. 28. The method 2800, for example, provides for a system to evaluate various media content inputs and generate a sequence of media content portions that correspond to words, phrases or images of the inputs.

At 2802, the method initiates with receiving a set of media content for generating a multimedia message from a personal media data store. The set of media content can be videos, photos, images drawn or created on a personal computer, a mobile device, a smart phone and the like, for example.

At 2804, the method includes determining a set of media content portions including content that corresponds to a word or a phrase of associated audio content, such as portions of video associated with a word or phrase. The word or phrase can be a determined word or phrase, such as by analysis of an image to determine an action, as well as a word or phrase from audio content.

At 2806, the method includes portioning the set of media content based on the one or more words, phrases and actions into the set of media content portions. At 28028, the method includes tagging the set of media content portions with a word or a phrase. At 2810, the method includes receiving textual input having words or phrases for the multimedia message. At 2819, the method includes generating the multimedia message with the set of media content portions according to the textual input including words or phrases that match the tagged word or phrase of the set of media content portions.

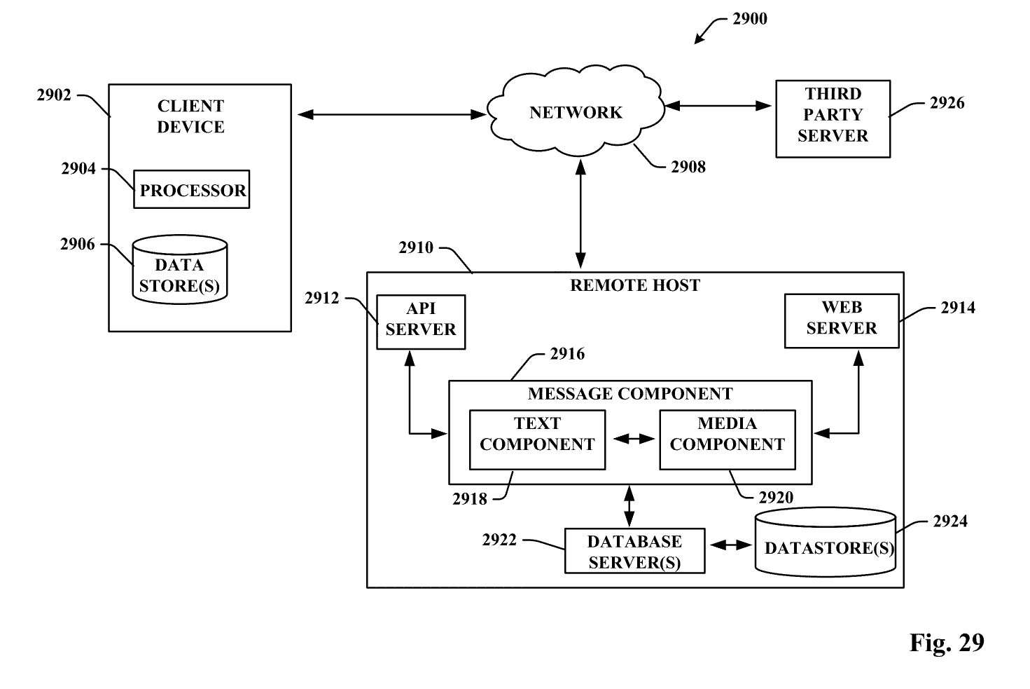

Referring to FIG. 29, illustrated is an example system 2900 for generating one or more messages having video and/or audio content that corresponds to a set of text inputs in accordance with various aspects described herein. The system 2900 is operable as a networked messaging system that communicates multi-media messages via a computing device, such as a computing device, a mobile device or mobile phone. The system 2900 includes a client device 2902 that includes a computing device, a mobile device and/or a mobile phone that is operable to communicate one or more message to other devices via an electronic digital message (e.g., electronic mail, a text message, a multimedia text message and the like). The client device 2902 includes a processor 2904 and at least one data store 2906 that processes and stores portions of media content such as video clips of a video comprising multiple video clips, portions of videos and/or portions of audio content and image content that is associated with the videos. The video clips, video segments and/or portions of videos can also include song segments, sound bites, and/or other media content such as animated scenes, for example. The clips, portions or segments of media content stored can be stored in an external data store, such as a data store 2924, in which the media content can include portions of songs, speeches, and/or portions of any audio content.

The client device 2902 is configured to communicate to other client devices (not shown) and to a remote host 2910 via a network 2908. The client device 2902, for example, can communicate a set of text inputs, such as typed text, audio or some other input that generates a digital typed message having alphabetic, numeric and/or alphanumeric symbols for a message. For example, the client device 2902 can communicate via a Short Message Service (SMS) that is a text messaging service component of phone, web, or mobile communication systems, using standardized communications protocols that allow the exchange of short text messages between fixed line and/or mobile devices. Any other message such as an email or any electronic message (e.g., electronic mail) is also envisioned.

The client device 2902 is operable to communicate multimedia content via the network 2908, which can include a cellular network, a wide area network, local area network and other networks. The network 2908 can also include a cloud network that enables the delivery of computing and/or storage capacity as a service to a community of end-recipients that entrusts services with a user's data, software and computation over a network. For example, the client device 2902 can include multiple client devices, in which end users access cloud-based applications through a web browser or a light-weight desktop or mobile app while software and user's data can stored on servers at a remote location.

The system 2900 includes the remote host that is communicatively connected to one or more servers and/or client devices via the network 2908 for receiving user input and communicating the media content. A third party server 2933, for example, can include different software applications or modules that may host various forms of media content 2902 for a user to view, copy and/or purchase rights to. The third party server 2933 can communicate various forms of media content to the client device 2902 and/or remote host 2910 via the network 2908, for example, or via a different communication link (e.g., wireless connection, wired connection, etc.). In addition, the client device can also enable viewing, interacting or be configured to communicate input related to the media content. For example, the client device 2902 can have a web client that is also connected to the network 2908. The web client can assist in displaying a web page that has media content, such as a movie or file for a user to review, purchase, rent, etc. Example embodiments can include the remote host 2910 operable as networked system via a client machine or device that is connected to the network 2908 and/or as an application platform system. Aspects of the systems, apparatuses or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), electronic devices, virtual machine(s), etc. can cause the machine(s) to perform the operations described.

The network 2908 is communicatively connected to the remote host 2910, which is operable as a networked host to provide, generate and/or enable message generation on the network 2908 and/or the client device 2902. The third party server 2933, client device 2902 and/or other client device, for example can requests various system functions by calling application programming interfaces (APIs) residing on an API server 2912 of the remote host 2910 for invoking a particular set of rules (code) and specifications that various computer programs interpret to communicate with each other. The API server 2912 and a web server 2914 serves as an interface between different software programs, the client machines, third party servers and other devices and facilitates their interaction with a message component 2916 and various components having applications for hardware and/or software. A database server 2922 is operatively coupled to one or more data stores 2924, and includes data related to various described components and systems described herein, such as portions, segments and/or clips of media content that includes video content, imagery content, and/or audio content that can be indexed, stored and classified to correspond with a set of text inputs.

The message component 2916, for example, is configured to generate a message such as a multimedia message having a set of media content portions. The message component 2916 is communicatively coupled to and/or includes a text component 2918 and a media component 2920 that operate to convert a set of text inputs that represent or generate a set of words or phrases to be communicated by the client device 2902 and/or the third party server 2933. For example, the set of text inputs can include voice inputs, digital typed inputs, and/or other inputs that generate a message with words or phrases, such as a selection of predefined words or phrases. For example, text input can be received by the text component 2918 and communicatively coupled to the media component 2920.

The media component 2920, in response to a set of text inputs received at the text component 2918 is configured to generate a correspondence of a set of media content portions with the set of text inputs. For example, words or phrases of the text input can be associated with words and phrases of a video. In addition or alternatively, the media component 2920 is configured to dynamically, in real time generate corresponding video scenes, video/audio clips, portions and/or segments from an indexed set of videos stored in the data store 2924, data store 2906, and/or the third party server 2933.

The media component 2920 is configured to determine a set of media content portions that respectively correspond to the set of words or phrases according to a set of predetermined criteria, such as by storing and grouping the media content portions or segments, for example, according to words, action scenes, voice tone, a rating of the video or movie, a targeted age, a movie theme, genre, gestures, participating actors and/or other classifications, in which the portion and/or segment is corresponded, associated and/or compared with the phrases or words of received inputs (e.g., text input). In one example, a user, such as a user that is hearing impaired, can generate a sequence of video clips (e.g., scenes, segments, portions, etc.) from famous movies or a set of stored movies of a data store without the user hearing or having knowledge of the audio content. Based on the set of text inputs the user provides or selects, portions of video movies/audio can be provided by the media component 2920 for the user to combine into a concatenated message. The message can then be communicated by being played with the sequence of words or phrases of the textual input by being transmitted to another device, and/or stored for future communication. The media component 2920 therefore enables more creative expressions of messaging and communication among devices.

In another example, a client device 2902 or other party generates the message via the network 2908 at the remote host 2910, and then the remote host 2910 communicates the message created to the client device 2902, third party server 2933 and/or another client for further communication from the client device 2902. In addition or alternatively, the message can be generated directly at the client via an application of the remote host 2910. The messages generated can span the imagination, and correspond to phrases or words according to actions or images that make up portions of media content or video content. For example, an angry gesture can be identified via the text input and a gesture corresponding to the identified angry gesture can be identified within the set of media content portions, and, in turn, placed within the message, such as a video message with scenes or clips corresponding to the text input. A middle finger being given by an actor in a famous movie, for example, could correspond to certain curse words or phrases within the set of text inputs received at the text component 2918, and then concatenated into the message by the message component 2916 to correspond to the emoticon, icon, or text based graphic as part of the message made of corresponding movie scenes (i.e., portions, segments, and/or clips of video).

In one embodiment, the media component 2920 is configured to generate a set of media content portions that correspond to the words or phrases of text according to a set of predetermined criteria and/or based on a set of user defined preferences/classifications. For example, the media component 2920 can include a set of logic (e.g., rule based logic or other reasoning processes) that is implemented with an artificial intelligence engine (not shown) such as via a rule based logic, fuzzy logic, probabilistic, statistical reasoning, classifiers, neural networks and/or other computing based platforms. The media component 2920 is configured to identify and organize portions of video and/or audio content for generation of multimedia messages based on textual inputs. As stated above, the text inputs can be selected, communicated and/or generated onsite via a web interface of the remote host 2910. The message component 2916 responds to the text input by dynamically generated a multimedia message that corresponds to the words or phrases of the text message of the text input. The portions of media content can correspond to the words or phrases according to predefined/predetermined criteria, for example, based on audio that matches each word or phrase of the text inputs.

In one embodiment, words that have little or less meaning, such as articles (e.g., the, a, an, etc.) can be set by a user preference to be ignored, altered to a different article and/or incorporated with the word or phrase in a media content portion that corresponds to the input word or phrase received. If particular words are ignored, the message component 2916 can still generate the message according to other word types, such as verbs, nouns, adjectives, adverbs, prepositions, etc. and still create the multimedia message from the text inputted for the message. Although each word of a message, including words such as articles, could be selected to also provide media content portions that also correspond to the words or phrase, and thus, the system is not limited in capability or options to the user for words or phrases of a message to be generated in various media content portions.

In another embodiment, the multimedia message can be generated to comprise a sequence of video/audio content portions from different videos and/or audio recordings that correspond to words or phrase of the input received (e.g., a text inputted message). The message can be generated to also display text within the message, similar to a text overlay or a subtitle that is proximate to or within the portion of the video corresponding to the word or phrase of the input. In the case of audio, the text message can also be generated along with the sound bites or audio segments (e.g., a song, speech, etc.) corresponding to the words or phrases of the text.

In another embodiment, a text message received via text input to the text component 2918 is also configured to receive emoticons, text-based images, such as a colon and a closed parenthesis for a smiley face or any other text-based image or graphic. The media component 2920 is configured to identify the text-based image and generate a video scene or image that corresponds thereto. For example, a smiley face received as a colon and a closed parenthesis could initiate the media component 2920 to generate a corresponding image of video, such as a smile from the Cheshire cat in the movie “Alice and Wonderland.”

In another embodiment, the message component 2916 is further configured to generate a voice overlay via a voice overlay component (not shown). The text component 2918 receives the text input and is further configured to dynamically generate a voice that corresponds to the text, which is one example of a user preference that can be set to operate along with the operations discussed above. The user preference can provide for a female, male, young, old, and/or tone of voice for the voice overlay, which is generated to accompany the set of media content assembled as part of the message. For example, a text input could be the following: “How are you? It's a beautiful morning!” In response, the message component 2916 is operable to generate a message with the text message, with a voice overlay in a chosen voice, and/or the sequence of video/audio content that corresponds to each word or phrase of the message. In addition, the audio of a video could be muted or overlap the voice overlay for a duet vocal, and video message. Likewise the video could be blocked to only generate the audio of the corresponding video portion.

As stated above, the media component 2920 generates a message of media content portions that correspond to text input according to a set of predetermined criteria. The predetermined criteria, for example, include a matching classification for the set of video content portions according to a set of predefined classifications, a matching action for the set video content portions with the set of words or phrases, or a matching audio clip (i.e., portion of audio content) within the set of video content portions that matches a word or phrase of the set of words or phrases. In addition, the matches or matching criteria of the predetermined criteria can be weighted, so that search results or generated results of corresponding media content portions are not exact. For example, a weighting of the predetermined criteria including a matching audio content for the set of video content portions can be weighted at only a certain percentage (e.g., 75%) so that the generated corresponding content generates a plurality of media content portions for a user to select from in building the message that not only matches the word or phrase the portion corresponds to, but also includes grunts, onomatopoeias, conjunctions or dialects of a word such as “y'all” for “you all,” if one is southern born.

Further, the media component 2920 is configured to generate a message of media content portions (e.g., portions of video and/or audio that accompanies or does not accompany video), in response to the words or phrases of text according to a set of user pre-defined preferences/classifications (i.e., classification criteria). Classifying the set of media content portions (e.g., video/audio content portions) according to a set of predefined classifications includes classifying the media content portions according to a set of themes, a set of media ratings, a set of target age ranges, a set of voice tones, a set of extracted audio data, a set of actions or gestures (e.g., action scenes), an alphabetical order, gender, religion, race, culture or any number of classifications, such as demographic classifications including language, dialect, country and the like. In addition, the media content portions can be generated according to a favorite actor or a time period for a movie. Thus, a user can predefine preference for the message component 2916 to dynamically generate videos on demand, in real time, dynamically or in a predetermined classification according to the set of video content portions that correspond to words or phrases of a text message.

In another embodiment, the message component 2916 is configured to generate media content portions that include video portions of a video mixed with audio portions of another movie that both correspond to words or phrases in a text message. For example, the media component 2916 is configured to generate video scenes that correspond to a word or phrase of a text message, in which the audio of the movie can correspond or some other content correspond to the textual word or phrase. While one scene or segment of an audio and/or video component can be generated to correspond with the phrase or word, any number of scenes, segments or audio portions can also be generated and mixed so that a video saying the word “Hello” by the actor John Wayne can be replaced with audio from another movie with the same audio, but different video, such as from Jim Carrey. As such, the audio of one video portion can be replaced with the audio of another video portion and selected to represent the particular word or phrase from the textual input for the multimedia message.

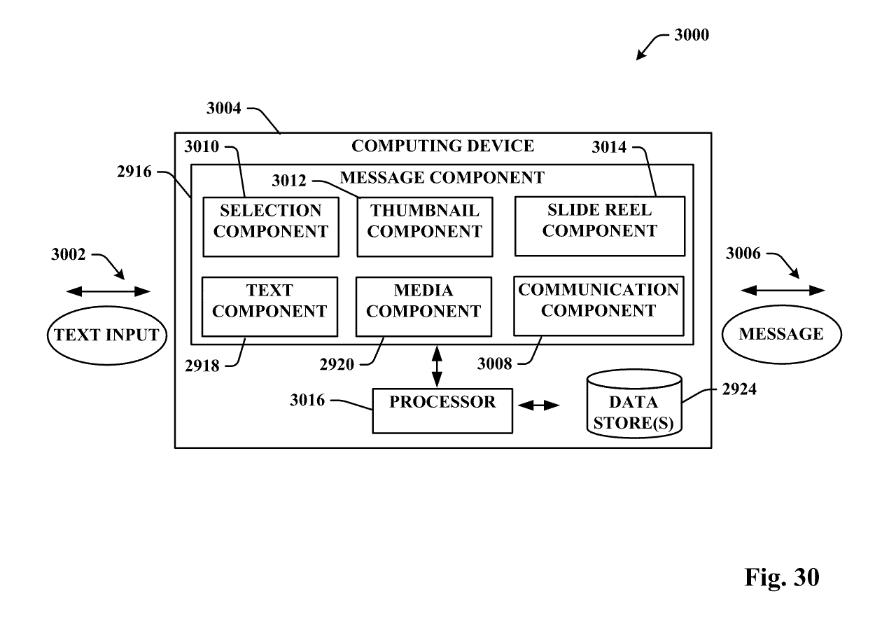

Referring now to FIG. 30, illustrated is a system 3000 that generates a message having various media content portions to correspond to a text message input in accordance with various embodiments disclosed in this disclosure. The system 3000 includes a computing device 3004 that can comprise a remote device, a personal computing device, a mobile device, and any other processing device. The computing device 3004 includes the message component 2916, a processor 3016 and the data store 2924. The computing device 3004 is configured to receive a text input 3002 via a voice input, a typed text input and/or via a selection of a textual word or phrase in the data store 2924.

The message component 2916 includes the text component 2918 that is configured to receive the set of text inputs 3002 and to generate a set of words or phrases of a message 3006. The message 3006 includes a set of video images or video scenes, clips, portions segments, etc. that correspond to the text input 3002. The computing device 3004 is configured to create the message 3006 as a multimedia message that has scenes or segments from different videos or movies that enact and/or have audio content that reflects, is indicative of, or corresponds to the words or phrases of the text input 3002.

The message component 2916 includes the text component 2918 and the media component 2920, which is configured to generate a set of media content portions (e.g., video scenes, and/or audio portions) of a media content that corresponds to words or phrases of the text input 3002, which can be communicated to the system by a user, such as by an electronic message, selections of text, and any other means for a message to be generated from the inputted text. The message component 2916 further includes a communication component 3008, a selection component 3010, a thumbnail component 3012 and a slide reel component 3014. The communication component 3008 is configured to communicate the message 3006 to a different device via a network, such as a mobile device or another computing device. The communication component 3008 can include a transceiver, for example, or any other communicating component for transmitting and/or receiving multimedia messages, video messages, text message, audio messages and/or any electronic message to a user.

The selection component 3010 is configured to receive a selection of a media content portion of a plurality of media content portions associated with a word or phrase of the set of words or phrases to include in the set of media content portions. Based on the received selection, the thumbnail component 3012 is configured to generate a set of representative images that represent the set of media content portions corresponding to the set of words or phrases. The representative images can include thumbnail images such as still scene shots, and/or metadata representative of and associated with each media content portions generated by the media component 2920 and/or that is selected by a composer of the message. Each thumbnail image can represent a word or phrase of the text message and of a word, phrase, image, and/or action of the media content portion represented. The slide reel component 3014 is configured to present the set of representative images of the thumbnail component 3012 in a selected order, in which the message 3006 is to be viewed by a recipient of the message. In one example, the message is composed along a slide reel that is generated by the slide reel component 3014 for the selections and the order to be defined. The selections received populate the slide reel in a concatenated sequence of video and/or audio content portions, in which the message 3006 will be composed. The order can be altered and the selected video/audio content portions assigned to each slide or reel can be altered. For example, if a video/audio content portion expressing the word “dog” is desired to be changed to “cat,” the thumbnail portion representing “dog” can be dragged out and another media content portion representing “cat” can replace the one representing “dog” by being dragged/dropped in the same location in along the slide reel. Further, the slide reel component 3014 is also operate to generate a preview of the concatenated sequence of video and/or audio content portions for a user to view before sending the final composed message.

The selection component 3010 is configured to receive a selection of a media content portion of a plurality of media content portions associated with a word or phrase of the set of words or phrases to include in the set of media content portions. For example, a query term or phrase could be entered to search for video content and/or audio content that includes or expresses the particular word or phrase. Upon receiving one or more results, the message component 2916 can receive a selection of the media content, splice or edit the media content portion having the word or phrase selected and represent it as an option to be included within the slide reel, or within another view pane, individually or with a group of other media content portions.

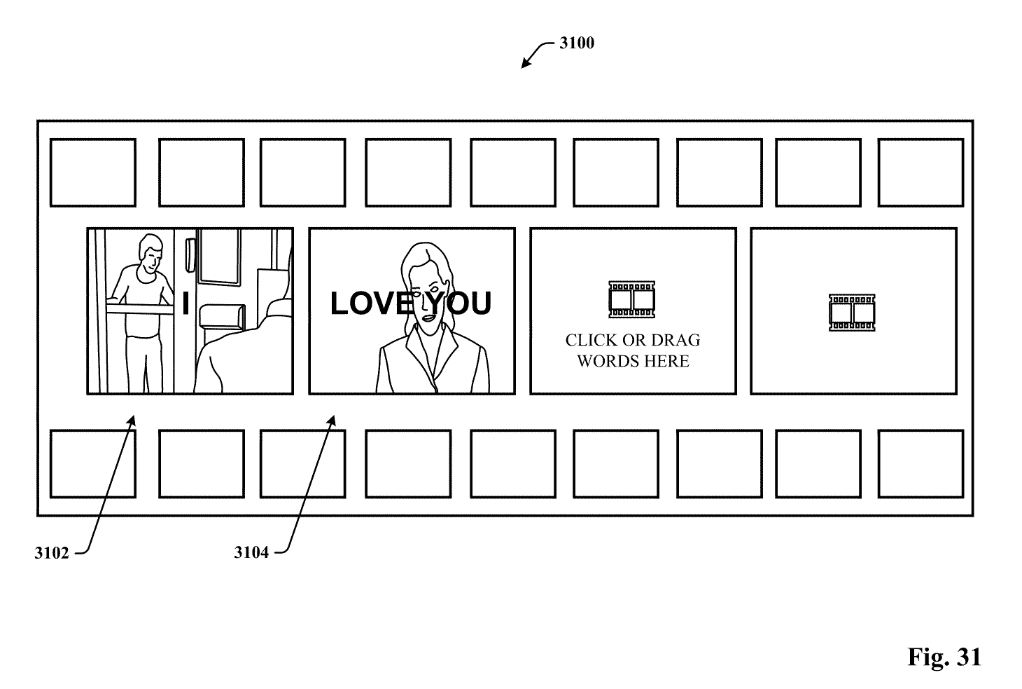

FIG. 31 illustrates one example of a generated slide reel by the slide reel component 3014 having a set of representative images in a selected order. The text words or phrases “I LOVE YOU” are presented as an overlay of each representative image. However, the text can be proximate to or alongside each thumbnail image slide 3102 and/or 3104. In one example, the word “I” is depicted to correspond with a selected media content portion comprising a video scene from a movie with an actor saying the word “I” with a certain tone and reflection, and is previewed in a slide 3102 having a thumbnail image of the video content portion that corresponds to the word “I”. Likewise, the next slide in the concatenated order includes the phrase “LOVE YOU” and corresponds to a set of scenes or a video/audio media content portion from a movie with a different actor of a different context expressing the phrase “LOVE YOU.” In addition, other media content portions could be selected to fill other reels, such as “VERY” and “LITTLE” after the slides 3102 and 3104. In addition, the thumbnail images can be other types of image data or representative data of the media content portions corresponding to a word, phrase and/or an image received, as well as include metadata that pertains to the media content portion. For example, video clips can be represented with thumbnail images and/or other data such as metadata that details properties, classification criteria, information about actors, filmed date, genre, rating, themes, awards received, and any data pertaining to the particular video that the video clip is cut or sliced from. Other forms of media content portions can also include metadata represented in a thumbnail image or other image such as audio data having information about the song, singer, speech, and/or other vocal expression. Consequently, the video sequence is represented by the thumbnails of the reel 3100, such as generated by the slide reel component 3014, but when communicated is played as a video with audio and/or the textual messages concatenated in a single video, such as, for example, the message 3006 of FIG. 30 and/or as generated for preview by the slide reel component 3014. Additionally or alternatively, portions could include only audio, and/or only video, and/or still image portions having audio or not. The text message can be generated with the other media content portions that correspond thereto, and/or without. The text message can be overlaying and/or proximate to as subtitles to the multimedia message.

In some embodiments, the systems (e.g., system 2900) and methods disclosed herein are implemented with or via an electronic device that is a computer, a laptop computer, a router, an access point, a media player, a media recorder, an audio player, an audio recorder, a video player, a video recorder, a television, a smart card, a phone, a cellular phone, a smart phone, an electronic organizer, a personal digital assistant (PDA), a portable email reader, a digital camera, an electronic game, an electronic device associated with digital rights management, a Personal Computer Memory Card International Association (PCMCIA) card, a trusted platform module (TPM), a Hardware Security Module (HSM), a set-top box, a digital video recorder, a gaming console, a navigation device, a secure memory device with computational capabilities, a digital device with at least one tamper-resistant chip, an electronic device associated with an industrial control system, or an embedded computer in a machine.

In some embodiments, a bus further couples the processor to a display controller, a mass memory or some type of computer-readable medium device, a modem or network interface card or adaptor, and an input/output (I/O) controller. The display controller may control, in a conventional manner, a display, which may represent a cathode ray tube (CRT) display, a liquid crystal display (LCD), a plasma display, or other type of suitable display device. Computer-readable medium may include a mass memory magnetic, optical, magneto-optical, tape, and/or other type of machine-readable medium/device for storing information. For example, the computer-readable medium may represent a hard disk, a read-only or writeable optical CD, etc. A network adaptor card such as a modem or network interface card is used to exchange data across the network. The I/O controller controls I/O device(s), which may include one or more keyboards, mouse/trackball or other pointing devices, magnetic and/or optical disk drives, printers, scanners, digital cameras, microphones, etc.

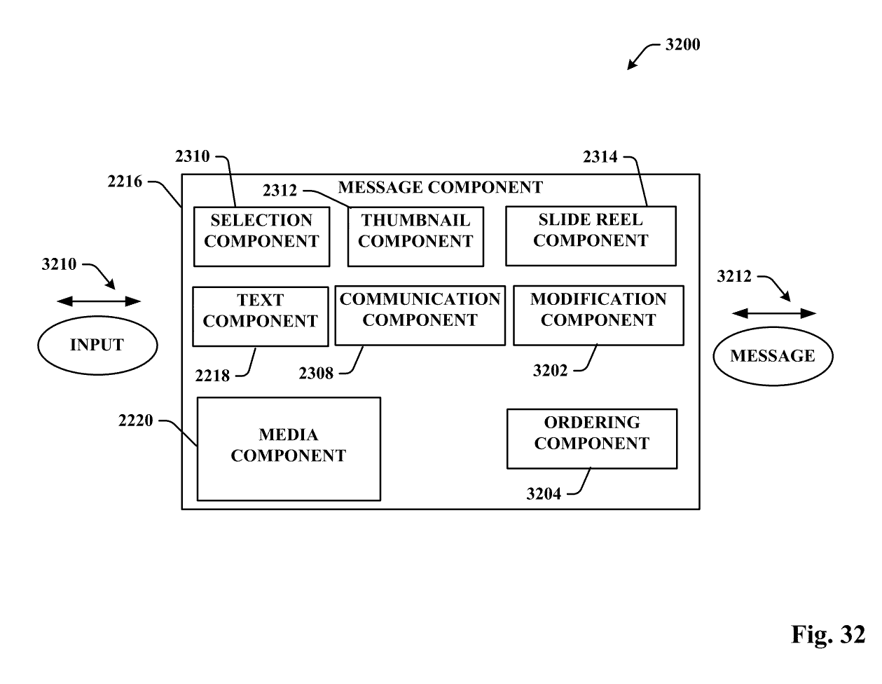

Referring to FIG. 32, illustrated is a system 3200 that generates messages with various forms of media content from a set of inputs, such as text, voice, and/or predetermined input selections that can be different or the same as the media content of the message in accordance with various embodiments herein. The system 3200 includes the message component 2916 that is configured to receive a set of inputs 3210 and communicate, transmit or output a message 3212. The set of inputs 3210 comprise a text message, a voice message, a predetermined selection and/or an image, such as a text-based image or other digital image that is received by the system according to a user's input for a message. The message 3212 that is generated by the message component 2916 is operable to convert the input to a message having different forms of media content, such as a set of videos, audio and/or scenes or images of a movie that correspond to the content or phrases and words expressed by the set of inputs 3210.

The message component 2916 includes the text component 2918, the media component 2920, the communication component 3008, the selection component 3010, the thumbnail component 3012, and the slide reel component 3014, which operate similarly as detailed above. The message component 2916 further includes a modification component 3202 and an ordering component 3204, and the media component 2920. These components integrate as part of the message component or separately in communication to one another to provide an expressive message that is able to be modified creatively and dynamically by a user with a computer device (e.g., a mobile device or the like). The message component 2916, for example, is configured to analyze the inputs 3210 received at an electronic device or from an electronic device, such as from a client machine, a third party server, or some other device that enables inputs to be provided from a user. The message component 2916 is configured to receive various inputs and analyze the inputs for textual content, voice content and/or indicators of various emotions or actions being expressed with regard to media. For example, a text message may include various marks, letters, and numbers intended to express an emotion, which can be discernible by analyzing a store of other texts, or ways of expressing emotions. Further, the way emotions are expressed in text can change based on cultural language, different punctuations used within different alphabets, for example. The message component 2916 thus is configured to translate inputs from one or more users into an image (e.g., an emotion, expression, action, gesture, etc.). The message component 2916 is thus operable to discern the different marks, letters, numbers, and punctuation to determine an expressed word, phrase, expression (e.g., an emotion) and/or image from the input, such as from a text or other input 3210 from one or more users in relation to media content, and based on the input generate a message having one or more different types of media content, such as video, audio, text, imagery, etc.

The modification component 3202 is configured to modify media content portions of the message 3212. The modification component 3202, for example, is operable to modify one or more media content portions such as a video clip and/or an audio clip of a set of media content portions that corresponds to a word or phrase of the set of words or phrases communicated via the input 3210. In one embodiment, the modification component 3202 can modify by replacement of the media content portions with a different media content portion to correspond with the word or phrase identified in the input 3210. For example, the message generated 3212 from the input 3210 via the message component 2916 can include media content portions, such as text phrases or words (e.g., overlaying or proximately located to each corresponding media content portion), video clips, images and/or audio content portions. If desired, the modification component 3202 can modify the message with a new word or phrase to replace an existing word or phrase in the message, and, in turn, replace a corresponding video clip. Additionally or alternatively, a video portion, audio portion, image portion and/or text portion can be replaced with a different or new video portion, audio portion image portion and/or text portion for the message to be changed, kept the same, or better expressed according to a user's defined preference or classification criteria. In addition or alternatively, the message component can be provided a set of media content portions that correspond to a word, phrase and/or image of an input for generating the message 3212 and/or to be part of a group of media content portions corresponding with a particular word, phrase and/or image.

In another embodiment, the modification component 3202 is configured to replace a media content portion that corresponds to the word or phrase with a different video content portion that corresponds to the word or phrase, and/or also replace, in a slide reel view (e.g., slide reel view 3100), a media content portion that corresponds to the word or phrase with another media content portion that corresponds to another word or phrase of the set of words or phrases.

The ordering component 3204 is configured to modify and/or determine a predefined order of the set of media content portions based on a received modification input for a modified predefined order, in which the communication component 3008 can communicate the modified predefined order in the message with the set of words or phrases in the modified predefined order. For example, a message that is generated by the message component 2916 with media content portions to be played in multimedia message such as a video and/or audio message, can be organized in a predefined order that is the order in which the input is provided or received by the message component 2916. The ordering component 3204 is thus configured to redefine the predefined order by either drop, drag, and/or some other ordering input that rearranges the slide reel view 3100. For example, the video sequence 3100 could be generated in the order in which the input 3210 is received, namely as “I LOVE YOU.” However, the ordering component 3204 is operable to rearrange the phrase and/or words of the concatenated reels without beginning a new message or providing different input 3210. For example, the message could be re-ordered to generate “YOU I LOVE NOT” by also adding “NOT” having a set of media portions associated therewith. A user or device can reorder the phrase I LOVE YOU (that is, if “LOVE YOU” is pieced as words and not grouped as a phrase) and add the input “NOT.” By inputting “NOT,” the user is then able to select from a plurality of media content portions generated from a data store that corresponds with “NOT.”

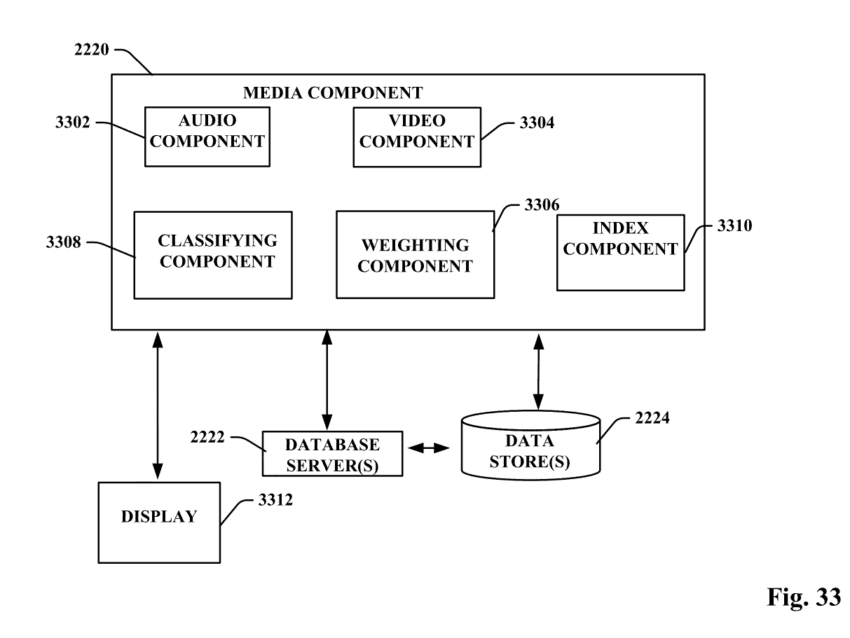

Referring now to FIG. 33, illustrated is an exemplary media component 2920 in accordance with various embodiments disclosed herein. The media component 2920 further includes an audio component 3302 and a video component 3304. The audio component 3302 is configured to determine a set of audio content portions that respectively correspond to the set of words or phrases according to the set of predetermined criteria. The audio content portions can be generated form a data store of songs, speeches, videos, sound bites and/or other audio recordings stored by a user, a server or some other third party. The audio component 3302 can search for audio within a set of videos while the video component 3304 can search for audio within a set of audio recordings. Likewise, the video component 3304 is configured to determine a set of video content portions that correspond to the set of words or phrases according to the set of predetermined criteria and generate them for the media component 2920 to generate a multimedia message as described in this disclosure.

In one embodiment, the audio content and video content generated by the audio component 3302 and the video component 3304 can overlap and generate the same or matching media content in which the audio of each matches a word, phrase and/or image of the inputs received from a user. Additionally, the audio component 3302 and video component 3304 are operable to generate different groups of media content portions to correspond with a phrase, word or image of the input, in which a user could select from the group of media content portions that correspond to a particular phrase, word or image. In addition, a weighting component 3306 can generate a weight indicator according to the set of user classification criteria that can be stored, defined and generated by a classifying component 3308. For example, if a user's preference is set to Western sayings and/or Western movies, then videos and audio of John Wayne or other Western actors could be weight high and ordered in a ranked order from least to greatest or vice versa; while other non-Western media content portions are either not generated or ranked lower. In another embodiment, the video and audio components store and generate upon query predefined video, audio and/or image portions that correspond to a phrase, word, and/or image to automatically be generated based on the input having phrases, words and/or images that is received.

The classifying component 3308 is configured to store and communicate information about the user's preferences to the audio component 3302 and the video component 3304 in order to ensure searches for media content portions are generated according to classification criteria such as by audience categories according to demographic information, such as generation (e.g., gen X, baby boomers, etc.), race, ethnicity, interests, age, educational level, and the like. The user can decide or opt to search video/audio portions, for example, according to theme, genre, actor, awards of recognition, age, rating, religion, etc. according to user's taste and personality desired to be conveyed within the multimedia message generated, for example. The media content portions can then be viewed, previewed or manipulated further in a display 3312.

The media component 2920 further comprises and index component 3310 that can index media content portions generated that correspond to various phrases, words, gestures, and/or images according to various classifications discussed herein, such as actors, time periods, country of origin, languages, cultures, ratings, audience, etc. In one example, a server can provide a data store (e.g., the data store 2924), and/or data base with media content having edited movie clips, video clips, audio clips, image clips, etc., and/or content (e.g., audio, video and the like) in its entirety. In addition, a user can also provide from a data store or memory on a user device, computer device, mobile device and the like with a store of videos, songs, audio content (e.g., speeches, news clips, clips of events, etc.). The media content from any number of data stores external or internal can be analyzed and portioned according to the predetermined criteria discussed herein. The index component 3310, for example, can search according to natural language, imagery analysis, facial recognition, gesture recognition algorithms, etc. to edit and portion sets of media content portions and classify them according to the classification criteria for fast look up and retrieval.

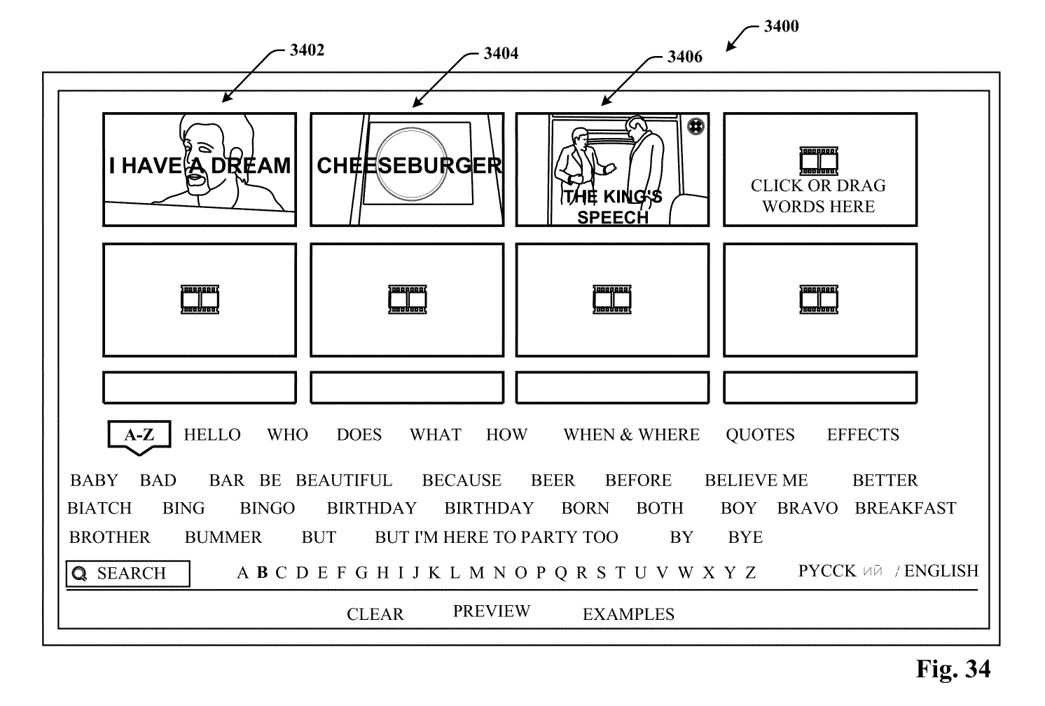

FIG. 34 illustrates one example of a view pane 3400 having predetermined text inputs that can be searched for and/or selected that have corresponding media content portions. Example view panes described herein are representative examples of aspects disclosed of one or more embodiments. These figures are illustrated for the purpose of providing examples of aspects discussed in this disclosure in viewing panes for ease of description. Different configurations of viewing panes are envisioned in this disclosure with various aspects disclosed. In addition, the viewing panes are illustrated as examples of embodiments and are not limited to any one particular configuration. The text inputs, for example, can be provided in a search component in order to find words or phrases with corresponding video portions. In addition or alternatively, for example, the text inputs could be words or phrases to search media content to correspond to the words or phrases according to a set of predetermined criteria, as discussed herein.

In one example of the view pane 3400, phrases, words and/or images can be dragged into the slide reel generated by the slide reel component 3014. The words or phrases can be classified according to classification criteria by the classifying component 3308 and/or an index component 3310, and further according to media content corresponding to the phrases, words, and/or images that meet a set of classification criteria, such as for popular videos (e.g., movies). The thumbnail component 3012 generates a display of a representation of each media content portion (e.g., video clips) with an indicator of the type of message the media content portion expresses. The words or phrases, and associated media content portions can be indexed by the media index component 3310. For example, a media content portion 3402 has the phrase “I HAVE A DREAM,” is expressed by a portion of the movie “You Don't Mess with the Zohan.” The thumbnail component is configured to generated metadata or information related to the media content portion when an input for example, such as a hovering input or else is sensed. For example, the media content portion 3406 displays metadata that the media content portion is derived from the movie “The Kings Speech,” in which the phrase “BEER” is spoken in a lucrative office setting. In addition, the media content portion 3404 includes “CHEESEBURGER” that is expressed by a portion or segment of the movie “Cloud with a Chance of Meatballs,” with a very deep machine voice.

Additionally, the viewing pane 3400 can include various classifications of various media content portions, such as alphabetical orderings, popular phrases, type of content or categories of words or phrases, quotes, effects and others, which can include sound effects, stage effects, video effects, dramatic actions, expressions, shouts, etc., which can be composed and transmitted via a mobile device or other device in a text message, multimedia message and/or other type messages.

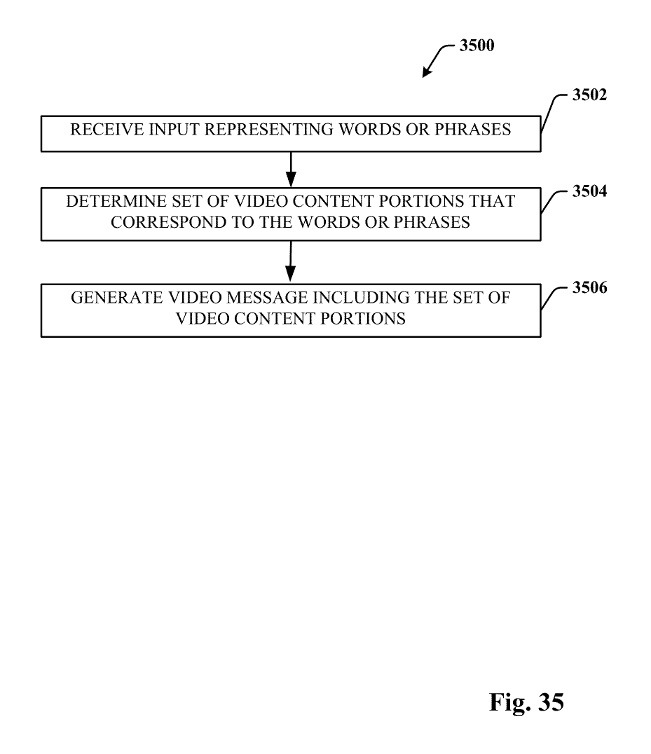

An example methodology 3500 for implementing a method for a messaging system is illustrated in FIG. 35 in accordance with aspects described herein. The method 3500, for example, provides for a system to interpret inputs received expressing a message via text, voice, selections, images, emoticons of one or more users and generating a corresponding message with media content portions for the portions, or segments of the inputs received. An output message can be generated based on the inputs received with a concatenation or sequence of media content portions of a group of different media content portions (e.g., video, audio, imagery and the like). Users are provided additional tools for self-expression by sharing and communicating message according to various taste, culture and personality.

At 3502, the method initiates with receiving, by a system including at least one processor, a set of text inputs that represent a set of words or phrases for a message. At 3504, a set of video content portions is determined that correspond to the set of words or phrases. The determining can occur according to a set of predetermined criteria. For example, the predetermined criteria can include a matching classification for the set of video content portions according to a set of predefined classifications (e.g., classification criteria), a matching action for the set video content portions with the set of words or phrases, and/or a matching audio clip within the set of video content portions that matches a word or phrase of the set of words or phrases.

At 3506 a video message is generated that includes the set of video content portions that correspond to the words or phrases. The message, for example, can be played as a video movie telegram or video based text message that contains the same audio or actions as that expressed in the input received. For example, the message can be generated as a video stream part that includes concatenated portions of different videos from the set of video content portions determined to correspond to the set of words or phrases, and a text part with text representing the set of words and phrases being configured to be displayed proximate to or overlaying the video stream part. The set of video content portions includes audio content portions that correspond to the set of words or phrases, or a set of actions that correspond to the set of words or phrases.

In another embodiment, the method 3500 can include classifying the set of video content portions according to a set of predefined classifications including at least one of a set of themes for the video content portions, a set of media ratings of the video content portions, a set of target age ranges for the video content portions, a set of voice tones of the video content portions, a set of extracted audio data from the video content portions, a set of actions or gestures included in the video content portions, or an alphabetical order of the set of video content portions.

In another embodiment, the method 3500 can include searching for the set of video content portions that correspond to the set of words or phrases in a networked data store, in a user data store on a mobile device, or from the networked data store and the user data store, and/or extracting a set of audio words and/or a set of images from videos to generate the set of video content portions that correspond to the set of words or phrases.

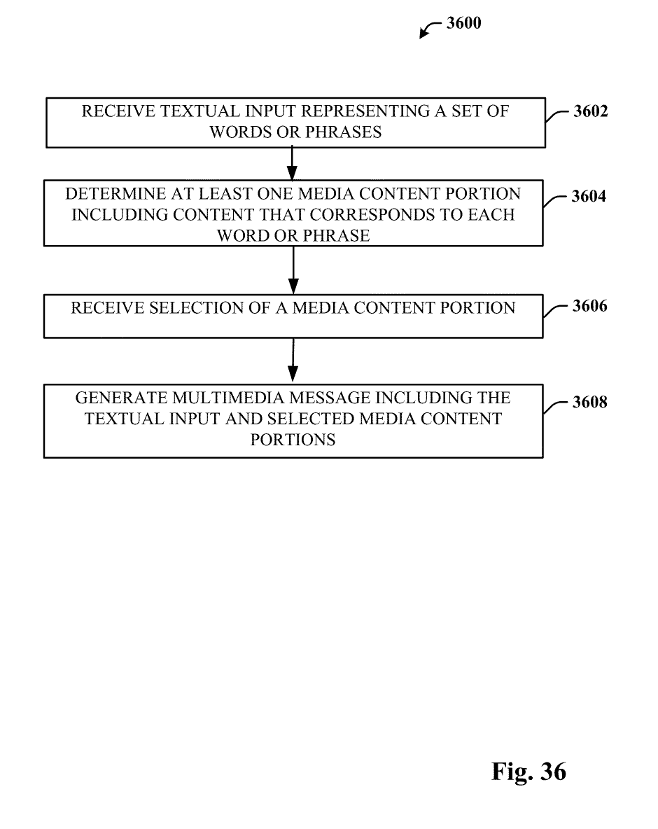

An example methodology 3600 for implementing a method for a system such as a recommendation system for media content is illustrated in FIG. 36. The method 3600, for example, provides for a system to evaluate various media content inputs and generate a sequence of media content portions that correspond to words, phrases or images of the inputs. At 3602, the method initiates with receiving a textual input representing a set of words or phrases of a message to be generated.

At 3602, at least one media content portion including content that corresponds to the word or phrase is determined. At 3606, a selection of a media content portion of the at least one media content portion is received. At 3608, a multimedia message is generated that includes the textual input and the selected media content portions respectively corresponding to the set of words or phrases. The multimedia message can include different portions of videos with audio content or image content

In another embodiment, the method 3600 includes displaying a set of thumbnail images of the selected media content portions in association with displaying respective words or phrases of the set of words or phrases that correspond to the selected media content portions. In addition or alternatively, a word or phrase of the set of words and phrases can be modified to a new word or phrase, and a selection can be received for a new media content portion from a group of media content portions corresponding to the new word or phrase to replace a media content portion associated with the word or phrase.

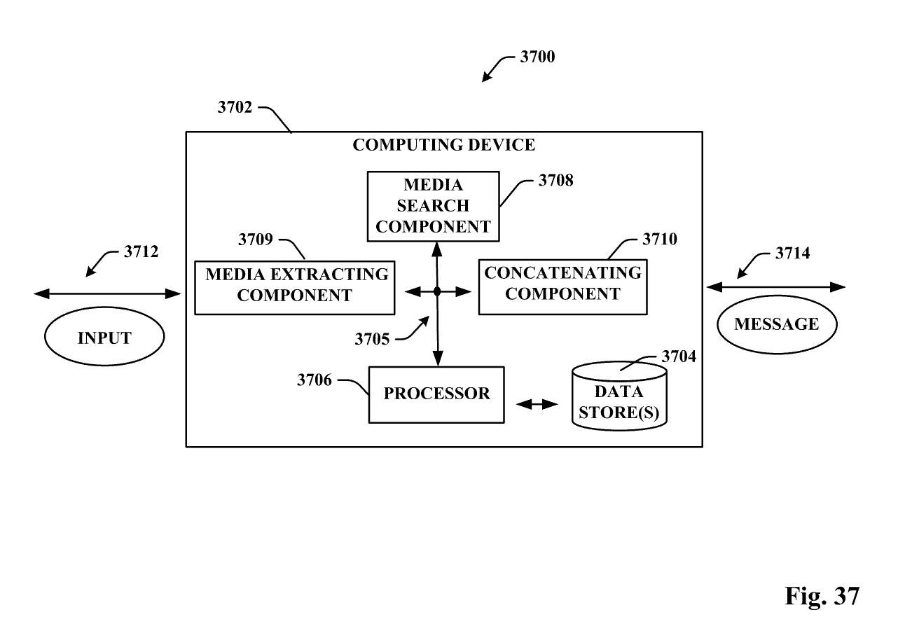

Referring to FIG. 37, illustrated is an example system 3700 that generates one or more messages having media content that corresponds to a set of text inputs in accordance with various aspects described herein. The one or messages generated can include a set of media content portions having one or more portions of video, audio and/or image content extracted from larger video and/or audio recordings. For example, in response to being viewed, a message generates a message that can comprise multiple portions of different videos (e.g., movies) of different video files, of different audio files, and/or of image files. Each of the portions, for example, can correspond to a word, phrase and/or gesture. The system 3700 is operable to create the message from the portions of media content that correspond to the words, phrases, and/or gestures of a set of inputs. The messages therefore can generate a video/audio stream that is a continuous media stream comprising, for example, multiple sound bites being played, multiple video segments being played, and/or multiple images being played from multiple different video, audio and/or images. For example, a video portion corresponding to one word is concatenated with a video portion corresponding to another word, and in response, the message plays two video portions in a sequence, in which each video portion plays a portion of a video or movie that corresponds to a word inputted to the system.

The system 3700 is operable as a networked messaging system that communicates multi-media messages, such as to a computing device, a mobile device, mobile phone, and the like. The system 3700, for example, includes a computing device 3702 that can comprise a personal computer device, a handheld device, a personal digital device (PDA), a mobile device (e.g., a mobile smart phone, laptop, etc.), a server, a host device, a client device, and/or any other computing device. The computing device 3702 comprises a memory 3704 for storing instructions that are executed via a processor 3706. The system 3700 can include other components (not shown), such as an input/output device, a power supply, a display and/or a touch screen interface panel. The system 3700 and the computing device 3702 can be configured in a number of other ways and can include other or different elements. For example, computer device 3702 may include one or more output devices, modulators, demodulators, encoders, and/or decoders for processing data.

The memory or data store(s) 3704 can include a random access memory (RAM) or another type of dynamic storage device that may store information and instructions for execution by the processor 3706, a read only memory (ROM) or another type of static storage device that can store static information and instructions for use by processing logic, a flash memory (e.g., an electrically erasable programmable read only memory (EEPROM)) device for storing information and instructions, and/or some other type of magnetic or optical recording medium and its corresponding drive.

A bus 3705 permits communication among the components of the system 3700. The processor 3706 includes processing logic that may include a microprocessor or application specific integrated circuit (ASIC), a field programmable gate array (FPGA), or the like. The processor 3706 may also include a graphical processor (not shown) for processing instructions, programs or data structures for displaying a graphic, such as a message generated by embodiments disclosed that comprises a continuous stream of video content portions and/or audio content portions, which include segments of a movie, song, speech, filmed event, each including video and/or audio. The message can therefore comprise one or more portions of video/audio content portions, in which each portion is a smaller segment of a larger video and/or audio that plays the smaller segment in a continuous sequence of one portion after the other portion within the message, and according to the order and association to a set of words and/or phrases received in a set of inputs 3712.

The set of inputs 3712 can be received via an input device (not shown) that can include one or more mechanisms in addition to touch panel that permit a user to input information to the computing device 3702, such as microphone, keypad, control buttons, a keyboard, a gesture-based device, an optical character recognition (OCR) based device, a joystick, a virtual keyboard, a speech-to-text engine, a mouse, a pen, voice recognition, a network communication module, etc.

The computing device 3702 includes a media search component 3708 that identifies a set of media content from one or more data stores 3704 based on a set of words or phrases. For example, a video and/or an audio such as a movie or song (e.g., “Streets of Fire,” U2—“Streets have no name”) can be identified by the search. In response to being identified, the media content can be tagged and indexed with metadata that further identifies and/or classifies the media content.

In one embodiment, the media search component 3708 is configured to search large volumes of memory storage and different data storages that can have multiple different types of libraries, files, applications, video content, audio content, etc., as well as to search data stores of third party servers, cloud resources, data stores of client devices, such as mobile devices. The media search component can identify video content (e.g., movies, home videos, video files, etc.) and/or audio content (e.g., movies, videos, video files, songs, audio books, audio files, etc.) from the data store(s) searched. The media search component 3708 can search for media content based on a set of predetermined criteria. For example, the media search component 3708 can search media content based on predefined classifications, such as use preferences that can includes, a theme, an artist, an actor or actress, a rating, a target audience, time period, author, and the like. The media search component 3708 is configured to search for the set of media content based on query terms, for example, that can be provided at a search input field or initiated by a graphical interface control by a user. Additionally or alternatively, the media content search component 3708 is configured to search data stores based on a set of words or phrases within the video content and/or audio content (e.g., a video file, audio file, etc.).

In another embodiment, the media search component 3708 is configured to identify video and/or audio content without receiving input, but only media content. In conjunction with an indexing component (discussed infra) the media search component only has to classify each media content (video content and audio content) and associate the content with an index of words and phrases contained within each media content file, for example.

In another embodiment, the media search component 3708 is configured to search a set of data stores for media content based on the set of inputs 3712 received by the compute device 3702. For example, the media search component 3708 is configured to dynamically search and identify content within a set of media content in a set of data stores that comprises and corresponds to a set of words or phrases of the set of inputs 3712. For example, in response to receiving the phrase, “I'll be coming for her, and I'll be coming for you too”, the media search component 3708 can identify the movie, “Streets of Fire” in the data store 3704 and outputs the particular media content (“Streets of Fire”) as a candidate for extraction to a media extracting component 3709.

The media extraction component 3709 is communicatively coupled to the media search component 3708, and receives media content that has been identified by the media search component 3708. The media extraction component 3709 is configured to extract portions of media content from a video, and/or an audio recording that can respectively comprise a plurality of words and/or phrases as part of the video, audio recording, and the like, so that when each portion is played a portion of the video, audio, etc., is played. Each portion, for example, includes scenes, and/or song portions that include the word and/or phrase of the set of inputs 3712 received. The media extraction component 3709 is configured to extract a set of media content portion from a set of media content based on the set of predetermined criteria, or a set of predetermined extraction criteria.

In one embodiment, the predetermined extraction criteria includes a matching of the words or phrases within the set of media content with the words and phrases of the set of inputs. Additionally or alternatively, the extraction can be a predetermined extraction according to words in a dictionary or other predefined words or phrases. The words, and/or phrases can be then indexed with the extracted portions of media that match the words and/or phrases. The media extraction component 3709 extracts the portions according to the set of predetermined criteria including a predefined location of where to cut, divide and/or segment a video recording, and/or audio recording (e.g., a video movie, song, speech, video/audio file, such as a .wav file and the like). The media extraction component 3709 can extract precise portions of media so that a multimedia message can be generated that includes a plurality of portions that each include movie scenes or song lines. The predetermined criteria can include a vague extraction, an estimated extraction or, in other words, an imprecise extraction so that words, phrases, and/or scenes surrounding the particular word and/or phrase of interest are also included within the portion extracted. This can provide further context of to the word or phrases, in which the portion extracted corresponds to or generate portions of video/audio on demand dynamically by providing a word or phrase via an input, such as a text, voice, selection, and/or other type input. The predetermined criteria can includes at least one of a classification of a set of classification and a matching of media content portions of the set of media content portions from the media content identified with a set of words or phrases. A matching audio clip or portion within the set of media content portions and/or a matching action to the words or phrases can also be part of the set of predetermined criteria by which the media extraction component 3709 extracts portions of video/audio content from media content files or recordings.

The computing device 3702 further includes a concatenating component 3710 that is configured to a concatenating component configured to assemble at least one media content portion of the set of media content portions into a multimedia message based on the set of inputs 3712 received for the multimedia message. The inputs 3712 can be a selection input of predefined words and/or phrases that correspond, or are correlated to the portions of media content extracted. In addition or alternatively, the inputs 3712 can include voice inputs, text inputs, and/or digital handwritten inputs with a touch screen or with a stylus. Thus the concatenation component 3710 generates a continuous stream of media content portions that make up a multimedia message. In response to the message being played, different portions of different video/audio content are played as a continuous video/audio, in which each of the portions include various scenes, musical notes, words, phrases, etc. that play a portion of the original and entire video and/or audio content from which they were extracted from. The concatenation component 3710 is configured to splice various portions together to form one continuous stream of video/audio that can then be sent as a message 3714 with each word or phrase corresponding to the set of inputs 3712 received by the system 3700.

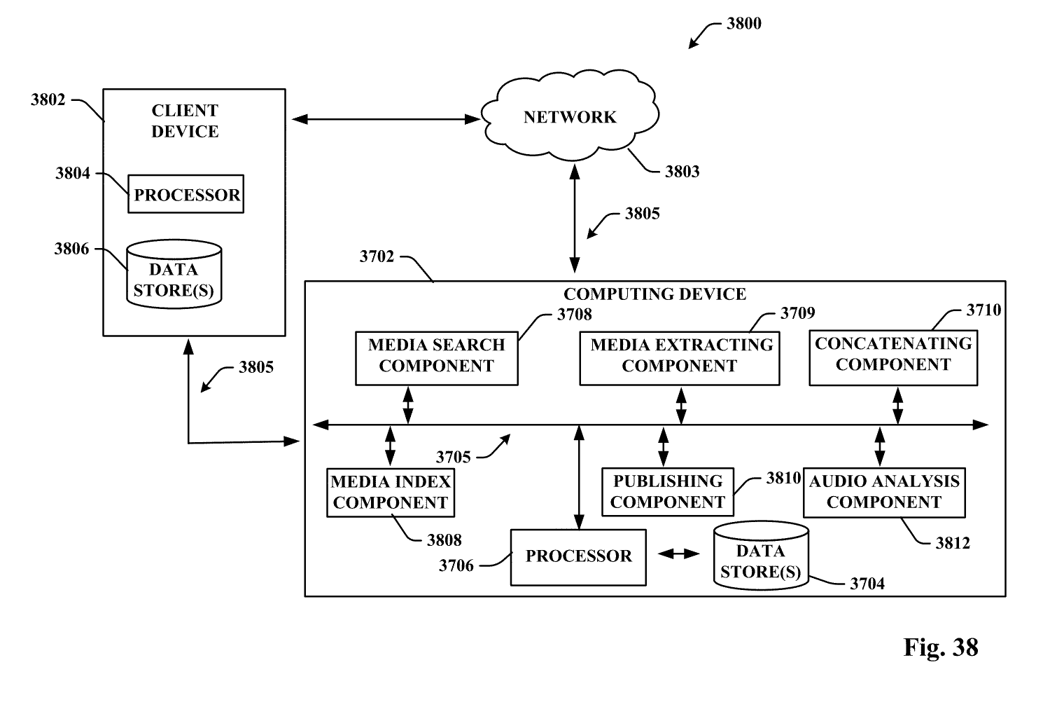

Referring now to FIG. 38, illustrated is a system 3800 that operates to extract media content portions from media content for generation of a multimedia message. The system 3800 includes the computing device 3702 that is communicatively coupled to a client device 3802 via a communication connection 3805 and/or a network 3803 for receiving input and communicating a multimedia message generated by the computing device 3702.

The client device 3802 can comprise a computing device, a mobile device and/or a mobile phone that is operable to communicate one or more message to other devices via an electronic digital message (e.g., a text message, a multimedia text message and the like). The client device 3802 includes a processor 3804 and at least one data store 3806 that processes and stores portions of media content such as video clips of a video comprising multiple video clips, portions of videos and/or portions of audio content and image content that is associated with the videos. The media content portions include portions of movies, songs, speeches, and/or any video and audio content segments that generate, recreate or play the portion of the media content that the media content portions are extracted from. The clips, portions or segments of media content can also be stored in an external data store, or any number of data stores such as a data store 3704 and/or data store 3806, in which the media content can include portions of songs, speeches, and/or portions of any audio content.

The client device 3702 is configured to communicate to other client devices (not shown) and to the computer device 3702 via the network 3803. The client device 3702, for example, can communicate a set of text inputs, such as typed text, audio or any other input that generates a digital typed message having alphabetic, numeric and/or alphanumeric symbols for a message. For example, the client device 3802 can communicate via a Short Message Service (SMS) that is a text messaging service component of phone, web, or mobile communication systems, using standardized communications protocols that allow the exchange of short text messages between fixed line and/or a wireless connection with a mobile device. The network 3803 can include a cellular network, a wide area network, local area network and other like networks, such as a cloud network that enables the delivery of computing and/or storage capacity as a service to a community of end-recipients.

The computing device 3702 includes the data store 3704, the processor 3706, the media search component 3708, the media extracting component 3709 and the concatenating component 3710 communicatively coupled via the communication bus 3705. The computing device 3702 further includes a media index component 3808, a publishing component 3810 and an audio analysis component 3812 for generating a multimedia message.

The media index component 3808 is configured to index media content portions of a set of media content portions according to a set of criteria. For example, the media index component 3808 can index the portions of media content according to words spoken, or phrases spoken within media content portions. For example, if the phrase “It is all good” is identified in a set of media content such as a video and/or an audio recording and extracted by the media extracting component 3709, then the media index component 3808 can store the portion of the media content with a tag or metadata that identifies the portion extracted as the phrase “It is all good.”

The media index component 3808 is configured to index a set of media content (e.g., videos and audio content) that are stored at the data store 3704 and/or the data store 3806, and store an index of media content portions within the data stores. In one embodiment, the media index component 3808 indexes the media content entirely based on a particular video or audio that is selected for extraction by the media extracting component 3709. Particular media content, such as particular movie, song, and the like, can indexed according to a classification criteria of the particular media content. For example, classification criteria can include a theme, genre, actor, actress, time period or date range, musician, author, rating, age range, voice tone, and the like. The computer device 3702 can receive media content from the client device 3802 for indexing by the media index component 3808, and/or index media content stored to predefine categories of media content and/or media content portions. In addition, the media index component 3808 is configured to index portions of media content that are extracted. The media indexing component 3808 can tag or associate metadata to each of the portions as well as the media content as a whole. The tag or metadata can includes any data related to the classification of the media content or portions related to the media content, as well as words, phrases or images pre-associated with the media content, which includes video, audio and/or video and audio pre-associated with one another in each portion extracted, for example.

The publishing component 3810 is configured to publish, via the network 3803 and/or a networked device or the client device 3802, the set of media content portions according to the indexing of the media content portions in an index of the data store 3704. The media content portions can be published irrespective of physical storage location, or, in other words, regardless of whether the portions are stored at the client device 3802, computing device 3702, and/or at the network 3803, for example, with words or phrases associated with respective media content portions of the set of media content portions, and/or published based on the metadata or a tag that the media content portions are indexed with. For example, a media content portion indexed according to the phrase “Put 'em up,” can be published as the phrase “Put 'em up” as well as each individual word or smaller phrase with a phrase, such as “put,” or “put 'em.” Additionally or alternatively, the media content portions can be published according to the classifications that the portions are indexed, such as the media content portion being extracted from a Western, as being spoken by the actor Clint Eastwood, being filmed during 1970's, being rated R, and/or other metadata or tag associated with the media content and/or the portions extracted from the media content.

In addition, the publishing component 3810 is configured to publish one or more of the computer executable components (e.g., the components of the computer device 3702) for download to the client device 3802, such as a mobile device via the network 3803. The publishing component 3810 of the computer device 3702 is configured to publish the components to a network for processing on the client device 3802, for example. In addition, the message generated by the computing device 3702 and/or the client device 3802 is published by the publishing component to a network for storage and/or communication to any other networked device. For example, a multimedia message generated by the computing device 3702 can include the media content portion with “Put 'em up” as audio content pre-associated with the video content portion extracted from a Clint Eastwood, as well as a concatenated portion thereto with video having pre-associated audio content of “I'll be comin for you,” as stated by the actor William Dafoe in the video “Streets of Fire.” The publishing component 3810 is operable to publish the multimedia message including the video portions and audio portions via the network 3803 for play as a single video and audio message joined together.

The audio analysis component 3812 is configured to analyze audio content of the set of media content and determine portions of the audio content that correspond to the set of words or phrases of the set of inputs. For example, the computing device 3702 is operable to receive a set of inputs corresponding to words or phrases for a message, and, based on a word or phrase in the set of inputs, the audio analysis component 3812 can analyze the media content for portions within media content having a matching word or phrase in the audio content of the media content. The media extracting component 3709 can receive then extract the portions with the matching word or phrase in the media content (e.g., video, and/or audio) to obtain a media content portion that has audio that includes the word or phrase. The media content portion, for example, can be a video segment with an actor saying the word or phrase, for example, as well as a song, speech, musical, etc.

The audio analysis component 3812, for example, can identify information meaning from audio signals for analysis, classification, storage, retrieval, synthesis, etc. In one embodiment, the audio analysis component 3812 recognizes words or phrases within a set of media content, such as by performing a sound analysis on the spectral content of the media content. Sound analysis, for example, can include the Fast Fourier Transform (FFT), Time-Based Fast Fourier Transform (TFFT) and/or the like tools. The audio analysis component 3812 is operable to produce audio files extracted from the media content, and analyze characteristics of the audio at any point in time, and/or as entire audio. The audio analysis component 3812 can then generate a graph over the duration of a portion of the audio content and/or the entire sequence of an audio recording that can be pre-associated with and/or not pre-associated with video or other media content. The media extracting component 3709 can thus extract portions of the media content based on the output of the audio analysis component 3812, such as part of the set of predetermined criteria upon which the extractions can be based.

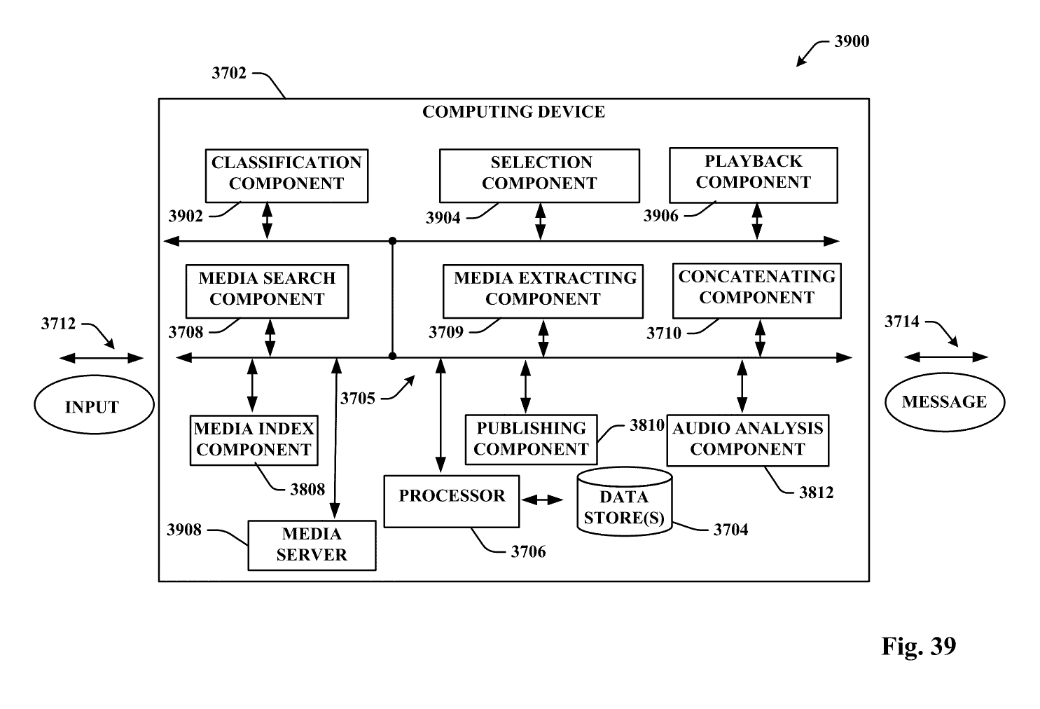

Referring now to FIG. 39, illustrated is a system 3900 in accordance with various embodiments described herein. The system 3900 comprises the computing device 3702. The computing device 3702 includes the data store 3704, the processor 3706, the media search component 3708, the media extracting component 3709, the concatenating component 3710, the media index component 3808, the publishing component 3810 and the audio analysis component 3812 communicatively coupled via the communication bus 3705. The computing device 3702 further includes a classification component 3902, a selection component 3904 and a playback component 3906 for generating a multimedia message.

The classification component 3902 is configured to classify the set of media content according to a set of classifications. For example, the classification of the set of media content can be based on a set of themes (e.g., spirituality, romance, autobiography, etc.), a set of media ratings (e.g. G, PG, R), a set of actors or actresses (e.g., John Wayne, Kate Hudson), a set of song artists (e.g., Bob Dylan), a set of titles, a set of date ranges and/or any other like identifying characteristic of media content. In one embodiment, the classification component 3902 communicates classification settings and/or data about the type of media content desired to the media extraction component 3709, which then extracts portions from the media content based on the set of classifications as well as the set of words or phrases received as input.

In another embodiment, the classification component classifies media content stored in the data store 3704 based on the set of classifications discussed above. Portions of the media content are extracted and can then be further classified according to additional criteria, such as voice tone, gender, race, emotion, age range, look and/or other characteristics of the video and/or audio, which could be suitable for a user to select when formulating a multimedia message 3714 with the computing device 3702. The classified portions of media content can be tagged or attributed with metadata that is associated with each portion within the data store 3704, as well as with the message 3714 before and after the message is communicated.

The selection component 3904 is configured to generate a set of predetermined selections such as selection options that include a set of textual words or phrases that correspond to at least one media content portion of the set of media content portions. The selection component 3904 is configured to receive the set of predetermined selections as the set of inputs and communicate the portions of media content corresponding to selections for generation of the multimedia message. For example, a selection can be a word or phrase such as “I love you.” Each word or the entire phrase can correspond to media content portions that make up “I love you”, thus generating a multimedia message that communicates “I love you.”

In addition or alternatively, the selections could be the portions of media content themselves, in which more than one media content portions corresponds to a given word or phrase. Consequently, various media content portions can generated by the selection component 3904 for a given word or phrase, in which selections can be received to associate a media content portion with any number of words or phrases. For example, if various media content portions for the word “love” are presented, a selection of the media content portion can be received and processed to associate the media content portion to the word “love” in the multimedia message. The multimedia message can then be generated to have various media content portions from different media content based on selections received, which are predetermined based on the word and/or selection options for various media content portions associated with a word or phrase. The selection component 3904 is configured to then communicate the media content portions as selections to be inserted into the multimedia message. The selections, for example, can be received via any number of graphical user interface controls, such as by drag and drop, links, drop down menus, and/or any other graphical user interface control.

A media server 3908 is configured to manage the various media content that is searched and indexed, as well as assist in publishing components of the computer device 3702 to a network for download on a mobile device or other device. The media server 3908 is thus configured to facilitate a sharing of media content of the set of data stores to communicate the respective media content portions of the media content via a network irrespective of physical storage location, and to manage storing of an index of different media content portions having video content and audio content based on associations to words or phrases including the set of words or phrases, and/or selections received at the selection component 3904.

The computing device 3702 further includes the playback component 3906 that is configured to generate a preview of the multimedia message including a rendering of selected media content portions of the set of media content portions in a concatenated video stream at a display component (not shown), such as a touch screen display or other display device. For example, in response to receiving a playback input, the playback component 3906 can provide a preview of the message generated with any number of media content portions that make up the phrase “I love you.” The message can then be further edited or modified to a user's satisfaction before sending based on a preview of the multimedia message.

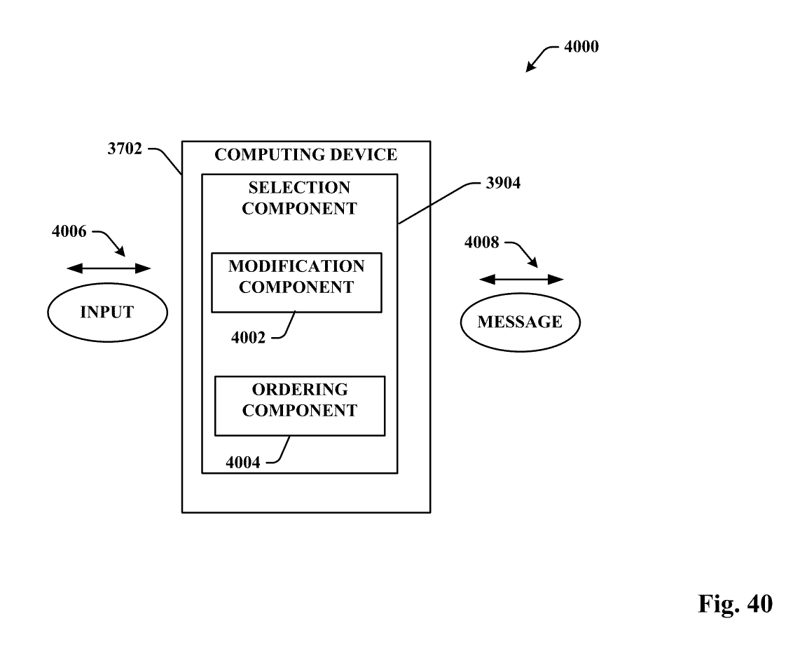

Referring to FIG. 40, illustrated is a system 4070 that generates messages with various forms of media content from a set of inputs, such as text, voice, and/or predetermined input selections that can be different or the same as the media content of the message in accordance with various embodiments herein. The system 4070 is configured to receive a set of inputs 4076 and communicate, transmit or output a message 4078. The set of inputs 4076 comprise a text message, a voice message, a predetermined selection and/or an image, such as a text-based image or other digital image, for example.

The selection component 3904 of the computing device 3702 further includes a modification component 4072 and an ordering component 4074. The modification component 4072 is configured to modify media content portions of the message 4078. The modification component 4072, for example, is operable to modify one or more media content portions such as a video clip and/or an audio clip of a set of media content portions that corresponds to a word or phrase of the set of words or phrases communicated via the input 4076. In one embodiment, the modification component 4072 can modify by replacement of the media content portions with a different media content portion to correspond with the word or phrase identified in the input 4076. For example, the message generated 4078 from the input 4076 can include media content portions, such as text phrases or words (e.g., overlaying or proximately located to each corresponding media content portion), video clips, images and/or audio content portions. The modification component 4072 is configured to modify the message 4078 with a new word or phrase to replace an existing word or phrase in the message, and, in turn, replace a corresponding video clip.

Additionally or alternatively, a video portion, audio portion, image portion and/or text portion can be replaced with a different or new video portion, audio portion image portion and/or text portion for the message to be changed, kept the same, or better expressed according to a user's defined preference or classification criteria. In addition or alternatively, the selection component 3904 can be provided a set of media content portions that correspond to a word, phrase and/or image of an input for generating the message 4078 and/or to be part of a group of media content portions corresponding with a particular word, phrase and/or image.

In another embodiment, the selection component 3904 is further configured to replace a media content portion that corresponds to the word or phrase with a different video content portion that corresponds to the word or phrase, and/or also replace, in a slide reel view, a media content portion that corresponds to the word or phrase with another media content portion that corresponds to another word or phrase of the set of words or phrases.

The selection component 3904 includes an ordering component 4074 that is configured to modify and/or determine a predefined order of the set of media content portions based on a received modification input for a modified predefined order, in which can be communicated with the set of words or phrases in the modified predefined order. For example, a message that is generated with media content portions to be played in multimedia message such as a video and/or audio message can be organized in a predefined order that is the order in which the input is provided or received by the message (concatenating) component 3710. The ordering component 4074 is thus configured to redefine the predefined order by either drop, drag, and/or some other ordering input that rearranges the media content portions.

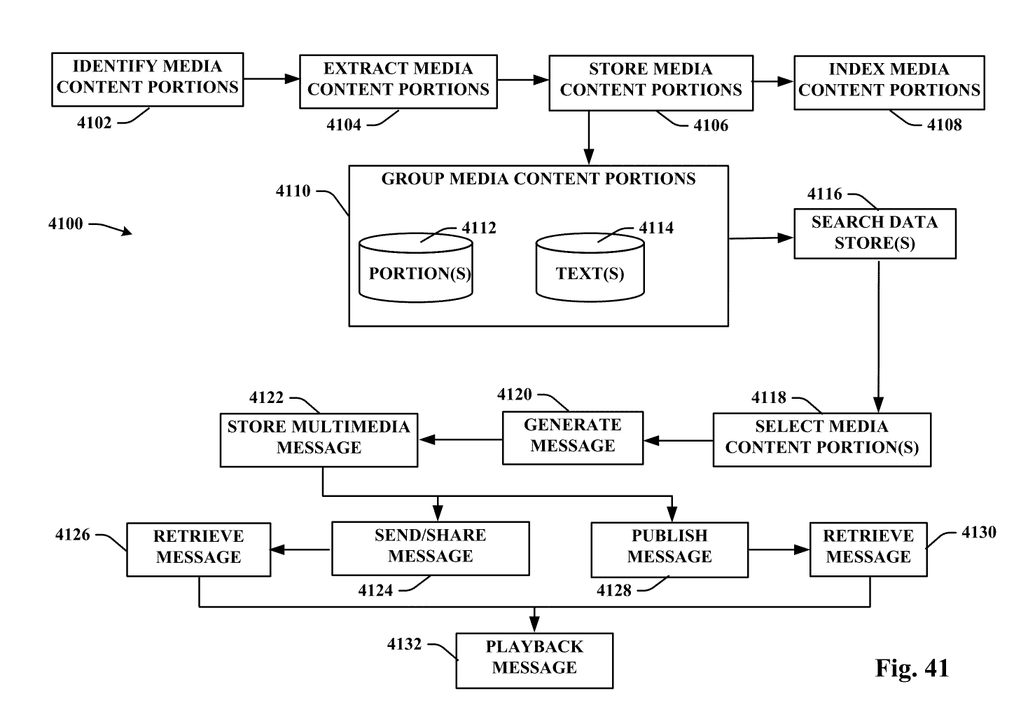

Referring to FIG. 41, illustrated is an exemplary system flow 4100 in accordance with embodiments described in this disclosure. The system 4100 identifies media content portions at 4102 based on a set of inputs, such voice inputs, digital typed inputs, text inputs and/or other inputs to generate a message with words or phrases, such as a selection of predefined words or phrases.

At 4104 media content portions of media content are extracted according to a set of predetermined criteria. For example, words or phrases of the text input can be associated with words and phrases of video and/or audio content and portions of media content corresponding to the words or phrases can be extracted. For example, the system is configured to edit, slice, portion and/or segment a video/audio for words, action scenes, voice tone, a rating of the video or movie, a targeted age, a movie theme, genre, gestures, participating actors and/or other classifications, in which the portion and/or segment is corresponded, associated and/or compared with the phrases or words of received inputs (e.g., text input). In addition or alternatively, the media content portions component 4104 is configured to dynamically, in real time generate corresponding video scenes, video/audio clips, portions and/or segments from an indexed set of videos stored in one or more data store(s).

At 4106, media content portions extracted are stored in one or more data store(s), such as a data store at a client device, a server, or a host device via network. At 4108 the media content portions are indexed. For example, a database index can be generated that is a data structure for improving the speed of media content retrieval operations on an index such as a database table. Indexes can be created with the media content portions, classifications, and corresponding words or phrases using one or more columns of a database table, providing the basis for both rapid random lookups and efficient access of ordered records.

At 4110, media content portions can be grouped and/or classified, for example, in a media portions database 4112 and/or words or phrases can be stored in a text data store 4114 that corresponds to each of the media portions. At 4116, data store(s) can be searched in response to a query for media content portions corresponding to the query terms. At 4118, a selection input is received that selects media content portion(s) generated from the query.

At 4120, a set of media content portions that correspond to the words or phrases of text according to a set of predetermined criteria and/or based on a set of user defined preferences/classifications is concatenated together to form a multimedia message. As stated above, text inputs can be selected, communicated and/or generated onsite via a web interface. The message can be dynamically generated as a multimedia message that corresponds to the words or phrases of the text message of the text input. The portions of media content can correspond to the words or phrases according to predefined criteria, for example, based on audio that matches each word or phrase of the text inputs, as well as classification criteria.

In one embodiment, the multimedia message can be generated to comprise a sequence of video/audio content portions from different videos and/or audio recordings that correspond to words or phrase of the input received (e.g., a text inputted message). The message can be generated to also display text within the message, similar to a text overlay or a subtitle that is proximate to or within the portion of the video corresponding to the word or phrase of the input. In the case of audio, the text message can also be generated along with the sound bites or audio segments (e.g., a song, speech, etc.) corresponding to the words or phrases of the text. The predetermined criteria, for example, can include a matching classification for the set of video content portions according to a set of predefined classifications, a matching action for the set video content portions with the set of words or phrases, or a matching audio clip (i.e., portion of audio content) within the set of video content portions that matches a word or phrase of the set of words or phrases. In addition, the matches or matching criteria of the predetermined criteria can be weighted, so that search results or generated results of corresponding media content portions are not exact. For example, a weighting of the predetermined criteria including a matching audio content for the set of video content portions can be weighted at only a certain percentage (e.g., 75%) so that the generated corresponding content generates a plurality of media content portions for a user to select from in building the message.

Further, the message of media content portions (e.g., portions of video and/or audio that are pre-associated with video to or not pre-associated) can be generated in response to the words or phrases of text according to a set of user pre-defined preferences/classifications (i.e., classification criteria). Classifying the set of media content portions (e.g., video/audio content portions) according to a set of predefined classifications includes classifying the media content portions according to a set of themes, a set of media ratings, a set of target age ranges, a set of voice tones, a set of extracted audio data, a set of actions or gestures (e.g., action scenes), an alphabetical order, gender, religion, race, culture or any number of classifications, such as demographic classifications including language, dialect, country and the like. In addition, the media content portions can be generated according to a favorite actor or a time period for a movie.

At 4122, the multimedia message that is generated can be shared, published and/or stored irrespective of location, such as on a client device, a host device, a network, and the like. At 4124 the message can be communicated or shared where the message is transmitted to a recipient, such as via a text multimedia message or other electronic means. At 4126, the message can be retrieved and played back at 4132 by a user and/or a recipient of the message. At 4128, message can also be published via a network, and retrieved at 4130 for playback at 4132 by any user of the system, and/or device having a network connection.

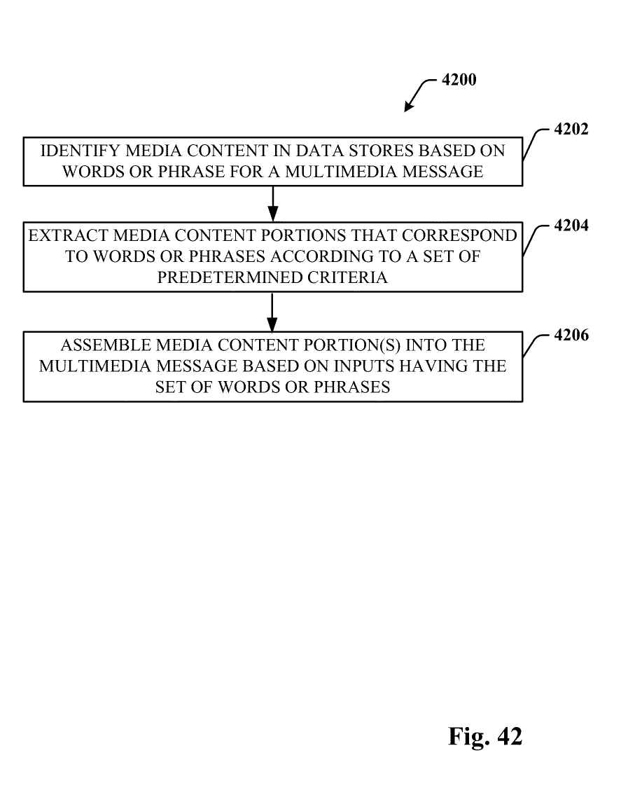

An example methodology 4200 for implementing a method for a messaging system is illustrated in FIG. 42 in accordance with aspects described herein. The method 4200, for example, provides for a system to interpret inputs received expressing a message via text, voice, selections, images, emoticons of one or more users and generating a corresponding message with media content portions for the portions, or segments of the inputs received. An output message can be generated based on the inputs received with a concatenation or sequence of media content portions of a group of different media content portions (e.g., video, audio, imagery and the like). Users are provided additional tools for self-expression by sharing and communicating message according to various taste, culture and personality.

At 4202, the method initiates with identifying, by a system including at least one processor, a set of media content such as video content and audio content in a set of data stores irrespective of location based on a set of words or phrases for a multimedia message.

At 4204, media content portions are extracted such as a set of video content portions and audio content portions, which correspond to the set of words or phrases according to a set of predetermined criteria. The predetermined criteria, for example, can be at least one classification of the set of classifications and a matching of media content portions of the set of media content portions from the set of media content with the set of words or phrases. The predetermined criteria can comprise a matching audio clip within the set of media content portions that matches a word or phrase of the set of words or phrases, one or more of a matching classification for the set of video content portions according to a set of predefined classifications, and/or a matching action for the set video content portions with the set of words or phrases.

At 4206, the method 4200 continues with assembling at least one video content portion and at least one audio content portion of the set of media content portions into the multimedia message based on a set of inputs having the set of words or phrases. For example, the order that the inputs are received can be the order in which the multimedia message is generated as well as matching words or phrases from the set of inputs.

In one embodiment, the method 4200 includes dividing the set of video content and audio content into video content portions and audio content portions according to at least one of words, phrases, or images determined to be included in the video content portions or the audio content portions. For example, entire video and audio content can be divided into words, phrases and/or images for selection of various media content portions to be inserted into the message. In addition, a number of classification criteria can also be accounted for in the dividing, which enables predefined portions to be indexed and further selected for one or more multimedia messages.

In another embodiment, the method can classify media content portions according to a set of predefined classifications that includes at least one of a set of themes, a set of song artists, a set of actors, a set of album titles, a set of media ratings of the set of video content and audio content, voice tone, or a set of time periods.

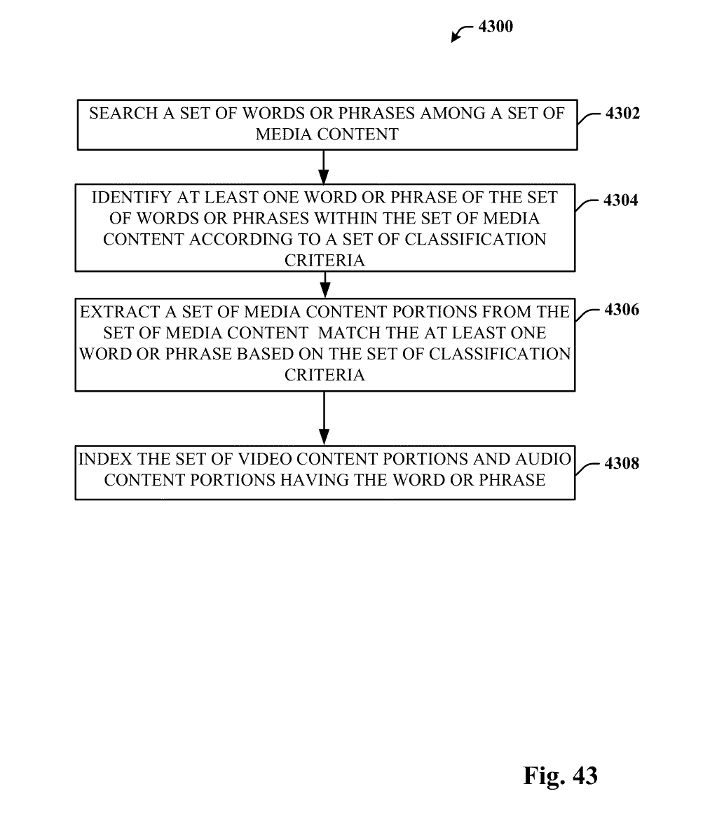

An example methodology 4300 for implementing a method for a system such as a multimedia system for media content is illustrated in FIG. 43. The method 4300, for example, provides for a system to evaluate various media content inputs and generate a sequence of media content portions that correspond to words, phrases or images of the inputs. At 4302, the method initiates with searching for a set of words or phrases among a set of media content such as video content and audio content in a set of data stores.

At 4304, at least one word or phrase of the set of words or phrases are identified within the set of media content searched according to a set of classification criteria. The classification criteria can be, for example, an actor, an actress, a theme, a genre, a rating of a film, a target audience, a date range or time period, and/or the like.

At 4306, a set of media content portions are extracted having audio content that matches the word or phrase based on the set of classification criteria. At 4308, the set of media content portions are indexed having the at least one word or phrase of the set of words or phrases that are pre-associated with video content and audio content in the set of data stores according to at least one of the at least one word or phrase, or the classification criteria.

The method can further include concatenating at least two video content portions or audio content portions of the set of video content portions and audio content portions into the multimedia message based on a set of selection inputs, and communicating the set of video content portions and audio content portions as selections to be inserted into the multimedia message.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

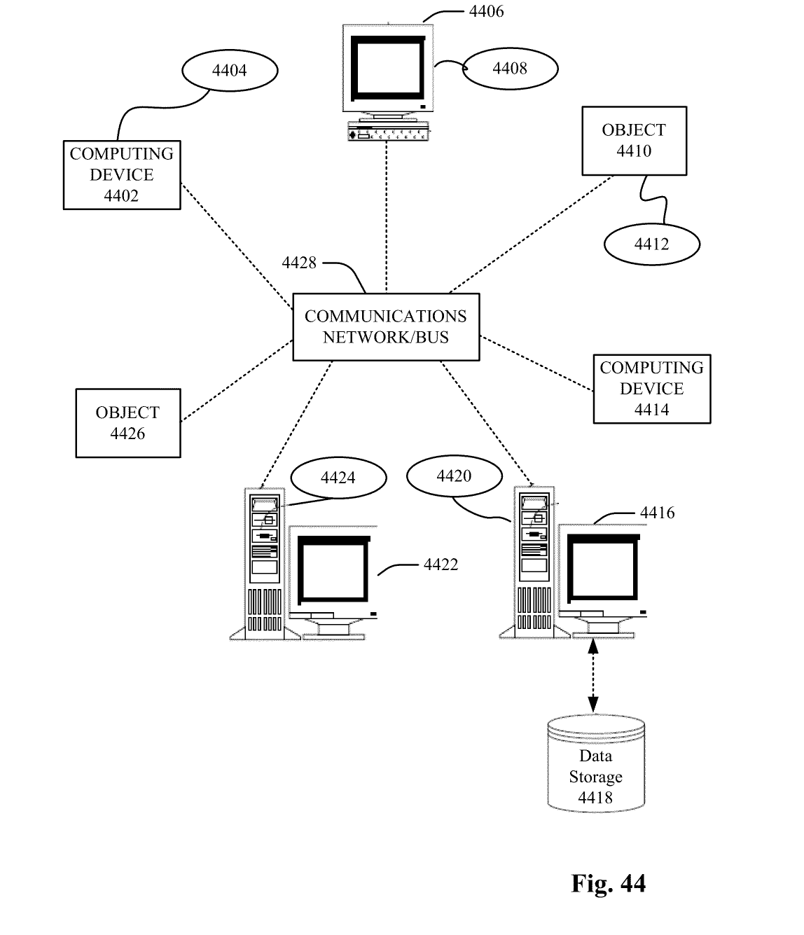

FIG. 44 provides a schematic diagram of an exemplary networked or distributed computing environment. The distributed computing environment comprises computing objects 4410, 4412, etc. and computing objects or devices 4420, 4422, 4424, 4426, 4428, etc., which may include programs, methods, data stores, programmable logic, etc., as represented by applications 4430, 4432, 4434, 4436, 4438. It can be appreciated that computing objects 4410, 4412, etc. and computing objects or devices 4420, 4422, 4424, 4426, 4428, etc. may comprise different devices, such as personal digital assistants (PDAs), audio/video devices, mobile phones, MP3 players, personal computers, laptops, etc.

Each computing object 4410, 4412, etc. and computing objects or devices 4420, 4422, 4424, 4426, 4428, etc. can communicate with one or more other computing objects 4410, 4412, etc. and computing objects or devices 4420, 4422, 4424, 4426, 4428, etc. by way of the communications network 4440, either directly or indirectly. Even though illustrated as a single element in FIG. 44, communications network 4440 may comprise other computing objects and computing devices that provide services to the system of FIG. 44, and/or may represent multiple interconnected networks, which are not shown. Each computing object 4410, 4412, etc. or computing object or device 4420, 4422, 4424, 4426, 4428, etc. can also contain an application, such as applications 4430, 4432, 4434, 4436, 4438, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 44, as a non-limiting example, computing objects or devices 4420, 4422, 4424, 4426, 4428, etc. can be thought of as clients and computing objects 4410, 4412, etc. can be thought of as servers where computing objects 4410, 4412, etc., acting as servers provide data services, such as receiving data from client computing objects or devices 4420, 4422, 4424, 4426, 4428, etc., storing of data, processing of data, transmitting data to client computing objects or devices 4420, 4422, 4424, 4426, 4428, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 4440 or bus is the Internet, for example, the computing objects 4410, 4412, etc. can be Web servers with which other computing objects or devices 4420, 4422, 4424, 4426, 4428, etc. communicate via any of a number of known protocols, such as the hypertext transfer protocol (HTTP). Computing objects 4410, 4412, etc. acting as servers may also serve as clients, e.g., computing objects or devices 4420, 4422, 4424, 4426, 4428, etc., as may be characteristic of a distributed computing environment.

### Exemplary Computing Device

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

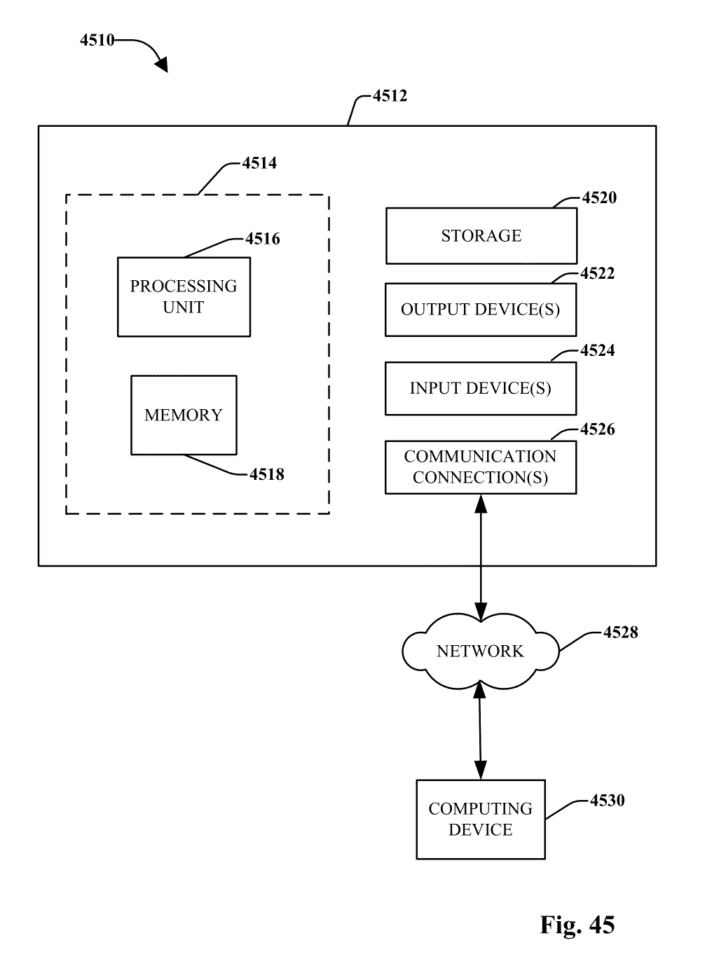

FIG. 45 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 45 illustrates an example of a system 4510 comprising a computing device 4512 configured to implement one or more embodiments provided herein. In one configuration, computing device 4512 includes at least one processing unit 4516 and memory 4518. Depending on the exact configuration and type of computing device, memory 4518 may be volatile (such as RAM, for example), non-volatile (such as ROM, flash memory, etc., for example) or some combination of the two. This configuration is illustrated in FIG. 45 by dashed line 4514.

In other embodiments, device 4512 may include additional features and/or functionality. For example, device 4512 may also include additional storage (e.g., removable and/or non-removable) including, but not limited to, magnetic storage, optical storage, and the like. Such additional storage is illustrated in FIG. 45 by storage 4520. In one embodiment, computer readable instructions to implement one or more embodiments provided herein may be in storage 4520. Storage 4520 may also store other computer readable instructions to implement an operating system, an application program, and the like. Computer readable instructions may be loaded in memory 4518 for execution by processing unit 4516, for example.

The term “computer readable media” as used herein includes computer storage media. Computer storage media includes volatile and nonvolatile, removable and non-removable media implemented in any method or technology for storage of information such as computer readable instructions or other data. Memory 4518 and storage 4520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 4512. Any such computer storage media may be part of device 4510.

Device 4512 may also include communication connection(s) 4526 that allows device 4510 to communicate with other devices. Communication connection(s) 4526 may include, but is not limited to, a modem, a Network Interface Card (NIC), an integrated network interface, a radio frequency transmitter/receiver, an infrared port, a USB connection, or other interfaces for connecting computing device 4512 to other computing devices. Communication connection(s) 4526 may include a wired connection or a wireless connection. Communication connection(s) 4526 may transmit and/or receive communication media.

The term “computer readable media” as used herein includes computer readable storage media and communication media. Computer readable storage media includes volatile and nonvolatile, removable and non-removable (non-transitory), and tangible media implemented in any method or technology for storage of information such as computer readable instructions or other data. Memory 4518 and storage 4520 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 4510. Any such computer readable storage media may be part of device 4512.

Device 4512 may also include communication connection(s) 4526 that allows device 4512 to communicate with other devices. Communication connection(s) 4526 may include, but is not limited to, a modem, a Network Interface Card (NIC), an integrated network interface, a radio frequency transmitter/receiver, an infrared port, a USB connection, or other interfaces for connecting computing device 4512 to other computing devices. Communication connection(s) 4526 may include a wired connection or a wireless connection. Communication connection(s) 4526 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 4512 may include input device(s) 4524 such as keyboard, mouse, pen, voice input device, touch input device, infrared cameras, video input devices, and/or any other input device. Output device(s) 4522 such as one or more displays, speakers, printers, and/or any other output device may also be included in device 4512. Input device(s) 4524 and output device(s) 4522 may be connected to device 4512 via a wired connection, wireless connection, or any combination thereof. In one embodiment, an input device or an output device from another computing device may be used as input device(s) 4524 or output device(s) 4522 for computing device 4512.

Components of computing device 4512 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 4512 may be interconnected by a network. For example, memory 4518 may be comprised of multiple physical memory units located in different physical locations interconnected by a network.

Those skilled in the art will realize that storage devices utilized to store computer readable instructions may be distributed across a network. For example, a computing device 4530 accessible via network 4528 may store computer readable instructions to implement one or more embodiments provided herein. Computing device 4512 may access computing device 4530 and download a part or all of the computer readable instructions for execution. Alternatively, computing device 4512 may download pieces of the computer readable instructions, as needed, or some instructions may be executed at computing device 4512 and some at computing device 4530.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components; and
a processor, communicatively coupled to the memory, that facilitates execution of the computer-executable components, the computer-executable components including:
an input component configured to receive a message input having a set of words or phrases for generating a multimedia message;
a media component configured to analyze media content to determine an audio content portion and a video content portion that corresponds to the set of words or phrases of the message input;
an overlay component configured to overlay the audio content portion with the video content portion; and
a message component configured to generate the multimedia message with the video content portion and the audio content portion to correspond to the set of words or phrases of the message input.

2. The system of claim 1, wherein the media component is further configured to determine a first audio content portion associated with a first video content portion and a second audio content portion associated with a second video content portion.

3. The system of claim 2, wherein the overlay component is further configured to replace the first audio content portion associated with the first video content portion with the second audio content portion.

4. The system of claim 1, wherein the input component is configured to receive the message input comprising a voice input and identify the set of words or phrases within the voice input.

5. The system of claim 1, wherein the media component is configured to determine the video content portion and the audio content portion based on a matching of the audio content portion with the set of words or phrases of the message input.

6. The system of claim 5, wherein the audio content portion is associated with a different video content portion than the video content portion of the media content.

7. The system of claim 1, further comprising:
an audio filter component configured to identify different audio signals within the audio content portion of the media content.

8. The system of claim 7, wherein the audio filter component identifies the different audio signals with an originating source.

9. The system of claim 1, further comprising:
a voice recognition component configured to analyze the audio content portion to identify different voices originating from different persons respectively.

10. The system of claim 9, wherein the voice recognition component identifies different voices within one or more audio content portions of the media content based on a set of classification criteria including, a theme, a song, a speech, an originating person that vocalizes the audio content, and/or according to a characterization of the video content that the audio content is originally associated with.

11. The system of claim 1, further comprising:
a video filter component configured to separate the video content portion from the audio content portion.

12. The system of claim 1, further comprising:
a sequencing component configured to align the video content portion with the audio content portion in a matching time sequence, and associate the audio content portion and the video content portion to convey the word or the phrase received by the message input in the multimedia message.

13. The system of claim 1, wherein the multimedia message is generated according to a set of classification criteria that governs the audio content and the video content separately and includes at least one of a performer, a voice tone, a gender, an age range, a rating, an event, a time period, an object, a location or a language.

14. The system of claim 1, further comprising:
a payment component configured to assign a cost or a charge to at least one of the audio content portion or the video content portion generated within the multimedia message.

15. The system of claim 1, further comprising:
a voice input component configured to receive the set of words or phrases in a voice input of the message input and associate the set of words or phrases within the voice input to the video content portion as audio content that corresponds to the video content portion.

16. The system of claim 15, wherein the voice input component is further configured to remove any audio content originally associated with the video content portion and associate the set of words or phrases of the voice input with the video content portion.

17. A method, comprising:
receiving, by a system including at least one processor, a message input having a set of words or phrases for generating a multimedia message;
determining, from media content, a first media content portion that includes a first audio content portion of a first video content portion and a second media content portion that includes a second audio content portion of a second video content portion, wherein the first media content portion and the second media content portion correspond to the set of words or phrases of the message input based on a set of predetermined criteria;
combining the first audio content portion with the second video content portion to form a third media content portion; and
generating the multimedia message that includes the third media content portion.

18. The method of claim 17, wherein the set of predetermined criteria include at least one of an action, a facial expression, an audio word or phrase spoken or a characteristic about an event including at least one of a facial expression, an action, words or phrases spoken, in a portion media content that corresponds to the set of words or phrases.

19. The method of claim 17, wherein the generating of the multimedia message includes combining the third media content portion with at least one additional media content portion for a video sequence having audio content portions and video content portions that correspond to each word or phrase of the set of words or phrases respectively.

20. The method of claim 17, wherein the receiving the message input includes receiving a voice input having the set of words or phrases.

21. The method of claim 17, wherein determining the first media content portion and the second media content portion from the media content includes determining a match of media content portions of the media content with the set of words or phrases.

22. The method of claim 17, further comprising:
identifying a plurality of different audio content within audio content portions of the media content and associating a tag to identify the plurality of different audio content.

23. The method of claim 22, wherein the tag includes a name including a word or phrase that identifies a source of different audio content of the plurality of different audio content.

24. The method of claim 17, further comprising:
analyzing an audio content portion of the media content to identify a voice and an associated person in which the voice originates.

25. The method of claim 24, wherein the analyzing of the voice within the audio content portion of the media content is based on a set of classification criteria including, a theme, a song, a speech, an originating person that vocalizes the audio content, and/or according to a characterization of the video content that the audio content is originally associated with.

26. The method of claim 17, further comprising:
billing a cost or a charge to at least one audio content portion or at least one video content portion that is incorporated into the multimedia message.

27. The method of claim 26, further comprising:
identifying at least one copyright associated with the first media content portion or the second media content portion, wherein the billing of the cost or the charge is based on the at least one copyright.

28. The method of claim 17, wherein the receiving the message input includes receiving a voice input having the set of words or phrases.

29. An apparatus comprising:
a memory storing computer-executable instructions; and
a processor, communicatively coupled to the memory, that facilitates execution of the computer-executable instructions to at least:
receive a set of words or phrases for generation of a multimedia message;
determine a set of media content portions that respectively include an audio content portion and a video content portion according to the set of words or phrases;
associate the audio content portion of a first media content portion with the video content portion of a second media content portion to form a third media content portion; and
generate the multimedia message with the third media content portion.

30. The apparatus of claim 29, wherein the processor further facilitates execution of the computer-executable instructions to:
receive a voice input as the message input having the set of words or phrases.

31. The apparatus of claim 30, wherein the processor further facilitates execution of the computer-executable instructions to:
replace the audio content originally associated with the video content portion with the set of words or phrases of the voice input.

32. The apparatus of claim 29, wherein the processor further facilitates execution of the computer-executable instructions to:
bill a cost or a charge to the audio content portion or the video content portion that is incorporated into the multimedia message.

33. The apparatus of claim 29, wherein the processor further facilitates execution of the computer-executable instructions to:
edit a correlation of the audio content portion with the video content portion of the media content portion to correlate the video content portion with a different audio content portion.

34. The apparatus of claim 29, wherein the processor further facilitates execution of the computer-executable instructions to:
receive, via a set of interface controls, the message input in a text message.

35. The apparatus of claim 29, wherein the processor further facilitates execution of the computer-executable instructions to:
generate the media content portions according to a set of predetermined criteria that include at least one of audio content, a facial expression, or an action within the media content, according to a match with the set of words or phrases.

36. The apparatus of claim 39, wherein the multimedia message comprises a video message that includes concatenated portions of different video content portions that correspond to the set of words or phrases based on audio content portions of the different video content portions.

37. A tangible computer readable storage medium comprising computer executable instructions that, in response to execution, cause a computing system including at least one processor to perform operations, comprising:
receiving a set of words or phrases for generation of a multimedia message having a media content portion corresponding to the set of words or phrases;
extracting the media content portion having a video content portion and an audio content portion from a set of media content corresponding to the set of received words or phrases;
associating the video content portion of the media content portion with a different audio content portion of a different media content portion that corresponds to the set of received words or phrases; and
generating the multimedia message with at least one media content portion that corresponds to the set of received words or phrases and includes the video content portion associated with the different audio content portion.

38. The tangible computer readable storage medium of claim 37, the operations further including:
identifying different audio signals within the audio content portion or the different audio content portion of the media content and an originating source for each audio signal.

39. The tangible computer readable storage medium of claim 37, the operations further including:
identifying a voice within the audio content portion or the different audio content portion of the media content and a person in which the voice originates.

40. The tangible computer readable storage medium of claim 37, wherein the voice is identified based on a set of classification criteria including, a theme, a song, a speech, an originating person that vocalizes the audio content, and/or according to a characterization of the video content that the audio content is associated with.

41. A system comprising:
means for receiving a set of words or phrases for a multimedia message;
means for identifying a set of media content portions that include an audio content portion and a video content portion that corresponds to the audio content portion from a set of media content;
means for correlating a different audio content portion with the video content portion; and
means for generating the multimedia message with the video content portion and the different audio content portion.
